(19) United States
(12) Patent Application Publication
(10) Pub. No.: US 2025/0099891 A1
(43) Pub. Date: Mar. 27, 2025

(54) FILTER CARTRIDGES; AIR CLEANER ASSEMBLIES; HOUSING; FEATURES; COMPONENTS; AND METHODS

(71) Applicant: Donaldson Company, Inc., Bloomington, MN (US)

(72) Inventors: Mathijs VERSTRAETE, Tienen (BE); David J. BURTON, Minneapolis, MN (US); Timothy J. WESSELS, Victoria, MN (US); Steven K. CAMPBELL, Lakeville, MN (US); Miles NORWOOD, Bloomington, MN (US)

(21) Appl. No.: 18/729,987

(22) PCT Filed: Jan. 18, 2023
(86) PCT No.: PCT/US2023/060851

§ 371 Date: Jul. 18, 2024

Related U.S. Application Data
(60) Provisional application No. 63/300,505, filed on Jan. 18, 2022.

(51) Int. Cl. B01D 46/24; B01D 46/52; B01D 46/64; F02M 35/024

(52) U.S. Cl. CPC B01D 46/2411; B01D 46/525; B01D 46/64; F02M 35/02416; B01D 2267/40; B01D 2271/027; B01D 2275/208; B01D 2279/60

(57) ABSTRACT

An air cleaner assembly having a housing defining an interior volume, a first filter cartridge installed within the housing interior volume, and a second filter cartridge installed within the housing interior volume at a location downstream of the first filter cartridge. The second filter cartridge includes a seal member including a radially directed first seal arrangement forming a seal between the second filter cartridge and the housing, and including a radially directed second seal arrangement forming a seal between the second filter cartridge and the first filter cartridge.

### PRIORITY CLAIM

This application claims priority to U.S. Provisional Patent Application Ser. No. 63/300,505, filed Jan. 18, 2022, the entirety of which is incorporated by reference herein.

### FIELD OF THE DISCLOSURE

The present disclosure relates to filter arrangements, typically for use in filtering air; such as intake air for internal combustion engines. In certain selected examples, the disclosure particularly relates to filter arrangements that use serviceable cartridges having opposite flow ends; however other applications are described. Air cleaner arrangements, features, and, methods of assembly and use, are also described. Some embodiments herein are directed to filter cartridge sealing components for air cleaner assemblies, and more specifically, to sealing components fixed to, or carried by a shell. Some embodiments are also directed to catch arrangements for facilitating insertion of a filter cartridge into a housing of an air cleaner assembly.

### BACKGROUND

Air streams can carry contaminant material such as dust and liquid particulate therein. In many instances, it is desired to filter some or all of the contaminant material from the air stream. For example, air flow streams to engines (for example combustion air streams) for motorized vehicles or for power generation equipment, gas streams to gas turbine systems and air streams to various combustion furnaces, carry particulate contaminant therein that should be filtered. It is preferred, for such systems, that selected contaminant material be removed from (or have its level reduced in) the air. A variety of air filter arrangements have been developed for contaminant removal. Improvements are sought.

### SUMMARY

Filter assemblies (such as air cleaner assemblies or crankcase ventilation filter assemblies), components therefor, and features thereof, are described. Also described are methods of assembly and use. The filter assemblies generally comprise a housing assembly having a primary filter cartridge and a secondary filter cartridge removably positioned therein.

In one embodiment, an air cleaner includes a primary filter cartridge and a secondary filter cartridge, wherein the secondary filter cartridge carries a first seal arrangement to seal the secondary filter cartridge to an outlet of the air cleaner. The secondary filter cartridge also carries second and third seal arrangements that act to seal radially between a surface on the primary filter cartridge and a surface on the air cleaner housing upstream of the secondary filter cartridge seal. In the examples presented herein, these seal arrangements are in series such that a failure of the primary filter cartridge seal or the secondary filter cartridge seal does not provide a leak path to the engine inlet. In some examples, the primary seal surface does not substantially engage the air cleaner housing until the primary filter cartridge is in place, this prevents the primary seal from affecting the service force of the secondary filter cartridge. In some examples, the primary filter cartridge can also act to hold the secondary filter cartridge in place without requiring plastic-on-plastic interaction between the frames of the primary and secondary filter cartridges.

In one embodiment, the primary seal acts in concert with an upstream seal on the dirty side of the filter cartridge to maintain a clean air cleaner interior for side-service air cleaners. In embodiments where the primary filter cartridge installs from the side, the primary filter cartridge has one or more locating features that engage with the air cleaner housing, this feature helps guide the installation of the primary filter cartridge and ensures that the primary filter cartridge will only engage with a properly seated secondary filter cartridge.

By placing the seal for the primary filter cartridge on the secondary filter cartridge, we can maintain a single seal on the primary filter cartridge while extending the utility of the secondary seal. Having the primary seal attached to the secondary allows for a cost reduction overall and for the primary filter in that the primary filter need not be provided with a seal and in that the primary seal can be reused across multiple replacements of the primary filter cartridge. Separate locating features on the primary ensures that the primary is inserted in the correct location during servicing. The primary/secondary interaction works to ensure that the secondary filter cartridge is in the proper location in the housing during service and will hold the secondary filter cartridge in place under vibration.

In one example, an air cleaner assembly has a housing defining an interior volume, a first filter cartridge installed within the housing interior volume, and a second filter cartridge installed within the housing interior volume at a location downstream of the first filter cartridge. The second filter cartridge includes a seal member including a radially directed first seal arrangement forming a seal between the second filter cartridge and the housing, and including a radially directed second seal arrangement forming a seal between the second filter cartridge and the first filter cartridge.

A filter cartridge for an air cleaner housing can include a media pack having an inlet flow end and outlet flow end; a shell peripherally arranged about at least a portion of the media pack; and a seal member peripherally arranged about at least a portion of the shell, the seal member including a first seal arrangement and a second seal arrangement arranged in series, wherein: the first seal arrangement includes an outwardly radially directed lip seal for forming a seal between the filter cartridge and the air cleaner housing; and the second seal arrangement includes an inwardly radially directed lip seal for forming a seal between the filter cartridge and the air cleaner housing.

In examples, the seal member further includes a third seal arrangement including an outwardly radially directed lip seal for forming a seal between the filter cartridge and another filter cartridge.

In examples, the first seal arrangement is located more proximate the outlet flow end relative to the second seal arrangement.

In examples, at least a portion of the second seal arrangement is located axially beyond the media pack inlet flow end in a direction extending from the media pack outlet flow end towards the inlet flow end.

In examples, one or both of the first and second seal arrangements include a plurality of lip seals.

In examples, the lip seals of the first and second seal arrangements extend at an oblique angle relative to a longitudinal axis of the filter cartridge.

In examples, the media pack includes fluted media.

In examples, the media pack includes pleated media.

A filter cartridge for an air cleaner housing having a longitudinal axis can include a media pack extending along a longitudinal axis between an inlet flow end and outlet flow end; a shell peripherally arranged about at least a portion of the media pack; and a first part of a catch arrangement located on the shell proximate the media pack outlet flow end, the first part being configured to pivotally engage with a second part of the catch arrangement provided on the air cleaner housing such that the filter cartridge can be pivoted about the second part between a tilted position and an installed position, wherein a longitudinal axis of the filter cartridge is oriented at a first angle when in the installed position and oriented at a second angle, oblique to the first angle, when in the tilted position.

An air cleaner assembly can include a filter cartridge including a media pack extending along a longitudinal axis between an inlet flow end and outlet flow end; a shell peripherally arranged about at least a portion of the media pack; and a first part of a catch arrangement located on the shell proximate the media pack outlet flow end; and a housing extending along a longitudinal axis between an inlet end and an outlet end, and defining an access opening for receiving the filter cartridge into an interior volume of the housing, the housing including a second part of the catch arrangement; wherein, the first part of the catch arrangement is configured to pivotally engage with the second part of the catch arrangement such that the filter cartridge can be pivoted about the second part between a tilted position, in which the media pack longitudinal axis is at an oblique angle to the air cleaner longitudinal axis, and an installed position within the housing, in which the media pack longitudinal axis is parallel to the air cleaner longitudinal axis.

In some examples, the first part is integrally formed with the shell.

In some examples, the filter cartridge includes a handle located on the shell, the handle being located proximate the media pack inlet flow end such that a center of gravity of the filter cartridge is located axially between the handle and the first part of the catch arrangement.

In some examples, the handle is integrally formed with the shell.

In some examples, the media pack is provided with a seal arrangement.

In some examples, the seal arrangement is located proximate the media pack inlet flow end is provided.

In some examples, the seal arrangement is an outwardly directed radial seal member.

In some examples, in the tilted position, the filter cartridge is in an unsealed state relative to the air cleaner housing, and wherein, in the installed position, the filter cartridge is in a fully sealed state relative to the air cleaner housing.

In some examples, the first part is located axially at least partially beyond the media pack outlet flow end.

In some examples, the first part is located axially fully beyond the media pack outlet flow end.

In some examples, the filter cartridge has an obround cross-sectional shape.

In some examples, the media pack is formed from fluted media.

In some examples, the first part of the catch arrangement includes a concave shaped surface for engaging with the second part of the catch arrangement.

In some examples, the first part of the catch arrangement includes a convex shaped surface for engaging with the second part of the catch arrangement.

An air cleaner assembly can include a housing defining an interior volume; a first filter cartridge installed within the housing interior volume; a second filter cartridge installed within the housing interior volume at a location downstream of the first filter cartridge. The air cleaner can also include a second filter cartridge including a seal member including an outwardly radially directed seal surface forming a seal with a first interior surface of the housing and including an inwardly radially directed seal surface forming a seal with a second interior surface of the housing.

In some examples, the seal member further includes a second outwardly radially directed seal surface forming a seal between the second filter cartridge and the first filter cartridge.

In some examples, the outwardly radially directed seal surface is located between the media pack inlet and outlet flow ends.

In some examples, at least a portion of the inwardly radially directed seal surface is located axially beyond the media pack inlet flow end in a direction extending from the media pack outlet flow end towards the inlet flow end.

In some examples, one or all of the inwardly radially directed seal surface, outwardly directed seal surface, and the second outwardly directed seal surface includes one or more lip seals.

There is no specific requirement that an air cleaner assembly, component therefor, or feature thereof include all of the detail characterized herein, to obtain some advantage according to the present disclosure.

### BRIEF DESCRIPTION OF THE DRAWINGS

FIG. 1 is a schematic perspective view of an air cleaner assembly having features in accordance with the present disclosure.

FIG. 2 is a schematic perspective view of the air cleaner assembly shown in FIG. 1, with the cover removed.

FIG. 3 is a schematic longitudinal side cross-sectional view of the air cleaner assembly shown in FIG. 1.

FIG. 4 is an exploded schematic perspective view of the air cleaner assembly shown in FIG. 1, showing a first filter cartridge and a second filter cartridge removed from a housing.

FIG. 5 is a schematic first perspective view of the first filter cartridge of the air cleaner assembly shown in FIG. 4.

FIG. 6 is a schematic side view of the first filter cartridge shown in FIG. 5.

FIG. 7 is a schematic first face view of the first filter cartridge shown in FIG. 5.

FIG. 8 is a schematic first perspective view of the second filter cartridge of the air cleaner assembly shown in FIG. 4.

FIG. 9 is a schematic second perspective view of the second filter cartridge shown in FIG. 8.

FIG. 10 is a schematic first face view of the second filter cartridge shown in FIG. 8.

FIG. 11 is a schematic second face view of the second filter cartridge shown in FIG. 6.

FIG. 12 is a schematic first side view of the second filter cartridge shown in FIG. 8.

FIG. 13 is a schematic second side view of the second filter cartridge shown in FIG. 8.

FIG. 14 is a schematic third side view of the second filter cartridge shown in FIG. 8.

FIG. 15 is a schematic fourth side view of the second filter cartridge shown in FIG. 8.

FIG. 16 is a schematic exploded perspective view of the second filter cartridge shown in FIG. 8.

FIG. 17 is a partial cross-sectional side view of the seal member of the second filter cartridge shown in FIG. 8.

FIG. 18 is a schematic partial cross-sectional view of the air cleaner assembly shown in FIG. 1, with the first filter cartridge removed.

| FIG. 19 is a schematic partial cross-sectional view of the air cleaner assembly shown in FIG. 1, with the first filter cartridge installed and sealed against the second filter cartridge.

FIG. 20 is a schematic partial cross-sectional view of the air cleaner assembly shown in FIG. 1, showing a locating feature of the first filter cartridge engaged with a receiving feature of the housing.

FIG. 21 is another schematic partial cross-sectional view of the air cleaner assembly shown in FIG. 1, showing a locating feature of the first filter cartridge engaged with a receiving feature of the housing.

FIG. 22 is a schematic top partial cross-sectional view of the air cleaner assembly shown in FIG. 1, showing sealing arrangements of the second filter cartridge.

FIG. 23 is a schematic side partial cross-sectional view of the air cleaner assembly shown in FIG. 1, showing sealing arrangements of the second filter cartridge.

FIG. 24 is a schematic perspective view of a second example of an air cleaner assembly having features in accordance with the present disclosure.

FIG. 25 is a schematic perspective view of the air cleaner assembly shown in FIG. 20, with the cover removed.

FIG. 26 is a schematic exploded perspective view of the air cleaner assembly shown in FIG. 24.

FIG. 27 is a schematic top view of the air cleaner assembly shown in FIG. 24, with the cover removed and with the first filter cartridge in an initially tilted position within the main housing.

FIG. 28 is a schematic perspective view of the air cleaner assembly shown in FIG. 24, with the cover removed and with the first filter cartridge in an initially tilted position within the main housing.

FIG. 29 is a schematic cross-sectional side view of the air cleaner assembly shown in FIG. 24.

FIG. 30 is a schematic cross-sectional side view of the air cleaner assembly shown in FIG. 24, with the first filter cartridge in an initial tilted position within the main housing.

FIG. 31 is a schematic partial cross-sectional top view of the air cleaner assembly shown in FIG. 24, with the first filter cartridge removed.

FIG. 32 is a schematic partial cross-sectional top view of the air cleaner assembly shown in FIG. 24, with the first filter cartridge installed.

FIG. 33 is a schematic partial cross-sectional top view of the air cleaner assembly shown in FIG. 24, showing an enlarged portion of the view shown in FIG. 32.

FIG. 34 is a schematical partial perspective view of the air cleaner assembly shown in FIG. 24.

FIG. 35 is a schematic partial cross-sectional side view of the air cleaner assembly shown in FIG. 34, with the first filter cartridge placed in the initial tilted position.

FIG. 36 is a schematic partial cross-sectional side view of the air cleaner assembly shown in FIG. 24, with the first filter cartridge placed in the installed position.

FIG. 37 is a partial cross-sectional side view of the seal member of the second filter cartridge of the air cleaner assembly shown in FIG. 24.

FIG. 38 is a schematic first perspective view of the first filter cartridge of the air cleaner assembly shown in FIG. 24.

FIG. 39 is a schematic side view of the first filter cartridge shown in FIG. 38.

FIG. 40 is a schematic side view of the first filter cartridge shown in FIG. 38, with the cartridge shown in the initial tilted position.

FIG. 41 is a schematic top view of the first filter cartridge shown in FIG. 38.

FIG. 42 is a schematic bottom view of the first filter cartridge shown in FIG. 38.

FIG. 43 is a schematic inlet end or first end view of the first filter cartridge shown in FIG. 38.

FIG. 44 is a schematic outlet end or second end view of the first filter cartridge shown in FIG. 38.

FIG. 45 is a schematic first perspective view of the second filter cartridge of the air cleaner assembly shown in FIG. 24.

FIG. 46 is a schematic second perspective view of the second filter cartridge shown in FIG. 44.

FIG. 47 is a schematic first face view of the second filter cartridge shown in FIG. 44.

FIG. 48 is a schematic second face view of the second filter cartridge shown in FIG. 44.

FIG. 49 is a schematic first side view of the second filter cartridge shown in FIG. 44.

FIG. 50 is a schematic second side view of the second filter cartridge shown in FIG. 44.

FIG. 51 is a schematic third side view of the second filter cartridge shown in FIG. 44.

FIG. 52 is a schematic fourth side view of the second filter cartridge shown in FIG. 44.

FIG. 53 is a schematic exploded perspective view of the second filter cartridge shown in FIG. 45.

FIG. 54 is a schematic exploded perspective view of the second filter cartridge shown in FIG. 45.

FIG. 55 is a schematic partial perspective view of an alternative air cleaner configuration and catch arrangement having features usable with the air cleaner housings and filter cartridges of FIGS. 1-23 and 24-54.

FIG. 56 is a schematic partial perspective view of the second part of the catch arrangement associated with the housing shown in FIG. 55.

FIG. 57 is a schematic partial side cross-sectional view of the air cleaner catch arrangement shown in FIG. 55 with the filter cartridge in the tilted position.

FIG. 58 is a schematic partial side cross-sectional view of the air cleaner catch arrangement shown in FIG. 51 with the filter cartridge in the installed position.

FIG. 59 is a schematic perspective view of the first filter cartridge of the air cleaner shown in FIG. 55.

FIG. 60 is a schematic side view of the filter cartridge shown in FIG. 59.

FIG. 61 is a schematic cross-sectional side view of the filter cartridge shown in FIG. 59.

FIG. 62 is a schematic partial top-rear perspective view of the filter cartridge shown in FIG. 59.

FIG. 63 is a schematic partial top-front perspective view of the filter cartridge shown in FIG. 59.

FIG. 64 is a schematic partial top view of the filter cartridge shown in FIG. 59.

FIG. 65 is a fragmentary, schematic, perspective view of a first example media type useable in arrangements according to the present disclosure.

FIG. 66 is an enlarged, schematic, cross-sectional view of a portion of the media type depicted in FIG. 65.

FIG. 67 includes schematic views of examples of various fluted media definitions, for media of the type of FIGS. 65 and 66.

FIG. 68 is a schematic view of an example process for manufacturing media of the type of FIGS. 65-67.

FIG. 69 is a schematic cross-sectional view of an optional end dart for media flutes of the type of FIGS. 65-68.

FIG. 70 is a schematic perspective view of a coiled filter arrangement usable in a filter cartridge having features in accord with the present disclosure, and made with a strip of media for example in accord with FIG. 65.

FIG. 71 is a schematic perspective view of a stacked media pack arrangement usable in a filter arrangement having selected features in accord with the present disclosure and made from a strip of media for example in accord with FIG. 65.

FIG. 72 is a schematic flow end view of a filter media pack using an alternate media to the media of FIG. 65, and alternately usable in selected filter cartridges in accord with the present disclosure.

FIG. 73 is a schematic opposite flow end view to the view of FIG. 72.

FIG. 74 is a schematic cross-sectional view of the media pack of FIGS. 72 and 73.

FIG. 75 is a schematic, fragmentary, cross-sectional view of a further alternate media type usable in a media pack of a filter cartridge having features in accord with the present disclosure.

FIG. 76 is a schematic, fragmentary cross-sectional view, of a first variation of the media type of FIG. 75.

FIG. 77 is a schematic fragmentary depiction of another usable fluted sheet/facing sheet combination in accord with the present disclosure.

FIG. 78 is a fragmentary second schematic view of the type of media in FIG. 77 shown in a media pack.

FIG. 79 is a schematic, fragmentary, plan view of still another media variation usable in arrangements according to the present disclosure.

FIG. 80 is a schematic view of another variation of usable media in accord with the present disclosure.

FIG. 81 is a schematic depiction of another usable fluted sheet/facing sheet combination in accord with the present disclosure.

FIG. 82 is a perspective view of a portion of the usable fluted sheet/facing sheet combination depicted in FIG. 81.

FIG. 83 is a perspective view of another media variation useable in arrangements according to the present disclosure.

FIG. 84 is a schematic, perspective view of a portion of a support section of the filter media of FIG. 83, illustrated in a folded configuration but expanded or separated for illustrative purposes.

FIG. 85 is a schematic, cross-sectional view of a portion of the support section of the filter media of FIG. 83, illustrated in a folded configuration but expanded or separated for illustrative purposes.

FIG. 86 is a perspective view of another media variation useable in arrangements according to the present disclosure.

FIG. 87 is a schematic depiction of an equipment assembly including an air cleaner according to the present disclosure.

### DETAILED DESCRIPTION

Herein, example filter assemblies, features, and components thereof are described and depicted. A variety of specific features and components are characterized in detail. Many can be applied to provide advantage. There is no specific requirement that the various individual features and components be applied in an overall assembly with all of the features and characteristics described, however, in order to provide for some benefit in accord with the present disclosure.

### I. Some General Issues Relating to Air Cleaner Design and Servicing

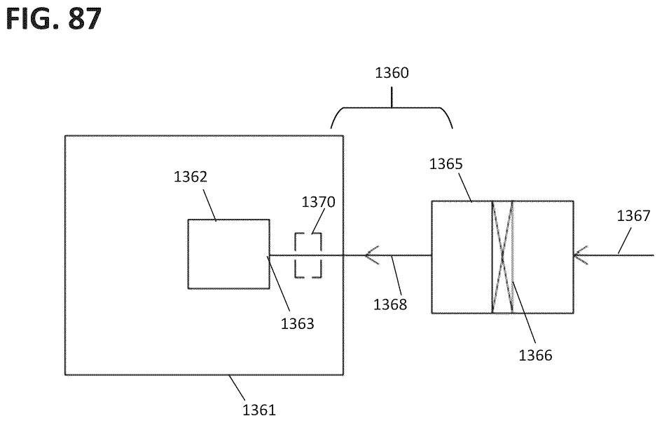

### A. An Equipment System Using an Air Cleaner Assembly, Generally, FIG. 87

In FIG. 87, a schematic depiction of an engine equipment arrangement 1360 is depicted. The equipment system 1360, in the example, comprises a vehicle or other equipment 361 having an internal combustion engine arrangement 1362 with a combustion air intake 1363. The equipment arrangement 1360 includes an air cleaner system 1365 having a filter arrangement 1366 therein, typically comprising a serviceable (i.e. removable and replaceable) filter cartridge. The air cleaner system 1365 and filter arrangement 1366 can include any of the below-described air cleaners and filter cartridges, and combinations thereof. Intake air to the system is shown at 1367 directed into the air cleaner assembly 1365 before filtering of unfiltered air through media of the filter cartridge arrangement 1366. At 1368, filtered air is shown being directed into the equipment air intake 1363. At 1370, optional equipment such as turbo system is shown.

Of course, alternate equipment systems can be represented by arrangements analogous to those of FIG. 87. The equipment system can be for example, an industrial air filter, an air cleaner arrangement used in association with a turbine, etc. The use in association with an internal combustion engine is typical, but not specifically required for many of the principles characterized herein.

B. Ensuring that a Cartridge Installable in the Air Cleaner is an Appropriate One for the Air Cleaner of Concern

In general, air cleaners such as used to filter equipment intake air, comprise housings having positioned therein at least a main filter cartridge, and sometimes, a secondary. The main filter cartridge generally is constructed to collect particulate contaminant as it flows into the air intake stream for the equipment. This protects the equipment against damage. Such filter cartridges are generally configured to be removed and replaced, i.e. they are service parts. At various defined service intervals, and/or as increase in restriction (from dust load) becomes an issue, the cartridges are removed from the air cleaner and are refurbished or replaced.

In many instances, the cartridges are specifically designed to match the equipment manufacturers' requirements for operation. It is important to ensure that the cartridge, which is replaced in the field, is a proper one for the equipment involved, and, thus fits and seals properly.

In general, a primary interface between the filter cartridge and the air cleaner is along a housing seal. This interface has sometimes been used to help ensure that a cartridge that fits is also a proper one for the system of interest. Examples are provided by the descriptions of U.S. Pat. No. 8,864,866, the disclosure of which is incorporated herein by reference. In that particular reference, seal surface variations through projections and/or recesses are described, in general terms. Those general principles are applied herein, with improvements and variations for certain applications.

C. Observations Concerning Issues with Installation of Cartridges in Systems in which the Housing Radial Seal of Interest is Deeply Recessed in the Housing; and/or, when Side-Load is Involved

In many instances, the seal surface to be engaged by a seal on the cartridge is deeply recessed within a housing, and out of view of the service provider. In addition, it can be difficult, if not impossible, to manually reach the seal surface as the cartridge is being installed, due to the size of the housing, and a blocking effect of the cartridge. An issue with using cartridges having seals which are not merely of simple or uniform geometric shape, such as circular or oval is that it, can be difficult, depending on the design, to orient the cartridge appropriately for the sealing to properly occur during installation. Certain of the techniques characterized herein are useful to facilitate this, in application, as will be understood from the further detailed descriptions above.

The problem can sometimes be exacerbated, when the cartridge is configured for side load. By side load, reference is meant to the portion of the housing through which the cartridge is installed in use. In particular, and in some instances, a straight through flow cartridge is loaded through the side of a housing and then pushed sideways into a sealing positioned. It can be difficult to manipulate and leverage the cartridge appropriately to get good sealing. Examples of advantageous side load arrangements with useful features to facilitate loading are described, for example in U.S. Pat. Nos. 7,396,375; 7,655,074; 7,905,936; 7,713,321 and 7,972,404, incorporated herein by reference.

The arrangements of the references identified in the previous paragraph, generally use oval shaped seals, typically racetrack shaped ovals. (shapes with straight sides separated by semi-circular curved ends in the seal surface). When the desire is to introduce a variation in the seal surface, it can sometimes be difficult, depending on how implemented, to get good, convenient, installation in a side load application. Some principles described herein are characterized to be particularly useful in such situations, to facilitate loading.

### II. Example Air Cleaners and Filter Cartridges

### A. Air Cleaner 100

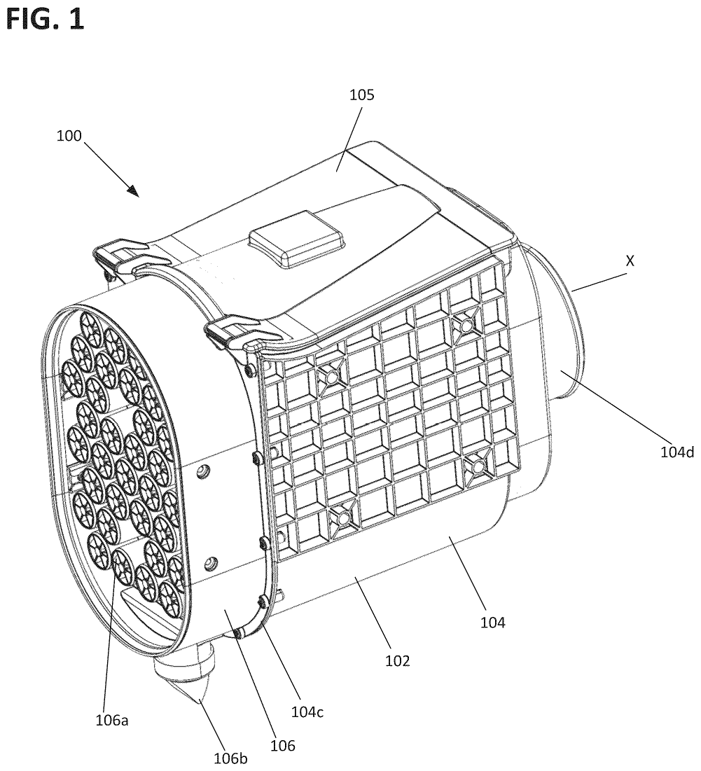

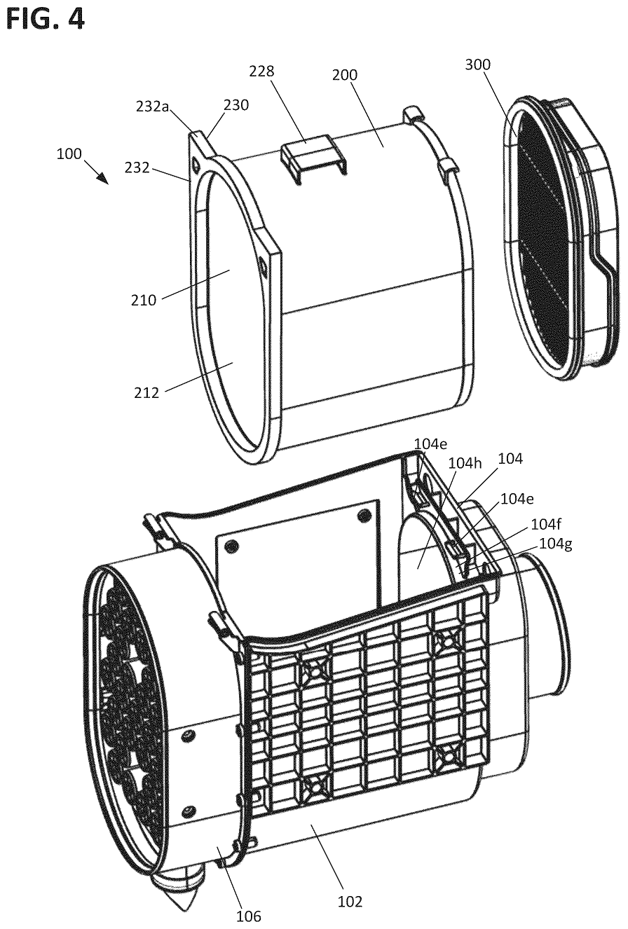

Referring to FIGS. 1 to 4, an air cleaner assembly 100 is presented. In one aspect, the air cleaner assembly 100 includes a housing assembly 102, a first filter cartridge 200, and a second filter cartridge 300 extending along a longitudinal axis X. The first filter cartridge 200 may be referred to by various terms that are generally interchangeable, such as a primary filter cartridge or a main filter cartridge. The second filter cartridge 300 may be referred to by various terms that are generally interchangeable, such as a secondary filter cartridge or a safety filter cartridge. As used herein, the terms “axial” and “axially” generally refer to a direction that is parallel to the longitudinal axis X while the term “radially” generally refers to a direction that is orthogonal to the longitudinal axis X. As also used herein, the term “radially inward” generally refers to a direction facing towards the longitudinal axis X while the term “radially outward” generally refers to a direction facing away from the longitudinal axis X. As used herein, the term “located radially” generally refers to a component or feature is located further or closer to the longitudinal axis X in the radial direction relative to another component or feature, and not necessarily that the component or feature is located on a common radial line with the other component or feature. As used herein, the term “located axially” generally refers to a component or feature is located in a specified axial direction relative to another component or feature, and not necessarily that the component or feature is located on a common axial line with the other component or feature. Similarly, the term “located axially between” generally refers to a component or feature that is located between two other components in the axial direction and not necessarily that the component or feature is located on a common line or axis between the two other components.

As shown, the housing assembly 102 can be configured with a main housing 104 and a cover 105 that allow for an interior volume 104a of the main housing 104 to be accessed through an opening 104b. The cover can be of any known type and secured to the main housing 104 using any number of methods or approaches known in the art, for example by over-center latches, interacting lugs, and the like. In the example shown, the cover 105 is pivotally secured to the main housing 104. In one aspect, a seal member 107 circumscribing the opening 104b may be provided to form a seal between the housing 104 and the cover 105. In one aspect, the main housing 104 and interior volume 104a extend between an inlet end 104c and an outlet end 104d. As discussed below in more detail, the housing also defines a pair of receiving features 104e for engaging with corresponding features on the filter cartridge 200. The housing 104 is further shown as being provided with an axially extending sidewall 104f located within the interior volume 104a and defining a radially outwardly facing seal surface 104g. As discussed later, a seal arrangement of the filter cartridge 300 forms a seal against the seal surface 104g. The axially extending sidewall 104f also defines a radially inward facing seal surface 104h against which the seal arrangement, at a different location, of the filter cartridge 300 forms a seal. While the seal surfaces 104g, 104h are formed on opposite sides of a common sidewall 104f, the main housing 104 can be alternatively arranged such that the seal surfaces are formed on different sidewalls of the housing.

In one aspect, the air cleaner assembly 100 includes a pre-cleaner assembly 106 mounted to the main housing 104 at the inlet end 104c. In the example shown, the pre-cleaner assembly 106 is presented as a two-stage air cleaner assembly, and includes a plurality of separator tube arrangements 106a. The pre-cleaner assembly 106 is usable to preclean selected material (contaminant) carried by an air stream into the air cleaner assembly 100, before the air reaches the first filter cartridge 200 positioned therein. Such precleaning generally leads to substantial removal of liquid particulate such as rainwater or splashed water, etc. and/or various (especially larger) dust or other particles. In the example shown, contaminants removed by the pre-cleaner assembly 106 can be discharged though an ejection port 106b.

### B. Filter Cartridge 200

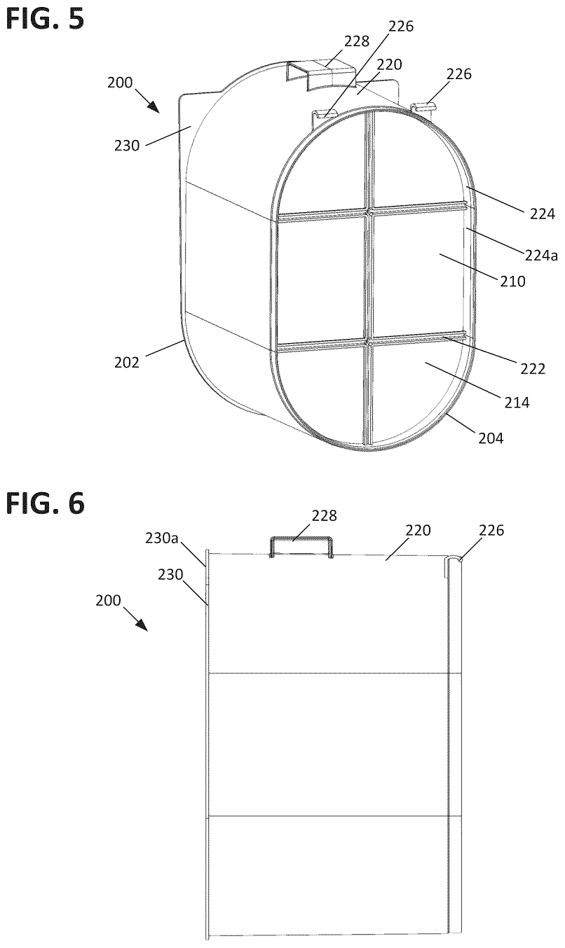

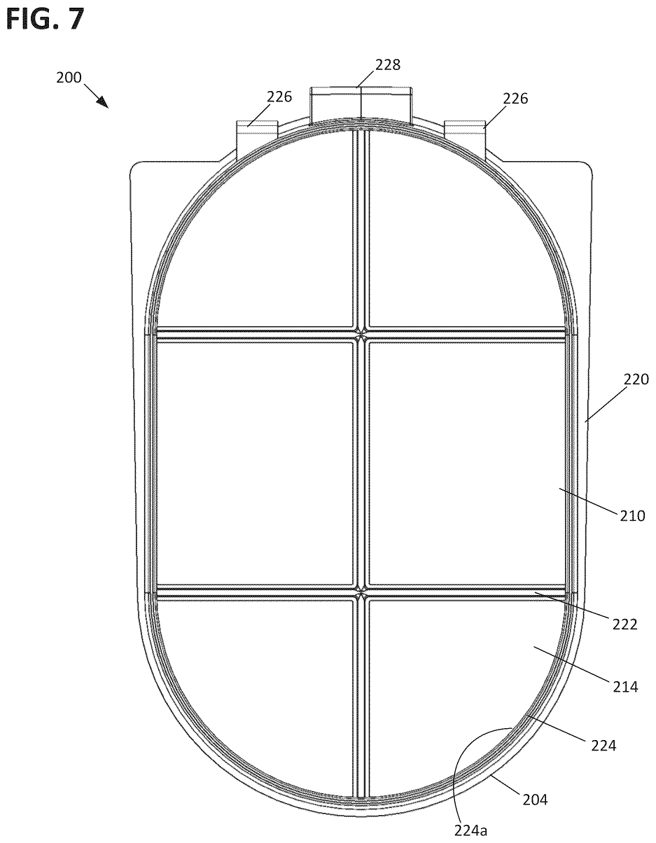

Referring now to FIGS. 5-7, an exemplary embodiment of a first filter cartridge 200 of air cleaner assembly 100 is illustrated. The filter cartridge 200 extends between a first end 202 and a second end 204. In one aspect, the first end 202 can be characterized as the upstream end of the filter cartridge 200 while the second end 204 can be characterized as the downstream end of the filter cartridge 200. The filter cartridge 200 can be considered to be the main or primary filter cartridge (or element), and is used to selectively separate a desired amount of particulate or contaminant material.

Filter cartridge 200 is generally a serviceable part or removable component, such that it is periodically removable and replaceable as desired or necessary during the lifetime of the air cleaner assembly 100. In particular, when the filter cartridge 200 becomes occluded or otherwise needs to be replaced, the filter cartridge 200 can be removed from the housing 104, for example by a handle 228, after removing or displacing the cover. After such removal, another filter cartridge 200 can be placed in the housing 104 by inserting the filter cartridge 200 into the interior volume 104a via opening 104b.

The filter cartridge 200 generally includes a media pack 210. In the example shown, the media pack 210 has inlet flow end 212 for receiving unfiltered air or pre-cleaned air from the pre-cleaner (if provided) and an outlet flow end 214 for delivering filtered air. In the example shown, the media pack 210 has an obround cross-sectional shape. However, other shapes are possible, such as round, oval, and rectangular cross-sectional shapes. In one aspect, the media pack 210 defines an outer perimeter extending between the inlet and outlet flow ends 212, 214. In the example shown, the media pack 210 is formed from a coiled media construction, for example a media construction having a fluted (typically corrugated) media sheet and a facing media sheet that together define parallel flutes to form a fluted or z-filter media construction. Suitable media constructions for the media pack 210 are discussed in more detail in the Media Types and Configurations section.

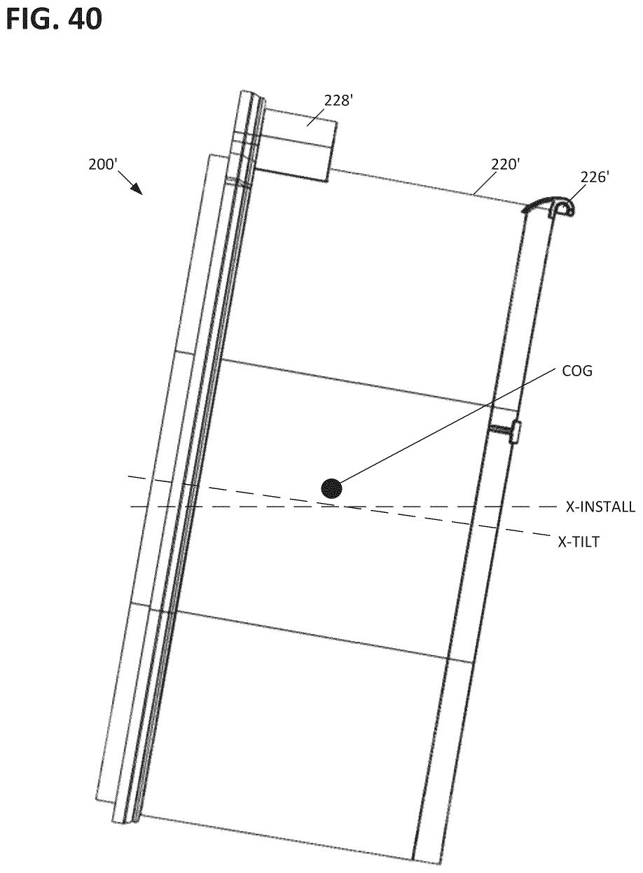

In one aspect, a shell 220 is provided that circumscribes the media pack 210 outer perimeter. In one aspect, the shell 220 can be characterized as being peripherally arranged about the outer perimeter of the media pack 210. In one aspect, the shell 220 can be characterized as peripherally supporting at least a portion of the media pack 210 in a radial direction. In some examples, an adhesive is used to secure the media pack 210 within the shell 220. In some examples, the media pack 210 has an interference fit with the shell 220. In the examples shown, the shell 220 has a single-piece construction. However, the shell 220 can be provided in multiple parts, for example in two mating halves. In the example shown, the shell 220 includes a support structure 222 located at the downstream face of the media pack 210. The support structure 222 can include multiple ribs or bridging segments to support the media pack 210 end face. With such a construction, the shell 220 can also be characterized as axially supporting the media pack 210. The shell 220 is further shown as defining an axial flange 224 extending beyond the support structure 222 and the media pack 210, at the second end 204. The axial flange 224 defines a radially inward facing sealing surface 224a. As discussed later, a seal associated with the filter cartridge 300 forms a seal against the seal surface 224a when both the filter cartridges 200, 300 are fully installed within the housing. As most easily seen at FIGS. 5 and 6, the shell 220 is also provided with, proximate the inlet flow end 212, a radially extending flange 230 presenting an axially face 230a for supporting a seal arrangement 232. For clarity, the seal arrangement 232 is not shown at FIGS. 5 and 6, but is shown at FIGS. 1 to 4. In one example, the seal arrangement 232 is over-molded onto the flange 230. In another example, the seal arrangement 232 is separately formed and later secured to the face 230a with an adhesive or by other means. In one aspect, the seal arrangement 232 defines a radial sealing surface 232a about the outer perimeter of the seal arrangement 232. The radial sealing surface 232a forms a seal with the main housing 104 and with the cover 105 and serves to ensure treated air from the pre-cleaner assembly 106 is guided to the inlet flow end 212 of the media pack 210. This arrangement also aids in guiding the filter cartridge 200, in a method of installation, from the initial tilted position into the fully installed position in that the interaction between the main housing 104 and the seal arrangement 232 operates to fix the lateral and axial rotational position of the cartridge 200. With reference to FIG. 40, filter cartridge 200′ is shown in the tilted position and shows the longitudinal axis of the filter cartridge 200′ in the tilted position as X-TILT and shows the longitudinal axis of the filter cartridge 200′ in the installed position as X-INSTALL. These orientations and following description are applicable to both filter cartridge 200 and 200′. In the tilted position, the longitudinal axis X-TILT of the filter cartridge is at an oblique angle in comparison to the longitudinal axis X-INSTALL of the filter cartridge when in the installed position. In the installed position, the longitudinal axis of the filter cartridge is parallel to the air cleaner longitudinal axis X. In the tilted position, the longitudinal axis of the filter cartridge is at an oblique angle to the air cleaner longitudinal axis X.

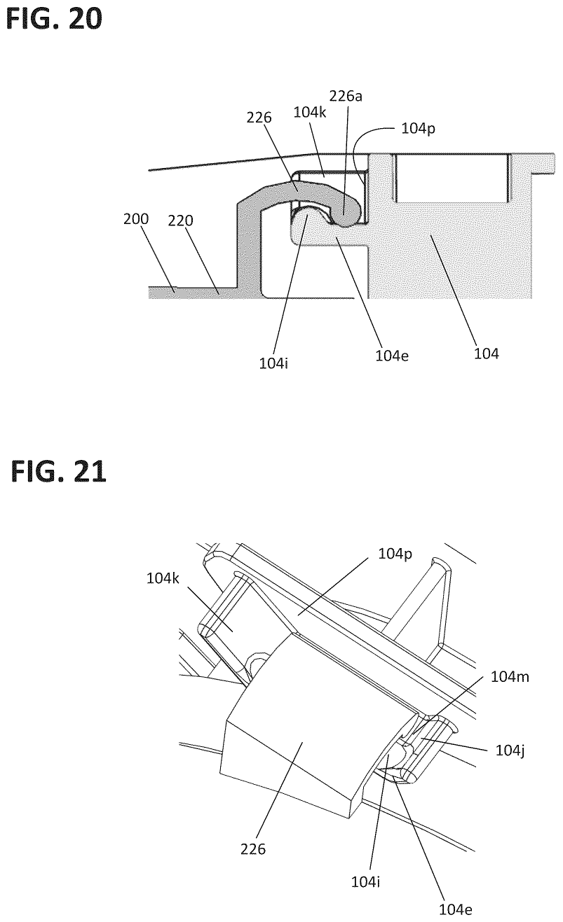

The shell 220 is also shown as defining a pair of locating features 226 that engage with corresponding receiving features 104e on the housing 104. Although two locating features 226 are shown, more or fewer appropriately positioned locating features may be utilized. In one characterization, the locating and receiving features 226, 104e may be referred to as a catch arrangement in which the locating feature(s) 226 form a first part of the catch arrangement and in which the receiving feature(s) 104e form a second part of the catch arrangement. In one aspect, the first part of the catch arrangement extends beyond the outlet flow end of the media pack 220 and also extends radially beyond the outer perimeter of the media pack 220. As most easily seen at FIGS. 20 and 21, the locating features 226 and receiving features 104e readily engage with each other as they are provided as complementary detent-type hook-shaped members 226a, 104i. In one aspect, the member 226a presents a convex curved surface that engages with the receiving feature 104e. In some examples, the receiving feature 104e can be provided with a correspondingly shaped concave surface. In one aspect, the receiving features 104e are additionally provided with sloped or ramped surfaces 104j, 104k that, in a method of installation, guide the locating features 226 such that the filter cartridge 200 is laterally guided into a centered alignment position with respect to the filter cartridge 300 and housing assembly 102. Together, the surfaces 104i, 104j, 104k and a sidewall surface 104p of the housing define a trough region 104m within which each locating feature 226 is received and retained. Together, these features help guide the installation of the filter cartridge 200 and ensures that the filter cartridge will only sealingly engage with a properly seated filter cartridge 300. The interaction between the locating features 226 and receiving features 104e, once engaged, secures the position of the filter cartridge 200 in an axial position such that relative movement between the filter cartridges 200, 300 is resisted, thus ensuring the seal formed between them is maintained.

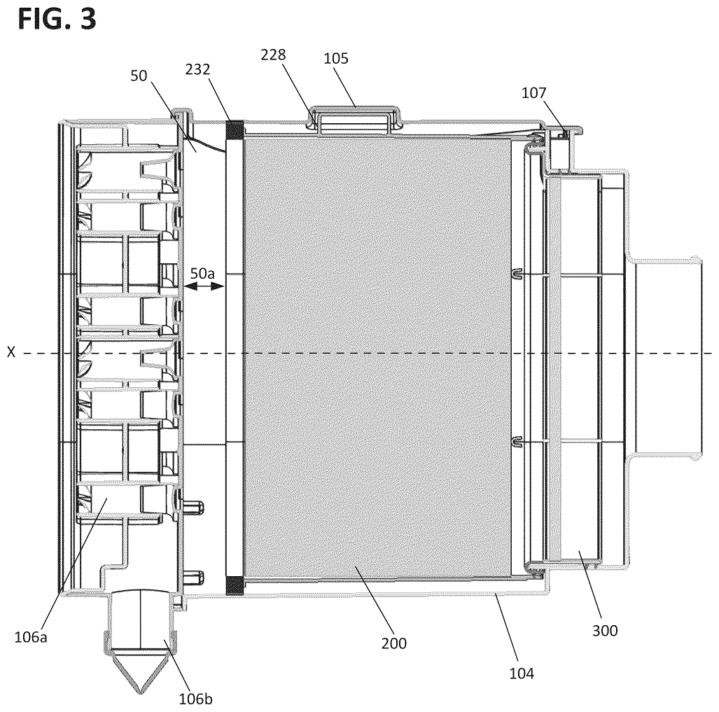

Referring to FIG. 3, it can be seen that an axial area or gap 50 exists between the end of the filter cartridge 200 and the pre-cleaner 106 having an axial dimension 50a. This gap 50 provides clearance for the filter cartridge 200 to be inserted into the interior volume 104a of the housing at a first angle in which the second end 204 hangs lower than the first end 202. In one example, the first angle is about 3 degrees relative to a plane orthogonal to the longitudinal axis X. In some examples, the first angle is between 2 and 10 degrees. Notably, the handle 228 is positioned axially between the ends 202, 204 such that the cartridge naturally hangs at the first angle. Accordingly, when an operator lowers the filter cartridge 200 into the interior volume 104a, the locating features 226 contact the receiving features 104e and the filter cartridge 200 is brought into lateral alignment with the housing 104 and filter cartridge 300. As the operator continues to lower the filter cartridge 200, the filter cartridge will rotate about the contact points between the locating features 206 and receiving features 104e until the filter cartridge 200 is fully installed with the longitudinal axis of the filter cartridge 200 aligning with that of the housing, whereby the flange 224 is brought into sealing engagement with the filter cartridge 300, as discussed in further detail below. The removal of the filter cartridge 200 from the housing 104 is the reverse operation, whereby an operator pulls up on the handle 228 such that the filter cartridge naturally rotates back to the first angle and out of engagement with the filter cartridge 300.

The shell 220 may be secured to the media pack 210 by an adhesive. The shell 220 is also shown as integrally forming the above-discussed handle 228. In one aspect, the shell 220 of the filter cartridge 200 is formed from a polymeric material, such as nylon, polypropylene, or ABS plastic.

### C. Filter Cartridge 300

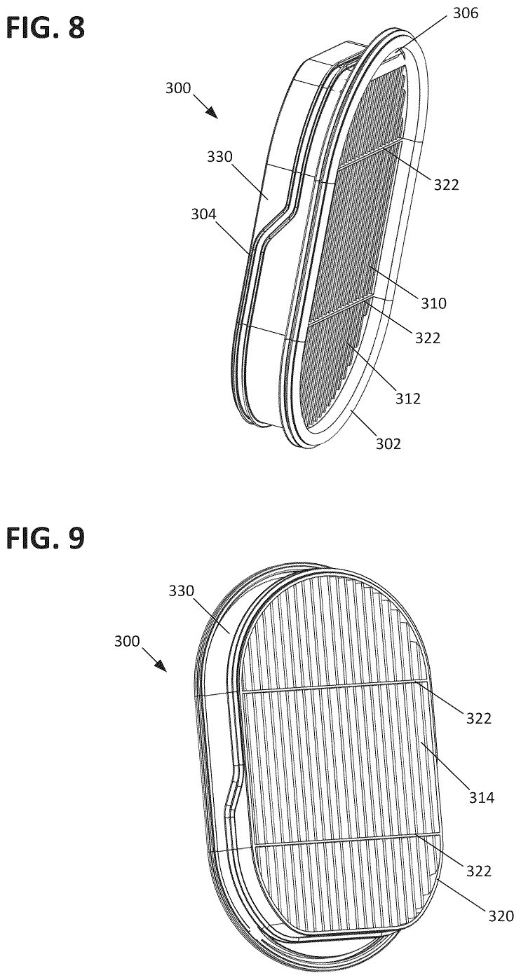

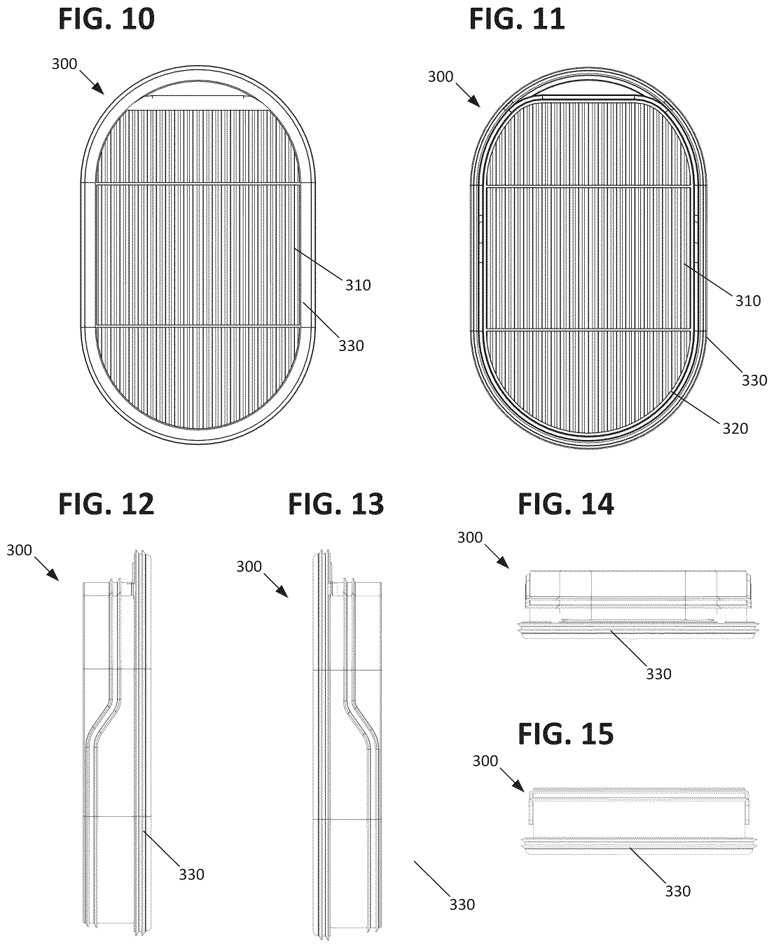

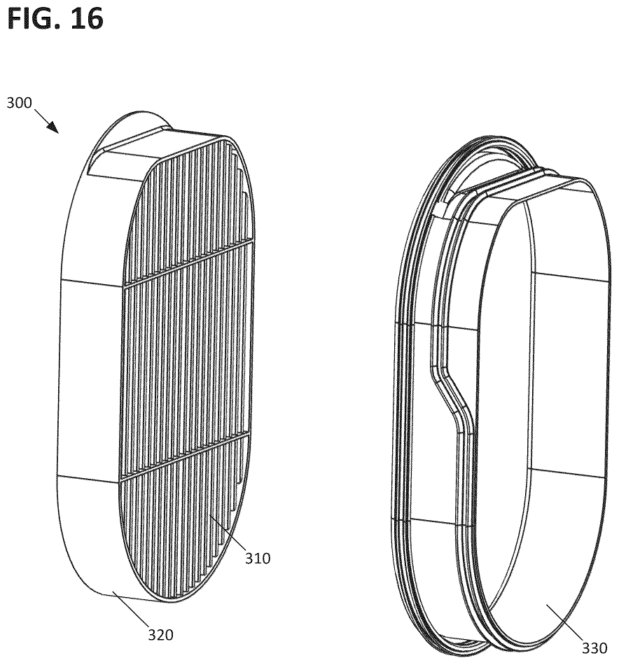

Referring now to FIGS. 8-17, an exemplary embodiment of a second filter cartridge 300 of air cleaner assembly 100 is illustrated. The filter cartridge 300 extends between a first end 302 and a second end 304. In one aspect, the first end 302 can be characterized as the upstream end of the filter cartridge 300 while the second end 304 can be characterized as the downstream end of the filter cartridge 300. The filter cartridge 300 can be considered to be the secondary or safety filter cartridge (or element), and is used to selectively separate a desired amount of particulate or contaminant material.

Filter cartridge 300 is generally a serviceable part or removable component, such that it is periodically removable and replaceable as desired or necessary during the lifetime of the air cleaner assembly 100. In particular, when the cartridge 300 becomes occluded or otherwise needs to be replaced, the cartridge 300 can be removed from the housing 104, for example by a handle portion 306, after removing or displacing the cover and removing the filter cartridge 200. After such removal, another filter cartridge 300 can be placed in the housing 104 by inserting the filter cartridge 300 into the interior volume 104a via opening 104b.

The filter cartridge 300 generally includes a media pack 310. In the example shown, the media pack 310 has inlet flow end 312 for receiving air filtered from filter cartridge 200 and an outlet flow end 314 for delivering filtered air. In the example shown, the media pack 310 has an obround cross-sectional shape. However, other shapes are possible, such as round, oval, and polygonal (e.g. rectangular) cross-sectional shapes. In one aspect, the media pack 310 defines an outer perimeter extending between the inlet and outlet flow ends 312, 314. In the example shown, the media pack 310 is formed from a pleated media construction. Suitable media constructions for the media pack 310 are discussed in more detail in the Media Types and Configurations section.

In one aspect, a shell 320 is provided that circumscribes the media pack 310 outer perimeter. In one aspect, the shell 320 can be characterized as being peripherally arranged about the outer perimeter of the media pack 310. In one aspect, the shell 320 can be characterized as peripherally supporting at least a portion of the media pack 310 in a radial direction. In some examples, an adhesive is used to secure the media pack 310 within the shell 320. In some examples, the media pack 310 has an interference fit with the shell 320. In the examples shown, the shell 320 has a single-piece construction. However, the shell 320 can be provided in multiple parts, for example in two mating halves. In the example shown, the shell 320 includes a support structure 322. The support structure 322 can include multiple ribs or bridging segments to support the media pack 310. With such a construction, the shell 320 can also be characterized as axially supporting the media pack 310.

In one aspect, the filter cartridge 300 includes a seal member 330 peripherally arranged about and circumscribing the media pack 310 and shell 320. Herein, the principles described are characterized as implemented specifically in arrangements in which a housing seal positioned on the filter cartridge, is a “radial” or “radially directed” seal. By this, reference is meant to a seal that is used to apply compressive seal forces directed either: generally toward a surrounding portion of a housing; or, alternately, with seal forces directed toward a portion of housing surrounded by the seal, for the sealing during use. With filter cartridges of the type characterized herein, a radial seal will generally be a seal that surrounds a flow passageway, with primary compressive direction (when installed) being toward or away from that flow passageway. An outwardly or radially outwardly directed seal will be one which has a seal surface on the seal arrangement (of the cartridge) that sealingly engages a surrounding structure in use. A radially inwardly directed seal, is a seal arrangement in which the seal surface of the cartridge surrounds the structure to which it sealed during use.

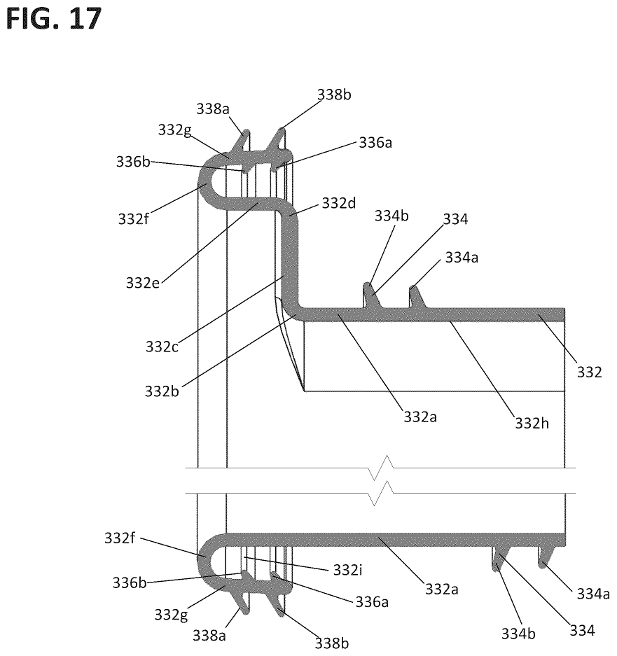

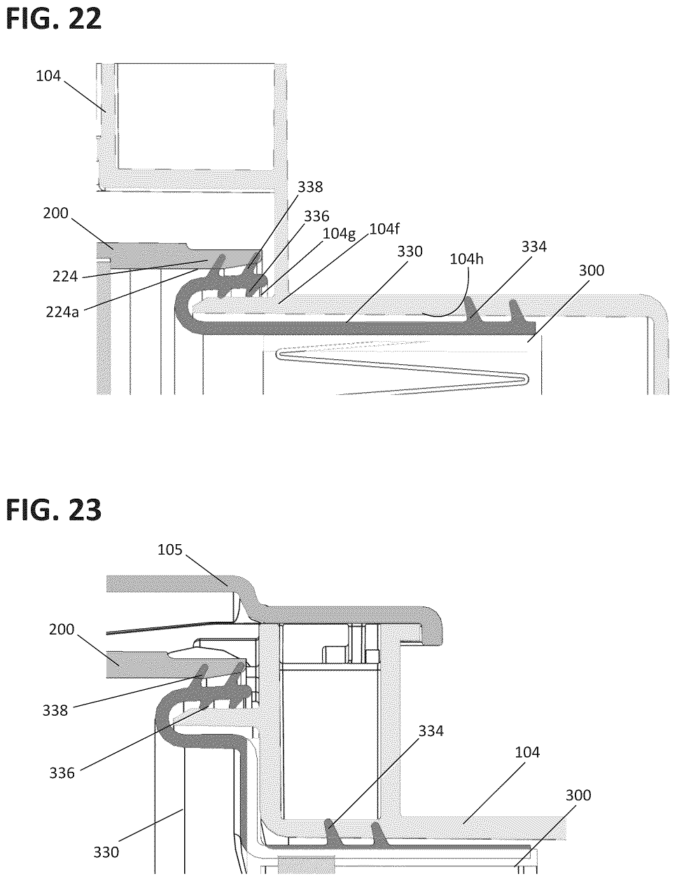

As most easily viewed at the cross-sectional views of the seal member 330 provided at FIGS. 17, 22, and 23, the seal member 330 can include a base member 332 including multiple segments or portions, for example segments or portions 332a to 332g. In the particular example shown, segments 332a, 332e, 332g extend in an axial direction while segment 332c extends in a radial direction, with segment 332b providing a transition between segments 332a, 332c, segment 333d providing a transition between segments 332c, 332e, and segment 332f providing a transition between segments 332e, 332g. In the configuration shown, the segments 332g and 332a are generally parallel to each other and form a trough region 332i extending to section 332f, within which seal arrangement 336 is located. In one aspect, the seal member 330 is secured to the shell 320 at a radially inwardly facing side 332h of the segment 332a. It is noted that segments 332b to 332g are only provided at the end of the filter cartridge 300 including the handle portion 306 to enable seal member arrangements 336 and 338 to circumscribe or follow the outer perimeter of the handle portion 306. A view of this portion of the seal member 330 is provided at FIG. 23. The remaining sections of the seal member 330 are similar to the configuration shown at the lower portion of FIG. 17 in which the section 332a extends to section 332f. A top cross-sectional view of this portion of the seal member 330 is also shown at FIG. 22. It is noted that the drawings, for example FIGS. 22 and 23, show the seal arrangements in their non-deflected states while installed within the housing such that overlap between the seal members and housing exists. However, a skilled person will easily and readily appreciate that the seal members of the seal arrangements will be deflected by the surfaces of the housing once installed within the housing. In the example shown, the seal member 330 extends on the shell 320 between the inlet flow end 312 to the outlet flow end 314 of the cartridge 300 to completely cover the shell 320. However, other configurations are possible, wherein the seal member 330 only partially covers the shell 320, as is the case for filter cartridge 300′, presented below.

In one aspect, the seal member 330 includes a plurality of seal arrangements 334, 336, 338 extending from the base member 332. The seal arrangements 334, 336, 338 ensure that an appropriate seal is formed between the filter cartridges 200, 300 and the housing assembly 102 such that air delivered from the outlet end 104d must first pass through both filter cartridges. In one aspect, and as most easily seen at FIG. 17, the base of the seal arrangement 334, proximate section 332a, is located radially closer to the longitudinal axis of the filter cartridge 300 and the outer perimeter of the media pack 320 in comparison to the base of the seal arrangement 336, proximate section 332g. In one aspect, the base of the seal arrangement 338, proximate section 332g, is located further from the longitudinal axis of the filter cartridge 300 and the outer perimeter of the media pack 320 than the bases of both the seal arrangements 3344, 336. Accordingly, in general terms, the seal arrangement 332 can be characterized as being radially closest to the longitudinal axis and media pack outer perimeter, the seal arrangement 338 can be characterized as being radially furthest from the longitudinal axis and media pack outer perimeter, and the seal arrangement 336 can be characterized as being between located at an intermediate radial distance between the seal arrangements 334, 338.

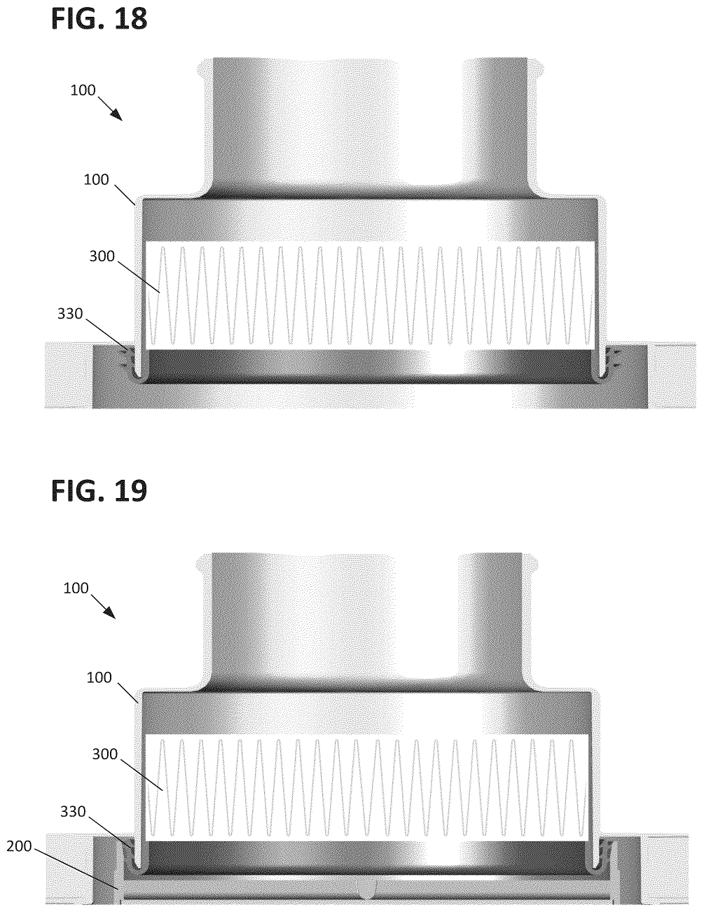

As shown, the seal arrangement 334 includes a pair of seal members 334a, 334b extending from the segment 332a. Although two seal members 334a are shown, more or fewer seal members 334a may be provided, such as one or three seal members 334a. In some examples, the seal members are lip seals. In some examples, the lip seals are tapered lip seals. Although the lip seals 334a, 334b can be provided with the same length, the lip seal 334b is longer than the lip seal 334a in the presented example, which can provide for improved sealing and easier installation. In one aspect, the lip seals 334a, 334b extend at an oblique angle from the segment 332a in a radially outward direction and towards the first end 302 of the filter cartridge 300. Accordingly, the seal arrangement 334 can be characterized as being a radially outwardly directed seal arrangement. As the seal arrangements 334, 338 are angled in the same direction as the insertion direction of the filter cartridge 300, the oblique angle provides for ease of installation. Further, as the seal arrangements 334, 336 are angled towards the higher pressure side of the air cleaner (i.e., angled in the upstream flow direction), the seals are angled to provide additional sealing against the housing by the internal air pressure. When the filter cartridge 300 is installed into the housing 104, the seal arrangement 334 forms a seal against the housing at the radially inward facing seal surface 104h, as most easily viewed at FIGS. 18 and 19. In alternative examples, the lip seals 334a, 334b extend in the opposite oblique direction or extend orthogonally from the segment 332a.

In the example shown, the seal arrangement 334 deviates in an axial direction such that one portion of the seal arrangement 334 is closer to the inlet or outlet flow end 312, 314 in comparison to another portion of the seal arrangement 334 while the seal arrangements 336, 338 are arranged along a plane parallel to the inlet and outlet flow ends 312, 314. Accordingly, an axial distance between the seal arrangement 334 and the seal arrangements 336, 338 is variable with the axial gap 50 being smallest at a location proximate the handle portion 306 and the axial gap being the largest at the opposite end of the cartridge 300. Other arrangements exist. For example, the seal arrangements 336, 338 could also be configured to deviate in an axial direction. For example, the seal arrangement 334 could be configured to be arranged along a plane parallel to the inlet and outlet flow ends 312, 314. In some examples, all of the seal arrangements 334, 336, 338 deviate in an axial direction. In some examples, none of the seal arrangements 334, 336, 338 deviate in an axial direction.

As shown, the seal arrangement 336 includes a pair of seal members 336a, 336b extending from the segment 332g. In some examples, the seal members are lip seals. In some examples, the lip seals are tapered lip seals. Although the lip seals 336a, 336b can be provided with the same length, the lip seal 336b is longer than the lip seal 336a in the presented example, which can provide for improved sealing and easier installation. In one aspect, the lip seals 336a, 336b extend at an oblique angle from the segment 332g in a radially inward direction and towards the first end 302 of the filter cartridge 300. Accordingly, the seal arrangement 336 can be characterized as being a radially inward directed seal arrangement. As the seals are angled in the same direction as the insertion direction of the filter cartridge 300, this oblique angle provides for ease of installation. In an alternative arrangement, the seals are angled towards the higher pressure side of the air cleaner (i.e., angled in the upstream flow direction) such that the seals are angled to provide additional sealing against the housing by the internal air pressure. When the filter cartridge 300 is installed into the housing 104, the seal arrangement 336 forms a seal against the housing at the radially outward facing seal surface 104g, as most easily viewed at FIGS. 18 and 19. In alternative examples, the lip seals 336a, 336b extend in the opposite oblique direction or extend orthogonally from the segment 332g.

In one aspect, as the seal arrangement 336 abuts the housing after installation of the filter cartridge 300, the seal arrangement 336 provides a reaction or back-up force that aids in ensuring that the seal arrangement 338 is held in a radial position sufficient to form a seal with the housing. In some examples, the seal arrangement 336 could be formed for only this purpose without necessarily forming a seal with the housing while still contacting the housing to provide the advantageous reaction force. In such cases, the seal arrangement 336 could be referred to as a positioning arrangement 336. When configured as such, it would not be necessary that the positioning arrangement 336 continuously contact the outer perimeter of the housing surface as no seal needs to be maintained. Accordingly, a positioning arrangement 336 could include spaced apart members circumferentially oriented about the housing perimeter surface. In cases where arrangement 336 is configured such that a continuous seal is not formed with the housing main body 104, it is noted that there would no longer be a pair of seals in a series arrangement. As such, if a leak were to occur with seal arrangement 334 in such a configuration, a leak around the filter cartridge would result 300. It is also noted that with such a configuration, sections 332b-g, and the portion of section 332a between section 332b and seal arrangement 334, should be continuous to ensure that air does not bypass around filter cartridge 200 before entering filter cartridge 300.

As shown, the seal arrangement 338 includes a pair of seal members 338a, 338b extending from the segment 332g. In some examples, the seal members are lip seals. In some examples, the lip seals are tapered lip seals. Although the lip seals 338a, 338b can be provided with the same length, the lip seal 338b is longer than the lip seal 338a in the presented example, which can provide for improved sealing and easier installation. As most easily seen at FIG. 21, the flange wall 224 is provided with a flared opening, for ease of installation, such that the contact point for the lip seal 338b is further away from the longitudinal axis in comparison to the contact point for lip seal 338a. In one aspect, the lip seals 338a, 338b extend at an oblique angle from the segment 332g in a radially outward direction and towards the second end 304 of the filter cartridge 300. Accordingly, the seal arrangement 338 can be characterized as being a radially outward directed seal arrangement. As the seals are angled in the same direction as the insertion direction of the filter cartridge 300, this oblique angle provides for ease of installation. Further, as the seals are angled towards the higher pressure side of the air cleaner (i.e., angled in the upstream flow direction), the seals are angled to provide additional sealing against the housing by the internal air pressure. When the filter cartridges 200 and 300 are installed into the housing 104, the seal arrangement 338 forms a seal against the flange 224 of the filter cartridge 200 at the radially inward facing seal surface 224a, as most easily viewed at FIG. 19. In alternative examples, the lip seals 338a, 338b extend in the opposite oblique direction or extend orthogonally from the segment 332g.

With continued reference to FIG. 19, it can be viewed that the seal arrangements 336, 338 extending from segment 332g are compressed within the clearance area defined between the flange 224 of the filter cartridge 200 and the sidewall 104f of the housing 104. This configuration ensures that the seal arrangements 336, 338 form an adequate seal against the respective seal surfaces 104g, 224a and further ensures that the filter cartridge 300 is adequately retained within the housing 104. With such a configuration, the seal arrangements 336, 338 may be together referred to as a primary seal that ensures a seal between the filter cartridge 300 and the housing 104, with the seal arrangement 334 correspondingly being referred to as a secondary seal arrangement. In some characterizations, the seal arrangement 334 is referred to as a first seal arrangement and the seal arrangements 336, 338 are together referred to as a second seal arrangement. One advantage of the disclosed arrangement is that the filter cartridge 300 can be easily removed from the housing 104 once the filter cartridge 200 is removed as the filter cartridge 200 no longer exerts a compressive force onto the second seal arrangement 336, 338. This advantage can be characterized as providing the filter cartridge 300 with a lower service force. Another advantage of the disclosed arrangement is that the seal arrangements 336, 338 are in series with the seal arrangement 334. With such a configuration, a leak path around the filter cartridges 200, 300 is prevented from developing even with the failure of the first seal arrangement 334 or the second seal arrangements 336, 338. In one aspect, and as can be seen at FIG. 22, the seal arrangements 336, 338 are located axially beyond the inlet flow end 312 of the media pack 310, in a direction extending from the media pack outlet flow 314 end towards the inlet flow end 312, and are further located radially beyond an outer perimeter of the media pack 310.

In one approach for forming the shell 320 and seal member 330, the shell 320 can first be formed via injection molding, and subsequently placed into a second mold wherein the seal member 330 can be injection molded onto the shell 320. One class of materials suitable for injection molding of the seal member 330 are thermoplastic elastomers (TPE). TPE materials allow for injection molding of highly flexible parts with detailed profiles, and are thus advantageous for the formation of the seal lips of the seal member 330. Other formation processes may also be used. For example, the seal member 330 could be independently molded from TPE or another material and later attached to the shell 320 or media pack 310 with an adhesive and/or sealant, or mechanically or frictionally secured in place without the use of an adhesive. As the seal member 330 is disposed about the shell 320, the seal member 330 inside surface can have the same perimeter shape as the shell 320 outside surface. In some examples, the seal member 330 can have a different perimeter shape from the shell 320. In some examples, such as when no shell is provided, the seal member 330 inside surface can have the same perimeter shape as the media pack 310 outer perimeter. Further, although seal member 330 is disclosed as being a single component, seal member 330 could be formed as multiple components, for example a first component including seal arrangement 334 and a second component including seal arrangements 336 and 338. Further, it is noted that as seals are formed between the housing at seal arrangements 334 and 336, it is not necessary that the sections 332a, 332b, 332c, 332d, 332f be continuous in order to ensure seal integrity. As such, these sections may have interruptions or openings without compromising seal performance. As noted above, where seal arrangement 336 is alternatively configured as a positioning arrangement 336 without forming a continuous seal with the housing main body 104, sections 332a-332g would be continuous to ensure air does not bypass filter cartridge 200.

In some examples, the seal member 330 can be initially formed as a flat structure with the segments 332a, 332f, and 332g being aligned along a single plane. Once formed in such a manner, the segment 332g can then be folded outwardly about section 332f into the shape shown in the drawings. In view of the above, a method for forming a filter cartridge exists by providing a media pack and then securing or forming a seal member to the media pack directly or onto a shell within which the media pack is disposed. Where the seal member is formed as an initially flat construction, the method can include folding the seal member into the shape shown in the drawings either before or after the seal is secured to the media pack or shell.

Although the seal arrangements 334, 336, 338 are shown as being integrally formed with the same base member 332, other arrangements are possible. For example, the filter cartridge 300 could be provided with separate seal arrangements 334, 336, 338 that are independently formed or molded onto the shell 320. Further, although the seal arrangements 334, 336, 338 are each shown as including a pair of lip seals, the seal arrangements can be provided with more or fewer lip seals or other types of seal members.

### D. Air Cleaner 100′, Filter Cartridge 200′, Filter Cartridge 300′

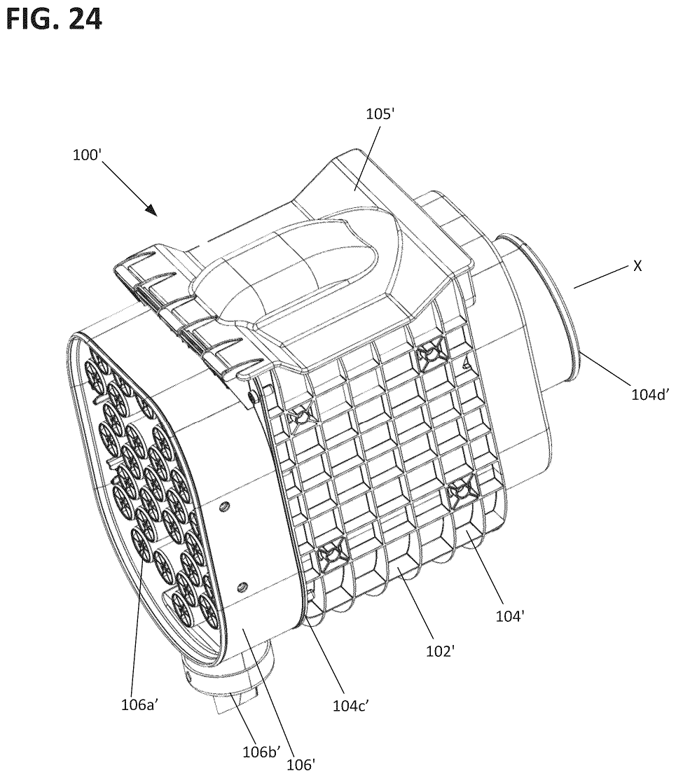

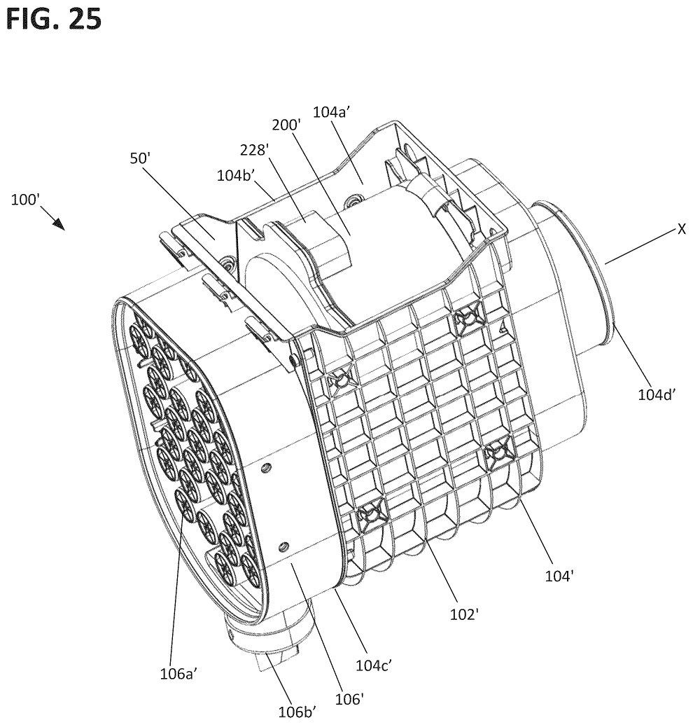

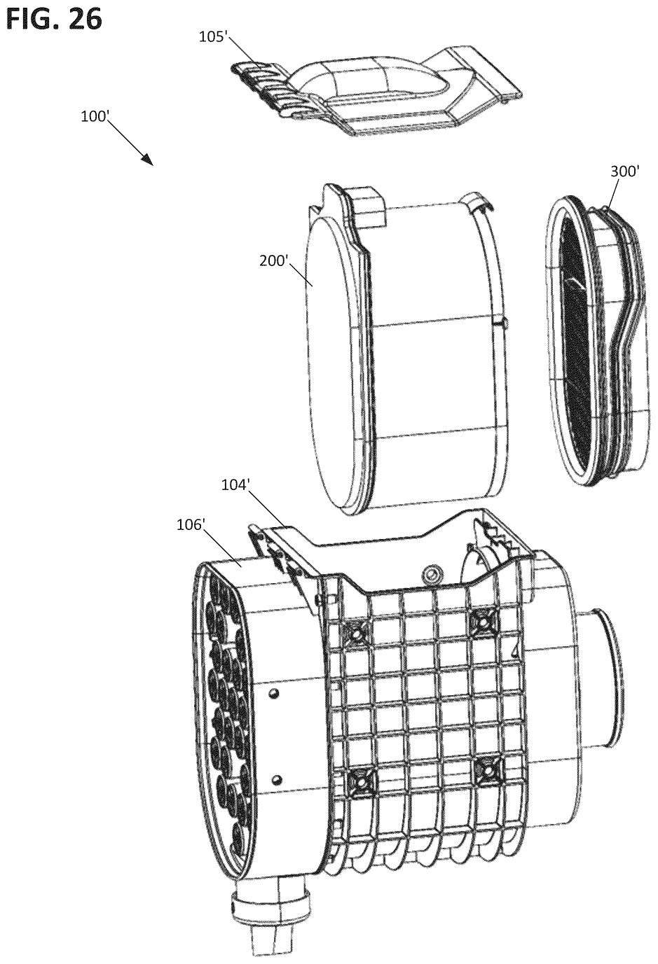

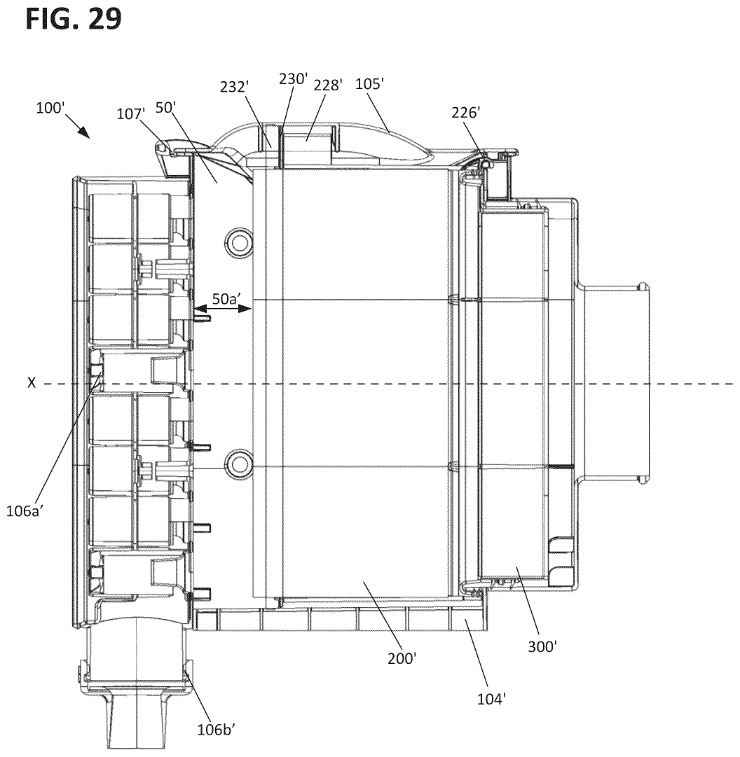

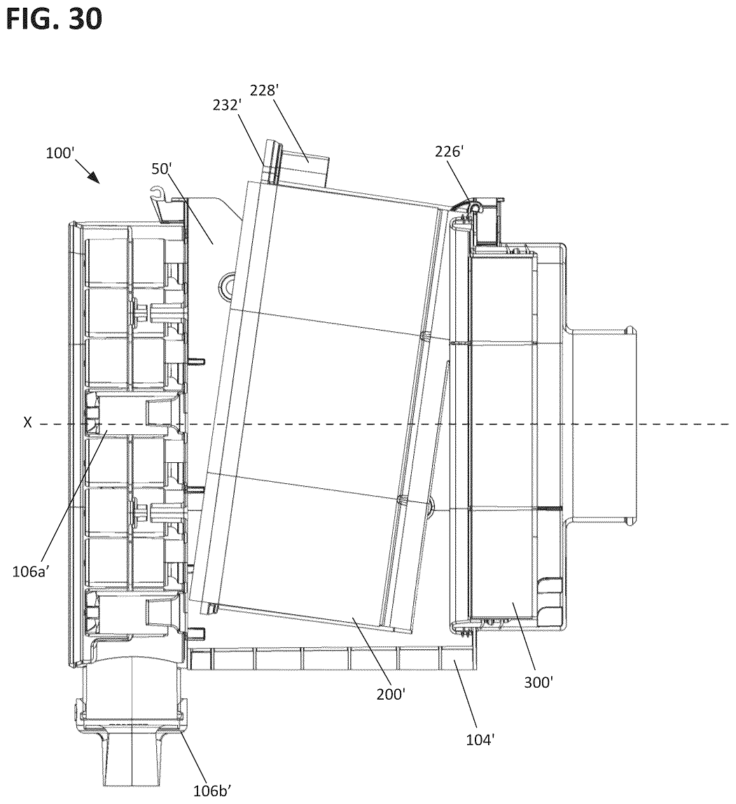

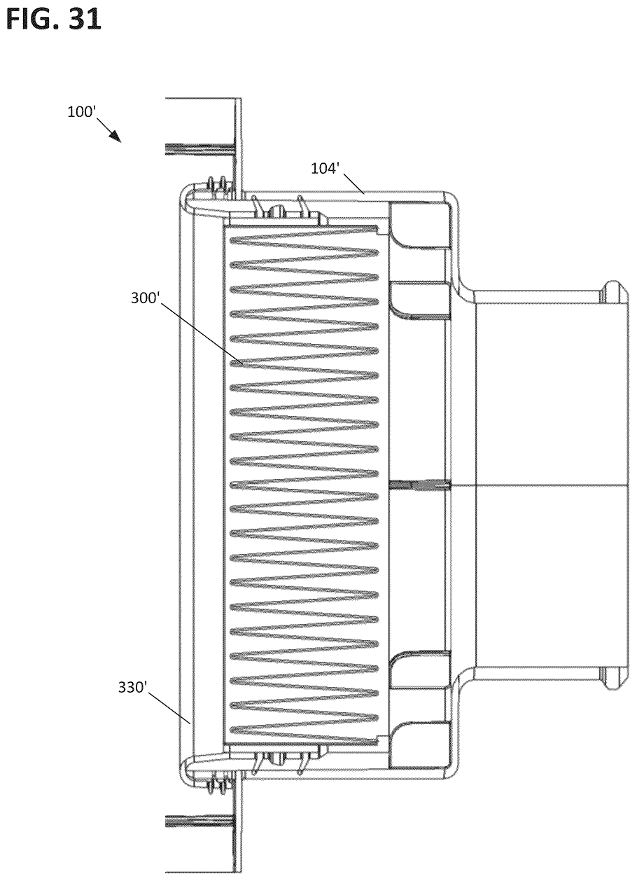

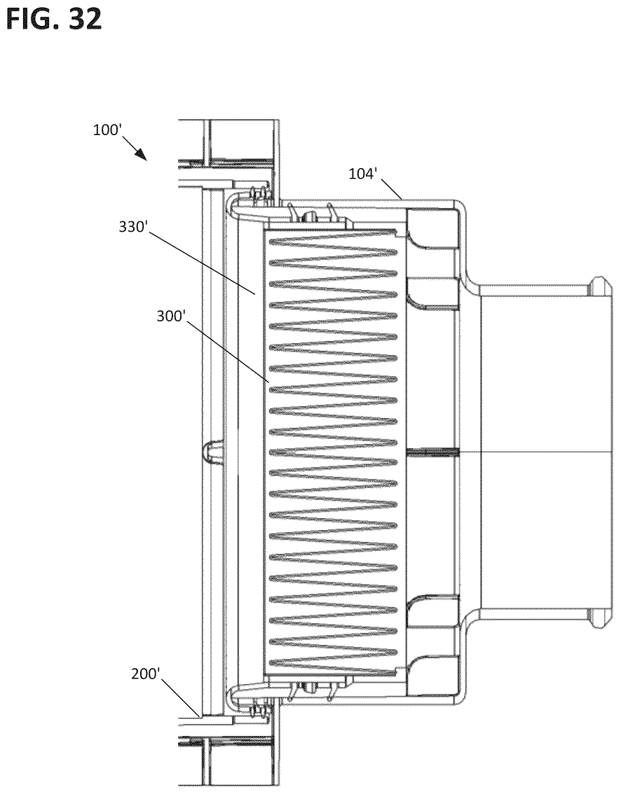

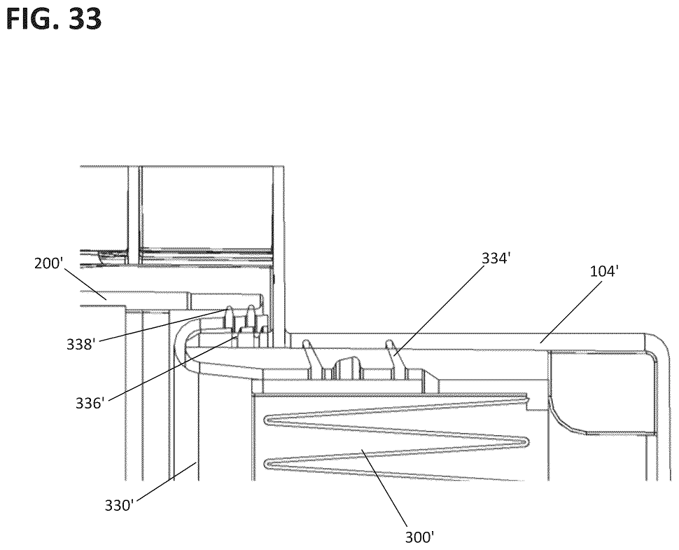

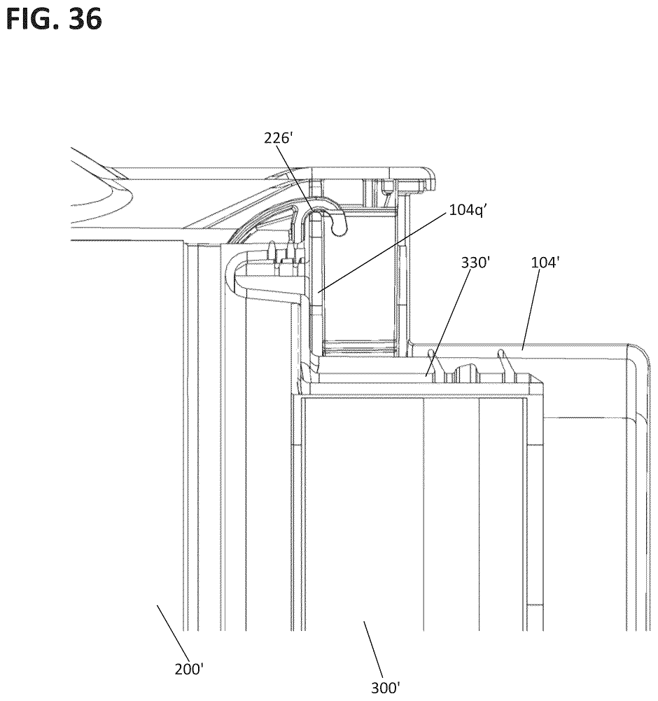

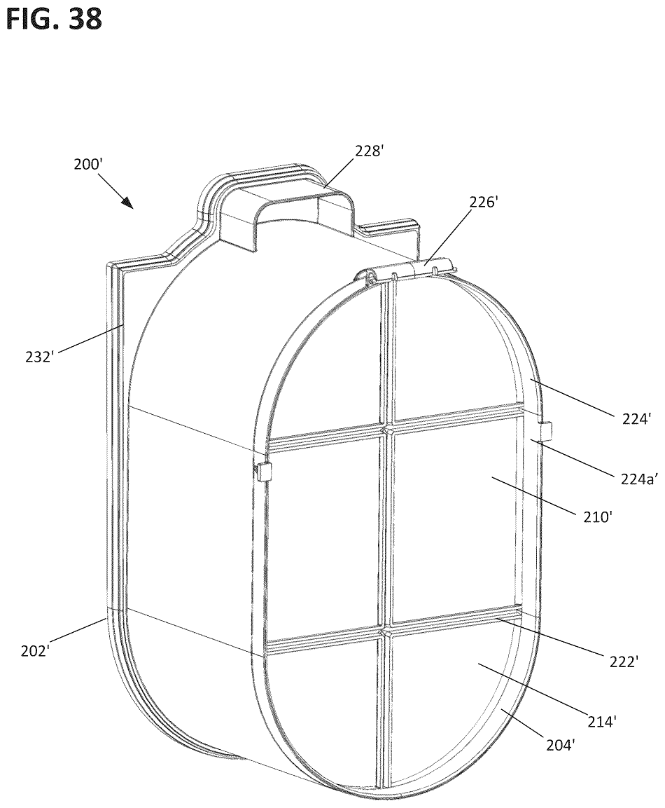

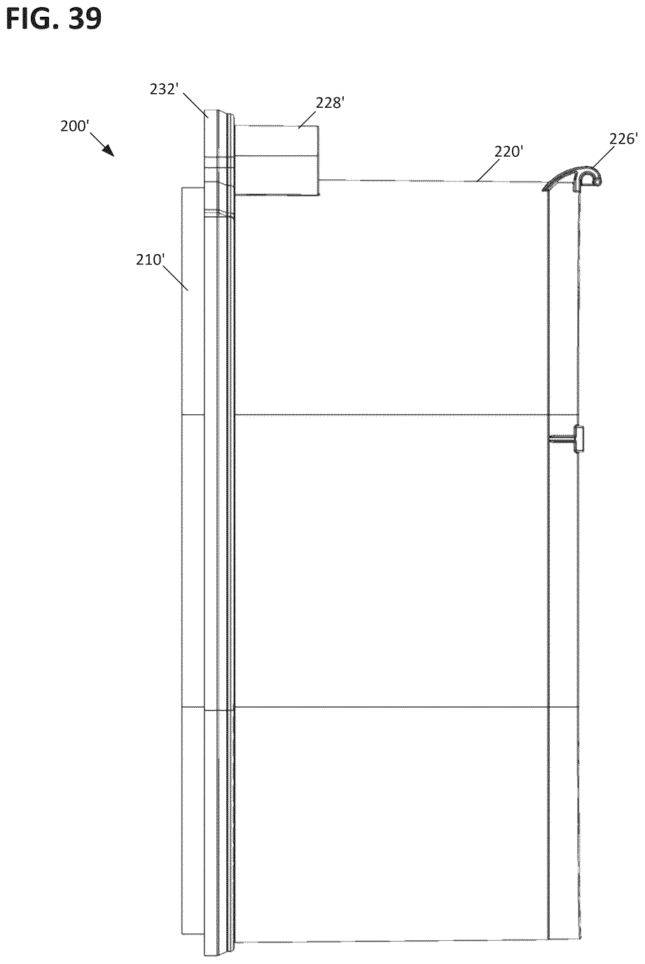

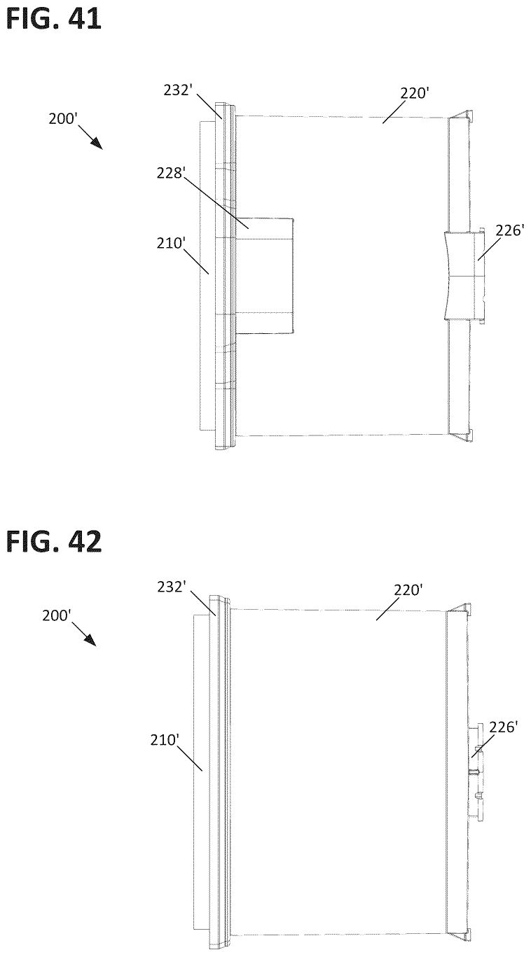

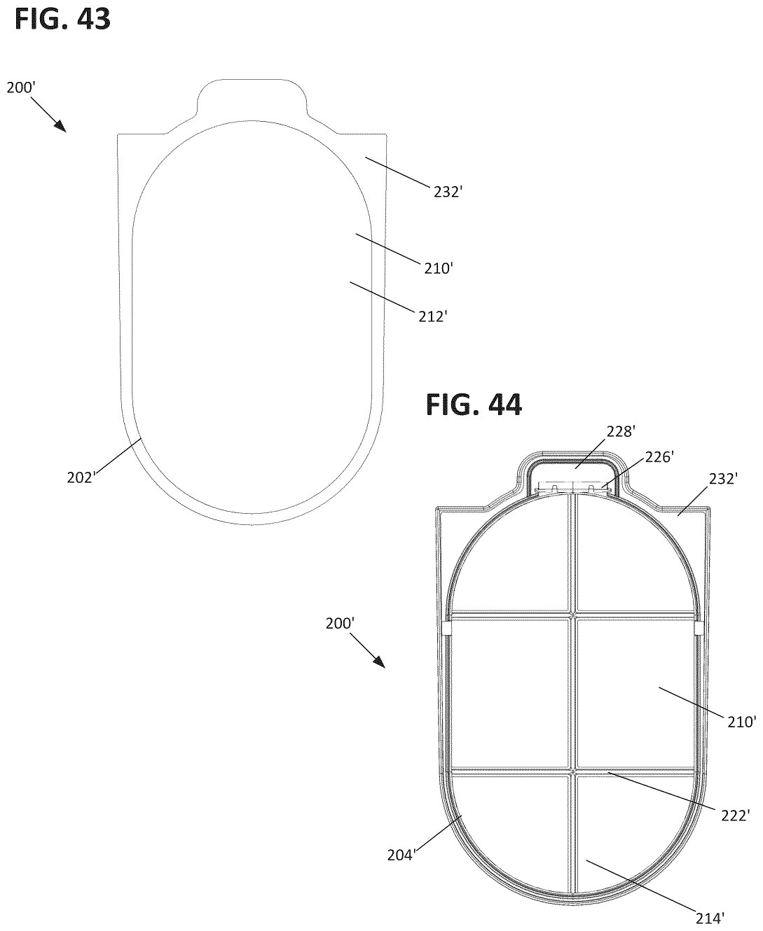

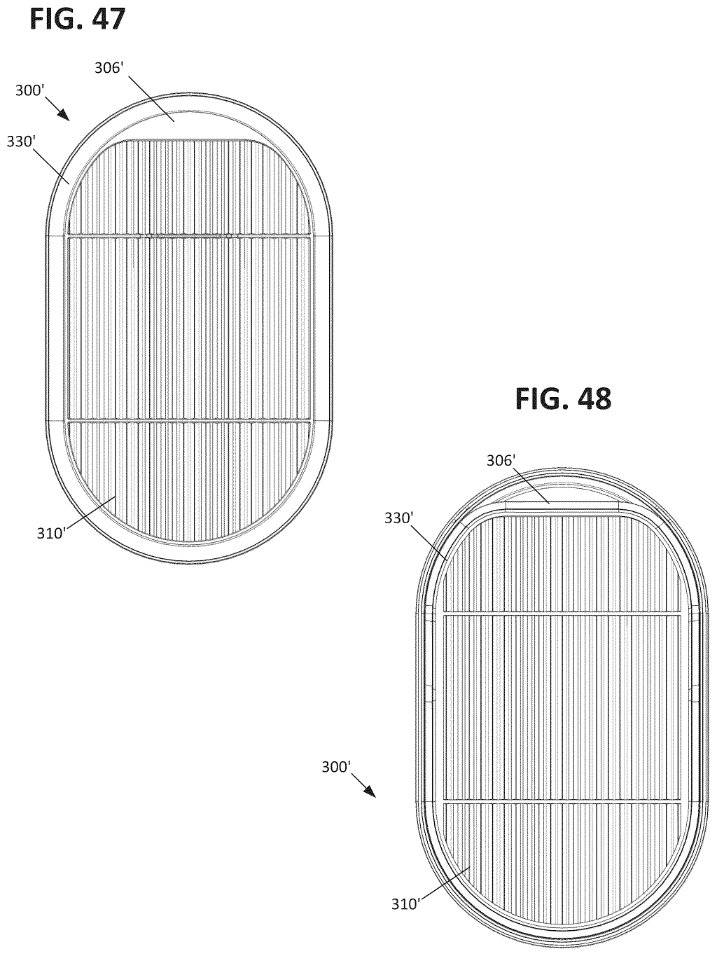

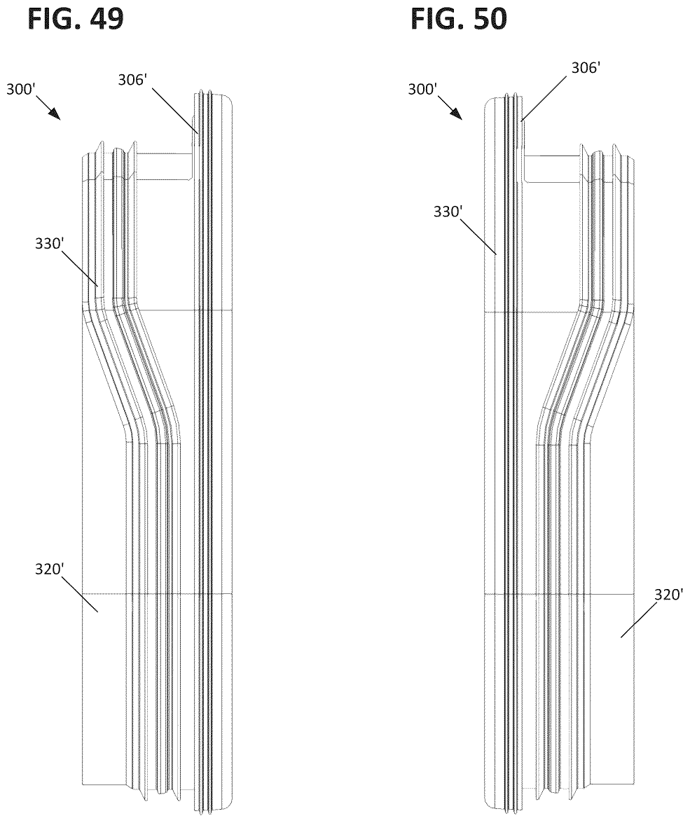

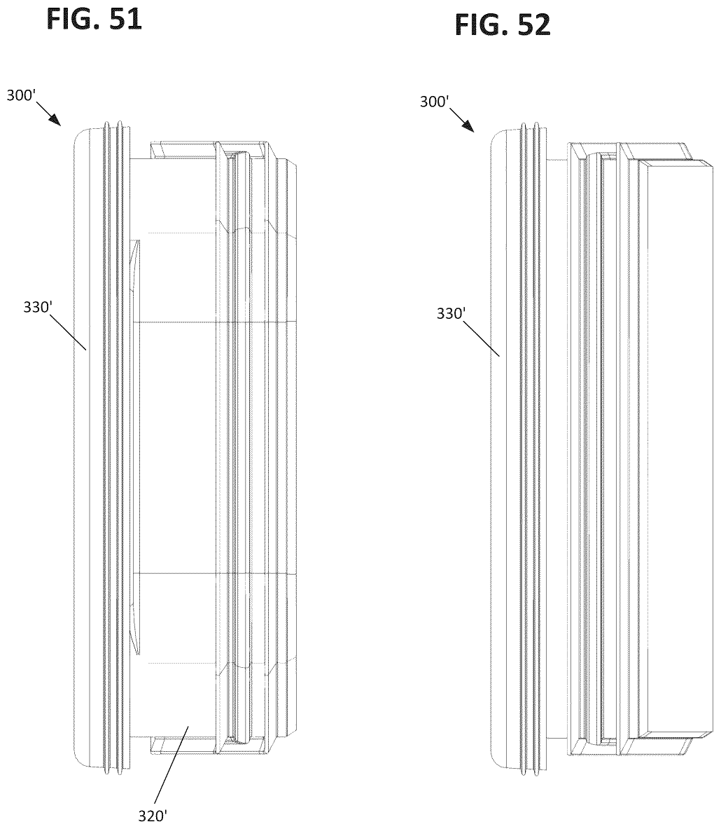

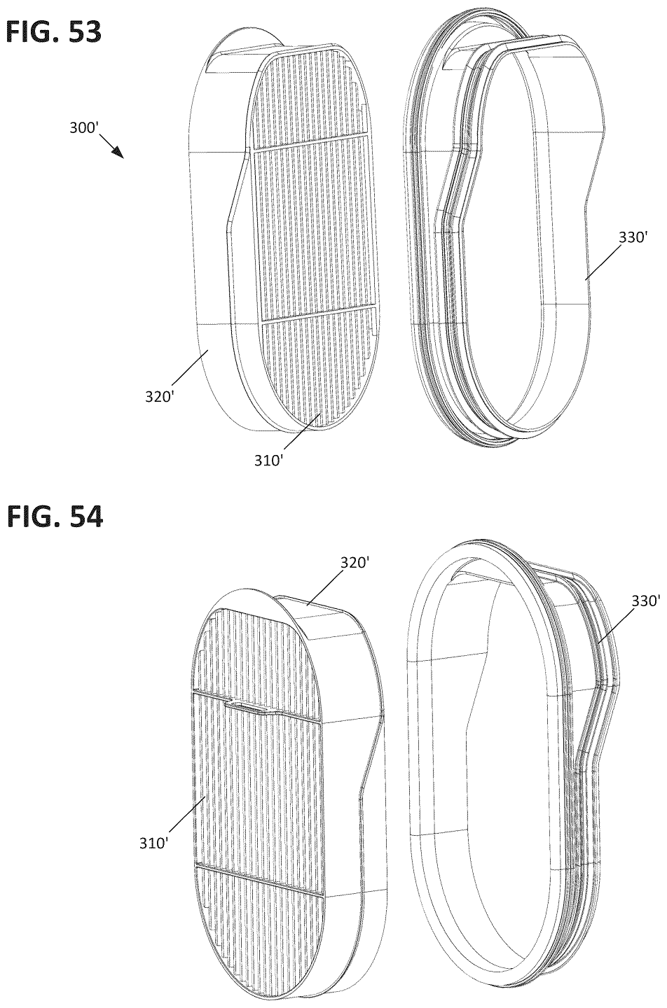

With reference to FIGS. 24-54, a second example of an air cleaner 100′ is presented. The air cleaner 100′ shares many features in common with air cleaner 100 and has the same general arrangement including a housing assembly 102′, a first filter cartridge 200′, and a second filter cartridge 300′. Where commonalities exist, the above-provided descriptions for air cleaner 100, filter cartridge 200, and filter cartridge 300 provided herein are fully applicable for air cleaner 100′, filter cartridge 200′, and filter cartridge 300′ and need not be repeated in this section. In such cases, the same reference numbers are used for air cleaner 100′, but with an added apostrophe. This section will instead focus on the relevant differences of air cleaner 100′ with respect to air cleaner 100.

In one aspect, the seal member 330′ associated with the filter cartridge 300′ is provided with a modified configuration. For example, the entire length of the seal member 330′ is provided with a section 332e′ that is disposed at a slight oblique angle to the longitudinal axis X. Further, segments 332e′ and 332g′ are provided with a greater length in comparison to segments 332e, 332g. As noted above, the seal member 330′ is also configured such that that seal member 330′ does not completely cover the shell 320′. Rather, the seal member 330′ is configured such that the segment 332a′ follows and extends slightly beyond the axially deviating location of the seal arrangement 334′.

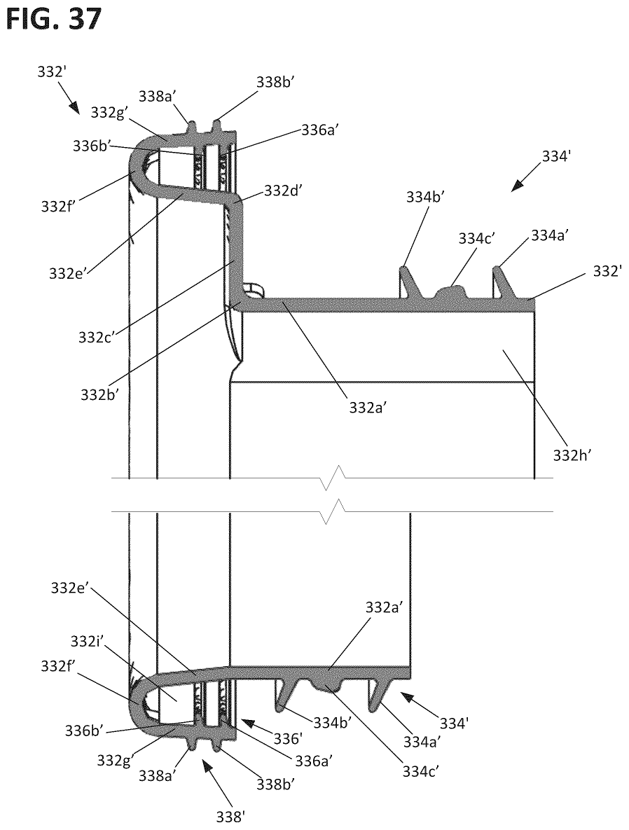

The seal arrangements of the filter cartridge 300′ also include differences over those of the filter cartridge 300. For example, seal arrangement 334′ is provided with seal members, which can be characterized as lip seals, 334a′, 334b′ that have a longer length in comparison to seal member 334a, 334b and that are further spaced apart to accommodate a bumper member 334c′. The bumper member 334c′ provides a radial limit for the displacement of the filter cartridge 300′ within the main housing 104′ to ensure that the seal members 334a′, 334b′ maintain contact with the housing sealing surface about the entire perimeter of the seal member 330′. With lip seals of the type shown at FIGS. 17 and 37, a concern exists that radial compression on one side of the filter cartridge, for example due to gravity, can result in the cartridge becoming radially offset to such a degree that the portion of the seal members on the opposite side of the cartridge come out of sealing contact with the housing, thereby creating a leak path. The bumper members 334c′ act as a stop against the housing to prevent such a condition. A bumper member 334c′ can also be provided on the seal member 330. In some examples, multiple bumper members 334c′ can be provided. In the example shown, the bumper member 334c′ is located between the seal members 334a′, 334b′, but can be provided in other locations proximate the seal members 334a′, 334b′.

The seal arrangement 338′ also differs from seal arrangement 338 in the seal members 338a′, 338b′ are provided with a shorter length in comparison to the seal members 338a, 338b, and are also not provided at an oblique angle to the longitudinal axis X. The seal members 338a′, 338b′ may be characterized as lip seals. The features of the seal arrangement 336′ are generally the same as seal arrangement 336 and include seal member or lip seals 336a′, 336b′. Notably, the seal arrangement 334′ deviates in an axial direction opposite to that for seal arrangement 334 such that the axial gap between the seal arrangements 334′ and seal arrangements 336′/338′ is greatest at the end proximate the handle 306′ and at a minimum around the remaining perimeter of the filter cartridge 300′. The above-described features of the seal member 330′ can be incorporated into the seal member 330 without departing from the concepts presented herein.

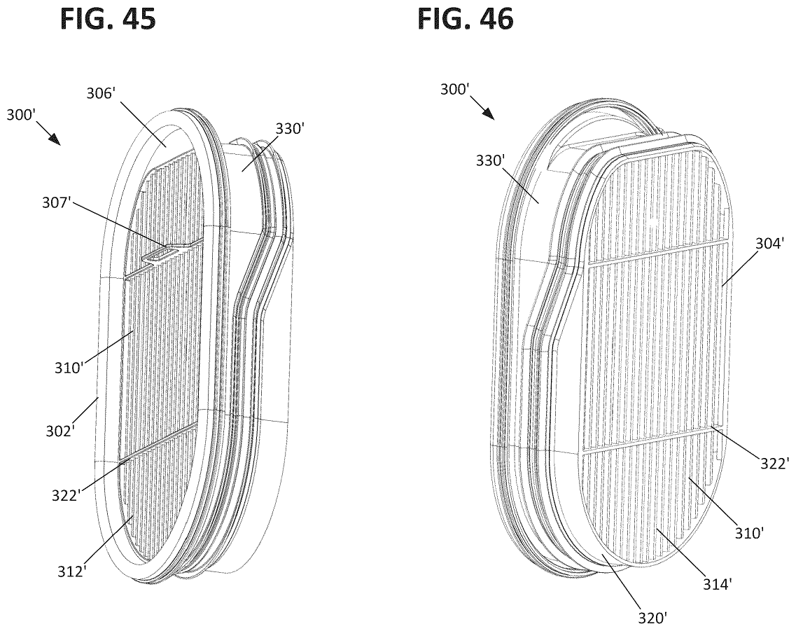

As most easily viewed at FIG. 45, the filter cartridge 300′ is provided with an additional handle 307′ extending from the inlet flow end 312′ of the media pack 310′. In some examples, the filter cartridge 300′ can be provided without handle 306′ such that handle 307′ is the only handle provided on the filter cartridge 300′. In such cases, the seal member 330′ can be provided with a uniform cross-sectional profile at the location of the seal arrangements 336′, 338′ without the need to include sections 332b′ to 332e′ that are provided to accommodate the handle portion 306′. Such an arrangement is also possible for filter cartridge 300 without departing from the concepts presented herein.

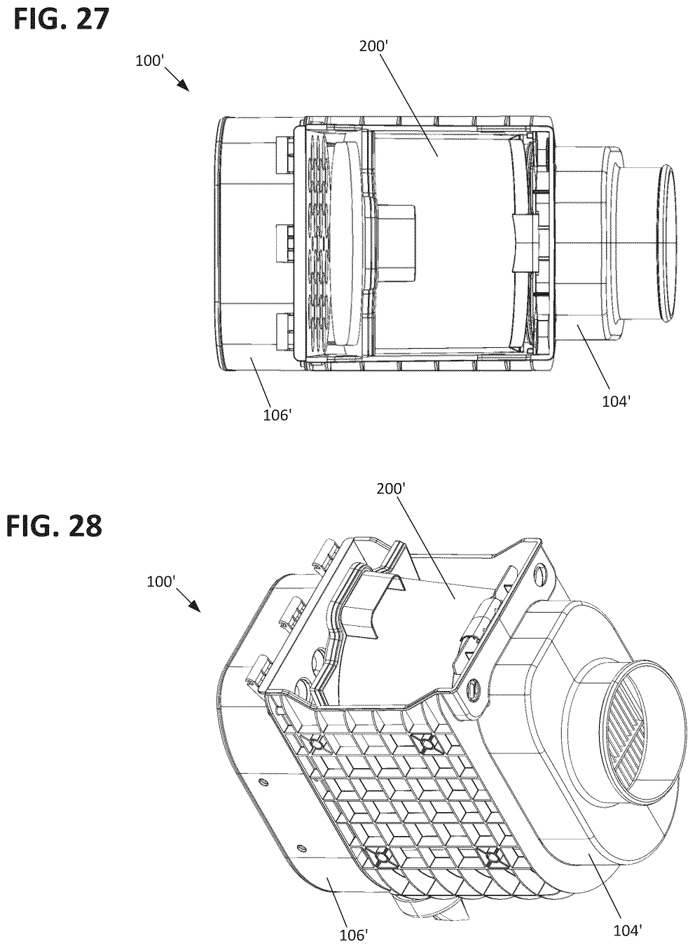

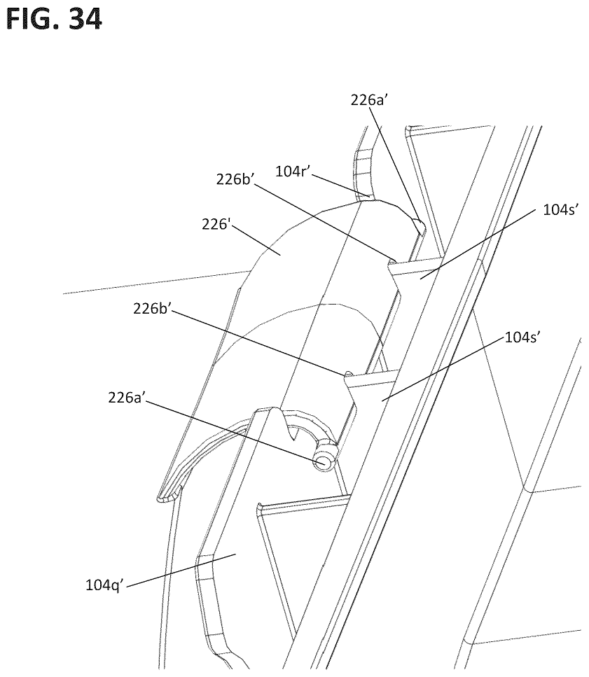

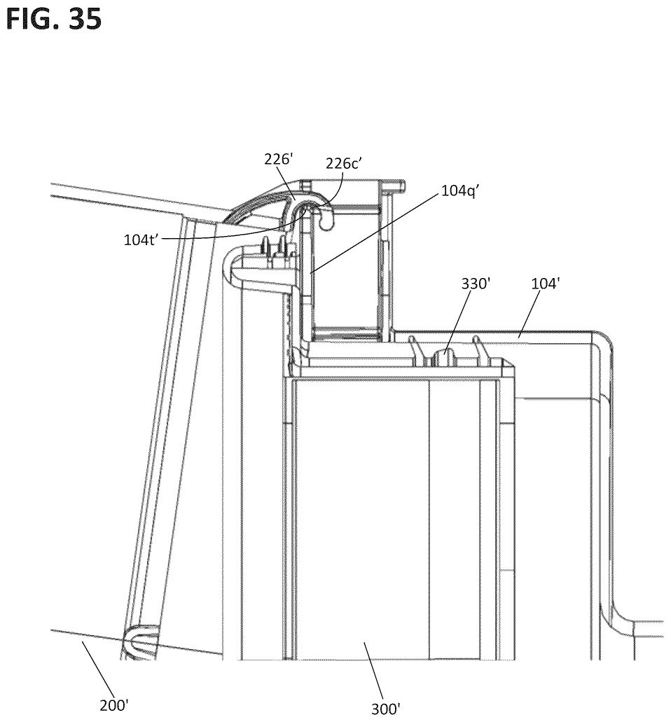

In one aspect, the main housing 104′ and filter cartridge 200′ are provided with a catch arrangement configuration with different interacting locating and receiving features, in comparison to that described above for the air cleaner 100. As most easily seen at FIGS. 34-36, the main housing 104′ is provided with a vertical wall section 104q′ defining an open notch or recessed portion 104r′ configured for receiving a single, centrally arranged locating feature 226′ provided on the filter cartridge 200′. In one characterization, the locating feature 226′ and wall section 104q′ may be referred to as a catch arrangement in which the locating feature(s) 226′ is a first part of the catch arrangement and in which the wall section 104q′ is a second part of the catch arrangement. In one aspect, the vertical wall section 104q′ runs orthogonally to the longitudinal axis X and parallel to the outlet flow end 214′ of the filter cartridge 200′. In one aspect, the locating feature 226′ presents a concave shaped inner surface 226c′ The main housing 104′ is further shown as including a pair of longitudinally extending wall portions 104s′ extending orthogonally from the wall section 104q′ in a direction towards the outlet end 104d′. The locating feature 226′ is shown as being provided with a pair of notches 226b′ configured to receive the wall portions 104s′ such that the locating feature 226′ can be fully received into the recessed portion 104r′. The interaction between the wall portions 104s′ and notches 226b′ ensures that the cartridge 200′ is properly aligned along the axis X of the air cleaner assembly 100′ before the cartridge 200′ is further inserted into the main housing 104′. Further, the wall portions 104s′ and notches 226b′ can function as an arrangement that ensures the proper filter cartridge 200′ is installed within the main housing 104′ in that a filter cartridge 200′ without the appropriately sized and located notches 226b′ cannot be fully received into the housing. The locating feature 226′ is further shown as including a pair of detent or hooking members 226a′ which extend laterally from the main body of the locating feature 226′ to a width that is greater than the width of the recessed portion 104r′. In the example shown, the detent or hooking members 226a′ are cylindrically shaped with a convex shaped outer surface 226c′ that rests upon and pivots about an end surface 104t′ of the wall section 104q′. As shown, the end surface 104t′ is provided with a rounded, convex shaped surface. Accordingly, once the locating feature 226′ is hooked over the wall section 104q′ and within the recess 104r′, as is shown with the cartridge 200′ in the initial tilted position at FIG. 35, the detent members 226a′ engage against the downstream side of the wall section 104q′ to prevent the filter cartridge 200′ from backing away from the wall section 104q′ towards the upstream direction. This feature aids in holding the top portion of the filter cartridge 200′ in place while providing a pivot location for the filter cartridge 200′ to rotate from the initial tilted position towards the installed position. The initial tilted position of the filter cartridge 200′ is illustrated at FIGS. 27, 28, 30, 35, 40. FIGS. 24, 25, 29, 32, 33, and 36 show the fully installed position of the filter cartridge 200′ and with the cover 105′ installed onto the main housing 104′. As described for filter cartridge 200, the filter cartridge 200′ is provided with a handle 228′ that can be used to manipulate the cartridge 200′ into the initial tilted position, as shown in isolation at FIG. 40. However, the handle 228′ is formed into the flange 230′ and is therefore closer to the inlet flow end 212′ in comparison to handle 228. The center of gravity of the filter cartridge 200′ is located axially between the handle 228′ and the locating feature 226′, as illustrated at FIG. 40. This is also the case for filter cartridge 200. Stated another way, a first radial plane orthogonal to the longitudinal axis X that extends through the center of gravity of the filter cartridge 200′ is located between a second radial plane orthogonal to the longitudinal axis X extending through the handle 228′ and a third radial plane orthogonal to the longitudinal axis X extending through the locating feature 226′. With such an arrangement, the filter cartridge 200′ will naturally hang at least at the initial tilted angle, or at least at an angle whereby the locating feature 226′ hangs vertically below the handle 228′ to facilitate easy initial engagement between the locating feature 226′ and the wall section 104q′. With such a configuration, such that the locating feature 226′ can hinge about the wall section 104q′ without initial interference between the seal member 330′ and the filter cartridge 200′. In the example shown, the difference between the initial tilted angle and the fully installed position of the filter cartridge is at least 5 degrees and about 8 degrees. The initial tilted position is limited by the axial dimension 50a′ of the gap 50′ such that the initial tilted position can increase as the axial dimension 50a′ of the gap 50′ increases.

The filter cartridge 200′ also differs from filter cartridge 200 in that the media pack inlet flow end 212′ extends past the seal arrangement 232′. With such a configuration, the axial dimension 50a′ of the gap 50′ is defined by the inlet flow end 212′ rather than by the seal arrangement 232′. Also, in the example shown, the seal arrangement 232′ is over-molded onto the flange 230′ of the shell 220′. The seal arrangement 232′, like seal arrangement 232, could be separately formed and later adhered to the flange 230′ in an alternative configuration. In some examples, the seal arrangement 232′ can be provided on or about the shell 220′ proximate the outlet flow end 214′.

### E. Air Cleaner 100″, Filter Cartridge 200″, Filter Cartridge 300″

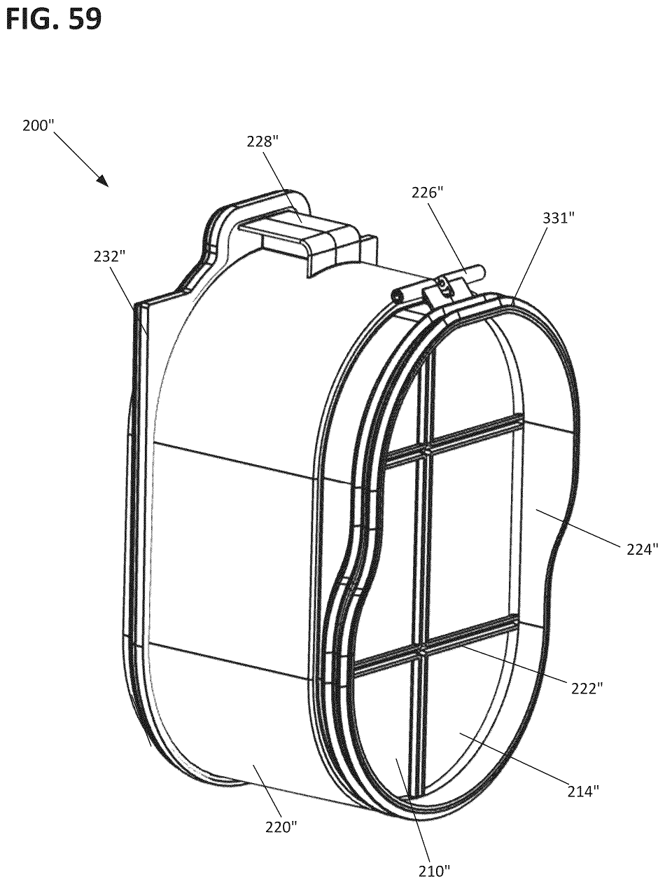

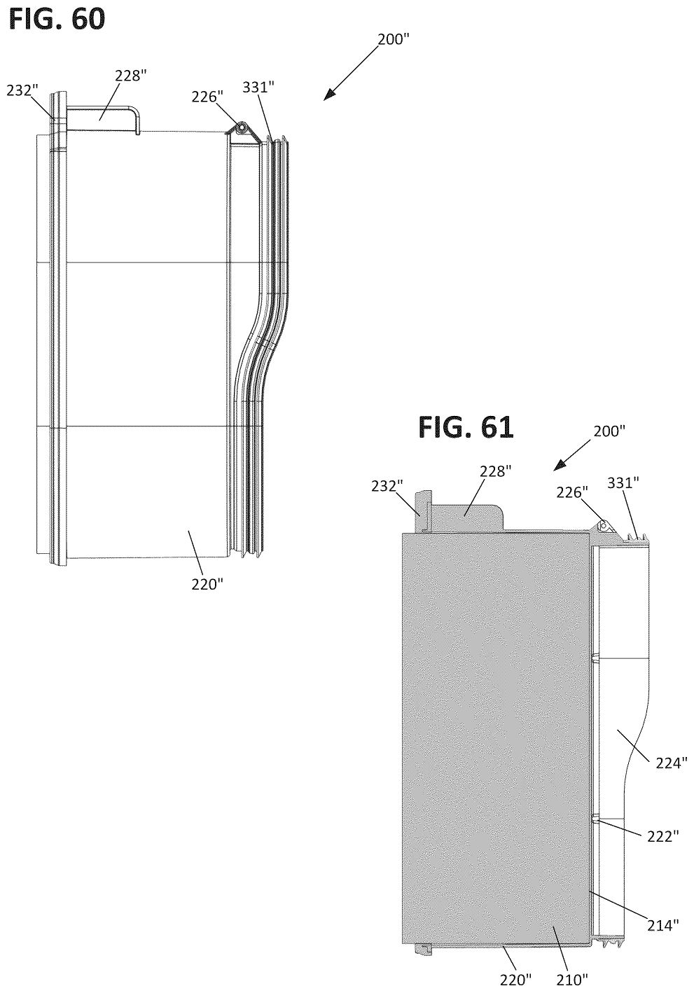

With reference to FIGS. 55-64, features of a third example of an air cleaner 100″ are presented that are usable with the air cleaners 100, 100′. The air cleaner 100″ shares many features in common with air cleaners 100 and 100′ and has the same general arrangement including a housing assembly 102″, a first filter cartridge 200″, and a second filter cartridge 300″. Where commonalities exist, the above-provided descriptions for air cleaner 100, 100′, filter cartridge 200, 200′, filter cartridge 300, 300′ provided herein are fully applicable for air cleaner 100″, filter cartridge 200″, and filter cartridge 300″, and need not be repeated in this section. In such cases, the same reference numbers are used for air cleaner 100″, but with two added apostrophes. This section will instead focus on the relevant differences of air cleaner 100″ with respect to air cleaners 100, 100″.

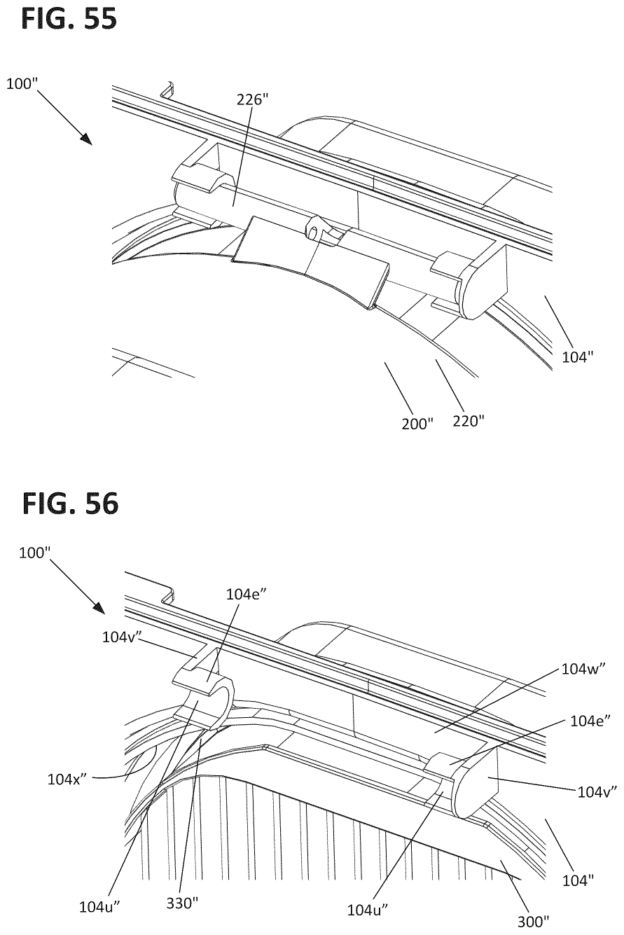

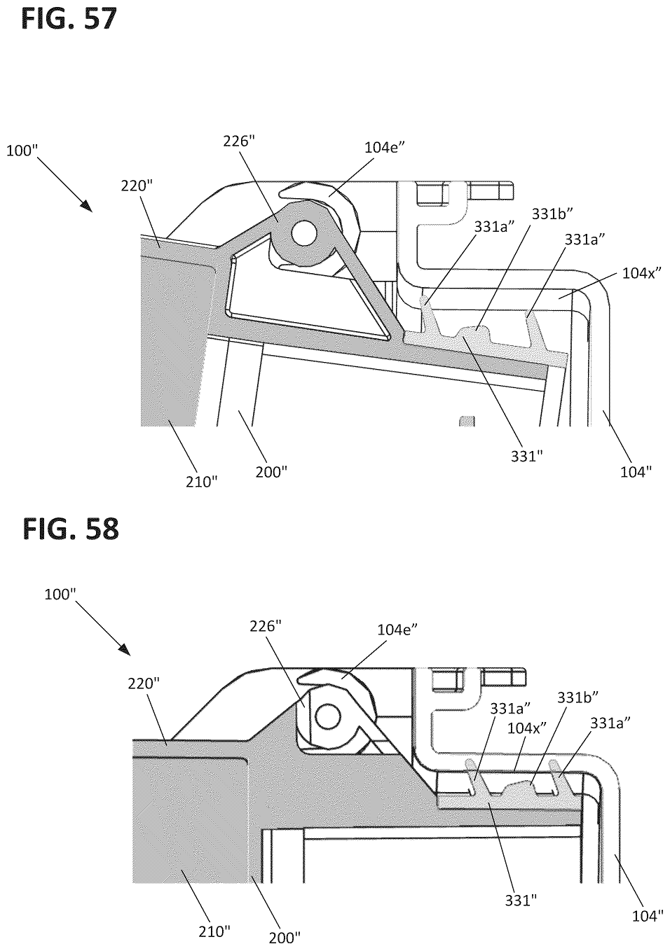

Air cleaner 100″ primarily differs from the previously disclosed embodiments in that a third example for a catch arrangement is disclosed in which the first part 226″ of the catch arrangement is provided as a horizontal pin 226″ and the second part 104e″ of the catch arrangement is provided as a receiving structure 104e″ having a pair of open channel structures 104u″, presenting a cylindrically shaped bearing surface. As shown, the open channel structures 104u″ are supported by extension members 104v″ that extend horizontally from a vertical wall 104w″ of the housing 104″. FIGS. 55 and 58 show the first part 226″ received into the second part 104e″ with the cartridge 200″ being in the installed position. FIG. 56 shows the air cleaner housing 104″ without the filter cartridge 200″ shown such that the second part 104e″ can be more easily viewed, as well as the filter cartridge 300″. FIG. 57 shows the air filter cartridge 200″ in the tilted position during installation or removal in which the longitudinal axis of the filter cartridge 200″ is at an oblique angle to the longitudinal axis of the air cleaner housing 104″ and to the longitudinal axis of the filter cartridge 200″ when in the installed position.

As can also be seen at FIGS. 57 and 58-61, the filter cartridge 200″ is provided with a seal member 331″ proximate the outlet end of the filter cartridge 200″ having a pair of seal members 331a″, configured as lip seals, and a bumper member 331b″. Although two seal members 331a″ are shown, more or fewer seal members 331a″ may be provided, such as one or three seal members 331a″. In the example shown, the housing 104″ is provided with a sealing surface 104x″ against which the seal member 330″ can form a seal. Notably, the seal member 331″ deviates axially similarly to seal member 330, 330′, but in the opposite direction such that the seal member 331″ is further from media pack outlet flow end 214″ proximate the catch arrangement first part 226″ in comparison to the opposite end. This arrangement thus accommodates the axial positioning of the first part 226″, which is located axially beyond the outlet flow end 214″, in a direction extending from the inlet flow end 212″ towards the outlet flow end 214″, while also delaying the rotational angle of the filter cartridge 200″ at which the bottom portion of the seal member 331″ contacts the housing sealing surface 104x″ as the cartridge 200″ is rotated from the tilted position into the installed position. As the filter cartridge 200″ is provided with seal member 331″, the seal member 330″ of the filter cartridge 300″ can be configured with the previously shown and described seal arrangement 334, but without seal arrangements 336, 338.

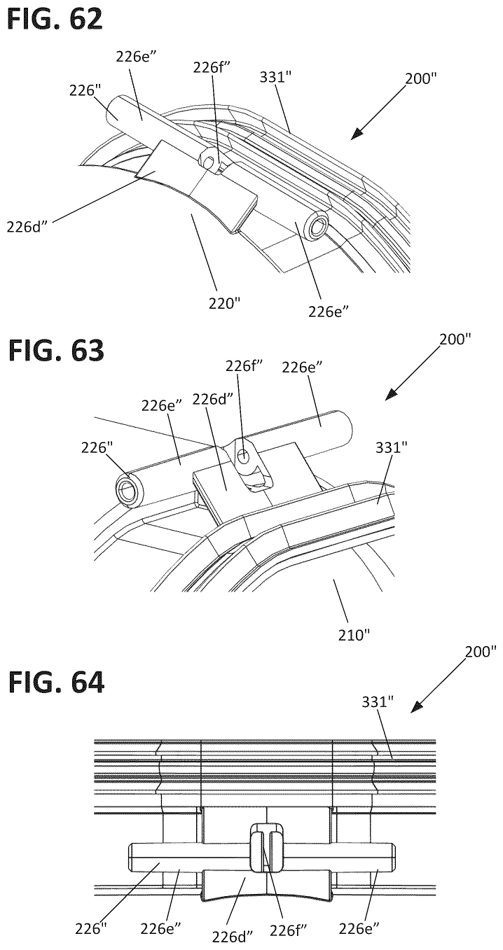

With reference to FIGS. 62 to 64, the first part 226″ of the catch arrangement is shown in further detail. As shown, the first part 226″ includes a base structure 226d″ extending from the shell 220″. In the example shown, the base structure 226d″ has a generally triangular shape, but other shapes are also possible. The base structure 226d″ supports a pair of horizontally extending pin members 226e″ that are spaced apart to form a gap or opening space 226f″. In some examples, the housing 104″ can be provided with a correspondingly shaped protrusion at the location of the gap 226f″ such that only a filter cartridge 200″ having a correctly shaped gap or opening space 226f″ can be installed within the housing 104″. In some examples, the pin members 226e″ can be formed as a single pin member 226e″ without including the gap or opening spaced 226f″. As stated previously, the pin members 226e″ have a generally cylindrical shape, but could be provided with other shapes as well. As most easily seen at FIG. 61, it can be viewed that the first part 226″ is located radially beyond the outer perimeter of the media pack 210″ and is located axially beyond the outlet end 214″ of the media pack 210″, in a direction extending from the inlet end 212″ towards the outlet end 214″. The first part 226″ is also located radially beyond the seal member 331″ while being located axially between the seal member 331″ and the outlet end 214″ of the media pack 210″.

### III. Example Media Configurations, Generally

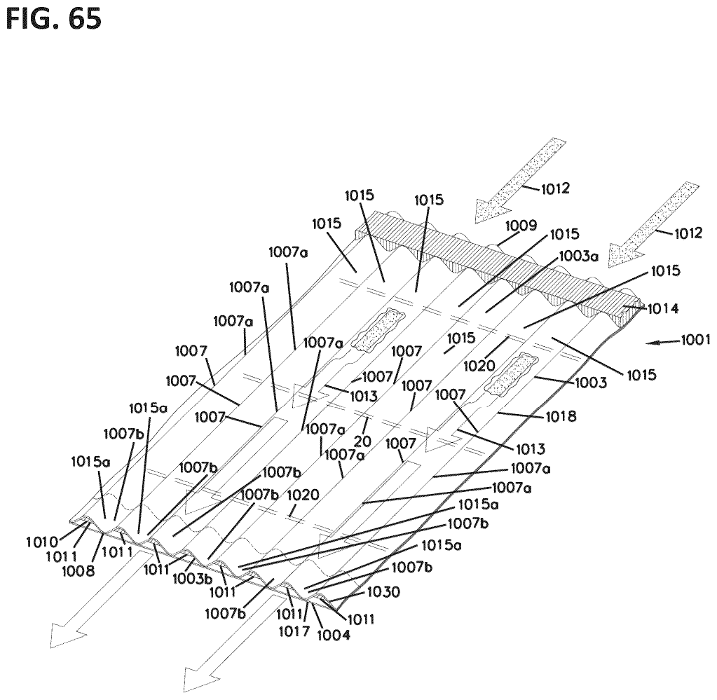

Any type of filter media can be used as the media pack for the disclosed filter cartridges (e.g. 200, 200′, 200″, 300, 300″), as further described herein with relation to FIGS. 65-86. Further, the media type for filter cartridge 200, 200′, 200″ may be the same type or a different type of media than that for filter cartridge 300, 300″. For example, the filter cartridge 200, 200′, 200″ may have fluted type media while filter cartridge 300, 300′ may be provided with pleated type media.

The media can be of a variety of types and configurations, and can be made from using a variety of materials. For example, pleated media arrangements can be used in cartridges according to the principles of the present disclosure, as discussed below.

The principles are particularly well adapted for use in situations in which the media is quite deep in extension between the inlet and outlet ends of the cartridge, but alternatives are possible. Also, the principles are often used in cartridges having relatively large cross-dimension sizes. With such arrangements, alternate media types to pleated media will often be desired.

In this section, examples of some media arrangements that are usable with the techniques described herein are provided. It will be understood, however, that a variety of alternate media types can be used. The choice of media type is generally one of preference for: availability; function in a given situation of application, ease of manufacturability, etc. and the choice is not necessarily specifically related to the overall function of selected ones of various filter cartridge/air cleaner interaction features characterized herein.

### A. Media Pack Arrangements Using Filter Media Having Media Ridges (Flutes) Secured to Facing Media

Fluted filter media (media having media ridges) can be used to provide fluid filter constructions in a variety of manners. One well known manner is characterized herein as a z-filter construction. The term “z-filter construction” as used herein, is meant to include (but not be limited) a type of filter construction in which individual ones of corrugated, folded or otherwise formed filter flutes are used to define (typically in combination with facing media) sets of longitudinal, typically parallel, inlet and outlet filter flutes for fluid flow through the media. Some examples of z-filter media are provided in U.S. Pat. Nos. 5,820,646; 5,772,883; 5,902,364; 5,792,247; 5,895,574; 6,210,469; 6,190,432; 6,350,291; 6,179,890; 6,235,195; Des. 399,944; Des. 428,128; Des. 396,098; Des. 398,046; and, Des. 437,401; each of these cited references being incorporated herein by reference.

One type of z-filter media, utilizes two specific media components joined together, to form the media construction. The two components are: (1) a fluted (typically corrugated) media sheet or sheet section, and, (2) a facing media sheet or sheet section. The facing media sheet is typically non-corrugated, however it can be corrugated, for example perpendicularly to the flute direction as described in U.S. provisional 60/543,804, filed Feb. 11, 2004, and published as PCT WO 05/077487 on Aug. 25, 2005, incorporated herein by reference.

The fluted media section and facing media section can comprise separate materials between one another. However, they can also be sections of the single media sheet folded to bring the facing media material into appropriate juxtaposition with the fluted media portion of the media. For example, a single continuous sheet of media formed with alternating fluted and flat sections along the length of the media can be folded upon itself in zig-zag fashion to form a fluted media configuration.

The fluted (typically corrugated) media sheet and the facing media sheet or sheet section together, are typically used to define media having parallel flutes. In some instances, the fluted sheet and facing sheet are separate and then secured together and are then coiled, as a media strip, to form a z-filter media construction. Such arrangements are described, for example, in U.S. Pat. Nos. 6,235,195 and 6,179,890, each of which is incorporated herein by reference. In certain other arrangements, some non-coiled sections or strips of fluted (typically corrugated) media secured to facing media, are stacked with one another, to create a filter construction. An example of this is described in FIG. 11 of U.S. Pat. No. 5,820,646, incorporated herein by reference.

Herein, strips of material comprising fluted sheet (sheet of media with ridges) secured to corrugated sheet, which are then assembled into stacks to form media packs, are sometimes referred to as “single facer strips,” “single faced strips,” or as “single facer” or “single faced” media. The terms and variants thereof, are meant to refer to a fact that one face, i.e., a single face, of the fluted (typically corrugated) sheet is faced by the facing sheet, in each strip.

Typically, coiling of a strip of the fluted sheet/facing sheet (i.e., single facer) combination around itself, to create a coiled media pack, is conducted with the facing sheet directed outwardly. Some techniques for coiling are described in U.S. provisional application 60/467,521, filed May 2, 2003 and PCT Application US 04/07927, filed Mar. 17, 2004, now published as WO 04/082795, each of which is incorporated herein by reference. The resulting coiled arrangement generally has, as the outer surface of the media pack, a portion of the facing sheet, as a result.

The term “corrugated” used herein to refer to structure in media, is often used to refer to a flute structure resulting from passing the media between two corrugation rollers, i.e., into a nip or bite between two rollers, each of which has surface features appropriate to cause corrugations in the resulting media. The term “corrugation” is however, not meant to be limited to such flutes, unless it is stated that they result from flutes that are by techniques involving passage of media into a bite between corrugation rollers. The term “corrugated” is meant to apply even if the media is further modified or deformed after corrugation, for example by the folding techniques described in PCT WO 04/007054, and published Jan. 22, 2004, incorporated herein by reference.

Corrugated media is a specific form of fluted media. Fluted media is media which has individual flutes or ridges (for example formed by corrugating or folding) extending thereacross.

Serviceable filter element or filter cartridge configurations utilizing z-filter media are sometimes referred to as “straight through flow configurations” or by variants thereof. In general, in this context what is meant is that the serviceable filter elements or cartridges generally have an inlet flow end (or face) and an opposite exit flow end (or face), with flow entering and exiting the filter cartridge in generally the same straight through direction. The term “serviceable” in this context is meant to refer to a media containing filter cartridge that is periodically removed and replaced from a corresponding fluid (e.g. air) cleaner. In some instances, each of the inlet flow end (or face) and outlet flow end (or face) will be generally flat or planar, with the two parallel to one another. However, variations from this, for example non-planar faces, are possible.

A straight through flow configuration (especially for a coiled or stacked media pack) is, for example, in contrast to serviceable filter cartridges such as cylindrical pleated filter cartridges of the type shown in U.S. Pat. No. 6,039,778, incorporated herein by reference, in which the flow generally makes a substantial turn as its passes into and out of the media. That is, in a U.S. Pat. No. 6,039,778 filter, the flow enters the cylindrical filter cartridge through a cylindrical side, and then turns to exit through an open end of the media (in forward-flow systems). In a typical reverse-flow system, the flow enters the serviceable cylindrical cartridge through an open end of the media and then turns to exit through a side of the cylindrical filter media. An example of such a reverse-flow system is shown in U.S. Pat. No. 5,613,992, incorporated by reference herein.

The term “z-filter media construction” and variants thereof as used herein, without more, is meant to include, but not necessarily be limited to, any or all of: a web of corrugated or otherwise fluted media (media having media ridges) secured adjacent to (facing) media, whether the sheets are separate or part of a single web, with appropriate sealing (closure) to allow for definition of inlet and outlet flutes; and/or a media pack constructed or formed from such media into a three dimensional network of inlet and outlet flutes; and/or, a filter cartridge or construction including such a media pack.

In FIG. 65, an example of media 1001 useable in z-filter media construction is shown. The media 1 is formed from a fluted, in this instance corrugated, sheet 1003 and a facing sheet 1004. A construction such as media 1001 is referred to herein as a single facer or single faced strip.

Sometimes, the corrugated fluted or ridged sheet 1003, FIG. 65, is of a type generally characterized herein as having a regular, curved, wave pattern of flutes, ridges or corrugations 1007. The term “wave pattern” in this context, is meant to refer to a flute, ridge or corrugated pattern of alternating troughs 1007b and ridges 1007a. The term “regular” in this context is meant to refer to the fact that the pairs of troughs and ridges (1007b, 1007a) alternate with generally the same repeating corrugation (flute or ridge) shape and size. (Also, typically in a regular configuration each trough 1007b is substantially an inverse ridge for each ridge 1007a.) The term “regular” is thus meant to indicate that the corrugation (or flute) pattern comprises troughs (inverted ridges) and ridges with each pair (comprising an adjacent trough and ridge) repeating, without substantial modification in size and shape of the corrugations along at least 70% of the length of the flutes. The term “substantial” in this context, refers to a modification resulting from a change in the process or form used to create the corrugated or fluted sheet, as opposed to minor variations from the fact that the media sheet 3 is flexible. With respect to the characterization of a repeating pattern, it is not meant that in any given filter construction, an equal number of ridges and troughs is necessarily present. The media 1001 could be terminated, for example, between a pair comprising a ridge and a trough, or partially along a pair comprising a ridge and a trough. (For example, in FIG. 65 the media 1001 depicted in fragmentary has eight complete ridges 1007a and seven complete troughs 1007b.) Also, the opposite flute ends (ends of the troughs and ridges) may vary from one another. Such variations in ends are disregarded in these definitions, unless specifically stated. That is, variations in the ends of flutes are intended to be covered by the above definitions.

In the context of the characterization of a “curved” wave pattern of corrugations, in certain instances the corrugation pattern is not the result of a folded or creased shape provided to the media, but rather the apex 1007a of each ridge and the bottom 7b of each trough is formed along a radiused curve. A typical radius for such z-filter media would be at least 0.25 mm and typically would be not more than 3 mm.

An additional characteristic of the particular regular, curved, wave pattern depicted in FIG. 65, for the corrugated sheet 1003, is that at approximately a midpoint 1030 between each trough and each adjacent ridge, along most of the length of the flutes 1007, is located a transition region where the curvature inverts. For example, viewing back side or face 1003a, FIG. 65, trough 1007b is a concave region, and ridge 1007a is a convex region. Of course when viewed toward front side or face 1003b, trough 1007b of side 1003a forms a ridge; and, ridge 1007a of face 1003a, forms a trough. (In some instances, region 1030 can be a straight segment, instead of a point, with curvature inverting at ends of the segment 1030.)

A characteristic of the particular regular, wave pattern fluted (in this instance corrugated) sheet 1003 shown in FIG. 65, is that the individual corrugations, ridges or flutes are generally straight, although alternatives are possible. By “straight” in this context, it is meant that through at least 70%, typically at least 80% of the length, the ridges 1007a and troughs (or inverted ridges) 1007b do not change substantially in cross-section. The term “straight” in reference to corrugation pattern shown in FIG. 65, in part distinguishes the pattern from the tapered flutes of corrugated media described in FIG. 1 of WO 97/40918 and PCT Publication WO 03/47722, published Jun. 12, 2003, incorporated herein by reference. The tapered flutes of FIG. 1 of WO 97/40918, for example, would be a curved wave pattern, but not a “regular” pattern, or a pattern of straight flutes, as the terms are used herein.

Referring to the present FIG. 65 and as referenced above, the media 1001 has first and second opposite edges 1008 and 1009. When the media 1001 is formed into a media pack, in general edge 1009 will form an inlet end or face for the media pack and edge 1008 an outlet end or face, although an opposite orientation is possible.

In the example depicted, the various flutes 1007 extend completely between the opposite edges 1008, 1009, but alternatives are possible. For example, they can extend to a location adjacent or near the edges, but not completely therethrough. Also, they can be stopped and started partway through the media, as for example in the media of US 2014/0208705 A1, incorporated herein by reference.

When the media is as depicted in FIG. 65, adjacent edge 1008 can provided a sealant bead 1010, sealing the corrugated sheet 3 and the facing sheet 1004 together. Bead 1010 will sometimes be referred to as a “single facer” or “single face” bead, or by variants, since it is a bead between the corrugated sheet 1003 and facing sheet 1004, which forms the single facer (single faced) media strip 1001. Sealant bead 1010 seals closed individual flutes 1011 adjacent edge 1008, to passage of air therefrom (or thereto in an opposite flow).

In the media depicted in FIG. 65, adjacent edge 1009 is provided seal bead 1014. Seal bead 1014 generally closes flutes 1015 to passage of unfiltered fluid therefrom (or flow therein in an opposite flow), adjacent edge 1009. Bead 1014 would typically be applied as media 1001 is configured into a media pack. If the media pack is made from a stack of strips 1001, bead 1014 will form a seal between a backside 1017 of facing sheet 1004, and side 1018 of the next adjacent corrugated sheet 1003. When the media 1001 is cut in strips and stacked, instead of coiled, bead 1014 is referenced as a “stacking bead.” (When bead 1014 is used in a coiled arrangement formed from a long strip of media 1001, it may be referenced as a “winding bead.”).

In alternate types of through-flow media, seal material can be located differently, and added sealant or adhesive can even be avoided. For example, in some instances, the media can be folded to form an end or edge seam; or, the media can be sealed closed by alternate techniques such as ultrasound application, etc. Further, even when sealant material is used, it need not be adjacent opposite ends.

Referring to FIG. 65, once the filter media 1001 is incorporated into a media pack, for example by stacking or coiling, it can be operated as follows. First, air in the direction of arrows 1012, would enter open flutes 1011 adjacent end 1009. Due to the closure at end 1008, by bead 1010, the air would pass through the filter media 1001, for example as shown by arrows 1013. It could then exit the media or media pack, by passage through open ends 1015a of the flutes 1015, adjacent end 1008 of the media pack. Of course operation could be conducted with air flow in the opposite direction.

For the particular arrangement shown herein in FIG. 1001, the parallel corrugations 1007a, 1007b are generally straight completely across the media, from edge 1008 to edge 1009. Straight flutes, ridges or corrugations can be deformed or folded at selected locations, especially at ends. Modifications at flute ends for closure are generally disregarded in the above definitions of “regular,” “curved” and “wave pattern.”

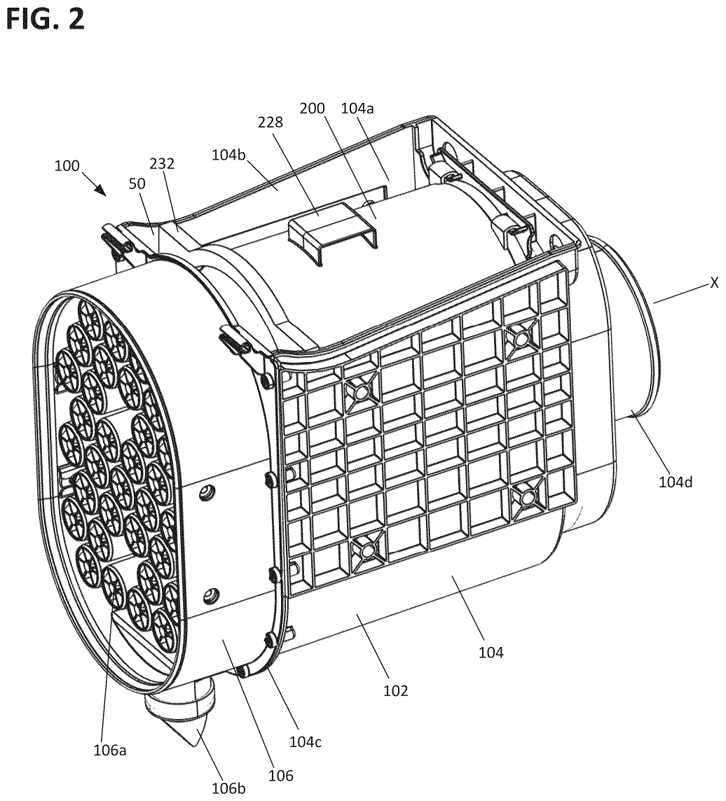

Z-filter constructions which do not utilize straight, regular curved wave pattern corrugation shapes are known. For example in Yamada et al. U.S. Pat. No. 5,562,825 corrugation patterns which utilize somewhat semicircular (in cross section) inlet flutes adjacent narrow V-shaped (with curved sides) exit flutes are shown (see FIGS. 1 and 3, of U.S. Pat. No. 5,562,825). In Matsumoto, et al. U.S. Pat. No. 5,049,326 circular (in cross-section) or tubular flutes defined by one sheet having half tubes attached to another sheet having half tubes, with flat regions between the resulting parallel, straight, flutes are shown, see FIG. 2 of Matsumoto '326. In Ishii, et al. U.S. Pat. No. 4,925,561 (FIG. 1) flutes folded to have a rectangular cross section are shown, in which the flutes taper along their lengths. In WO 97/40918 (FIG. 1), flutes or parallel corrugations which have a curved, wave patterns (from adjacent curved convex and concave troughs) but which taper along their lengths (and thus are not straight) are shown. Also, in WO 97/40918 flutes which have curved wave patterns, but with different sized ridges and troughs, are shown. Also, flutes, which are modified in shape to include various ridges, are known.

In general, the filter media is a relatively flexible material, typically a non-woven fibrous material (of cellulose fibers, synthetic fibers or both) often including a resin therein, sometimes treated with additional materials. Thus, it can be conformed or configured into the various corrugated patterns, without unacceptable media damage. Also, it can be readily coiled or otherwise configured for use, again without unacceptable media damage. Of course, it must be of a nature such that it will maintain the required corrugated configuration, during use.

Typically, in the corrugation process, an inelastic deformation is caused to the media. This prevents the media from returning to its original shape. However, once the tension is released the flute or corrugations will tend to spring back, recovering only a portion of the stretch and bending that has occurred. The facing media sheet is sometimes tacked to the fluted media sheet, to inhibit this spring back in the corrugated sheet. Such tacking is shown at 1020.

Also, typically, the media contains a resin. During the corrugation process, the media can be heated to above the glass transition point of the resin. When the resin then cools, it will help to maintain the fluted shapes.

The media of the corrugated (fluted) sheet 1003 facing sheet 1004 or both, can be provided with a fine fiber material on one or both sides thereof, for example in accord with U.S. Pat. No. 6,673,136, incorporated herein by reference. In some instances, when such fine fiber material is used, it may be desirable to provide the fine fiber on the upstream side of the material and inside the flutes. When this occurs, air flow, during filtering, will typically be into the edge comprising the stacking bead.

An issue with respect to z-filter constructions relates to closing of the individual flute ends. Although alternatives are possible, typically a sealant or adhesive is provided, to accomplish the closure. As is apparent from the discussion above, in typical z-filter media especially that which uses straight flutes as opposed to tapered flutes and sealant for flute seals, large sealant surface areas (and volume) at both the upstream end and the downstream end are needed. High quality seals at these locations are important to proper operation of the media structure that results. The high sealant volume and area, creates issues with respect to this.

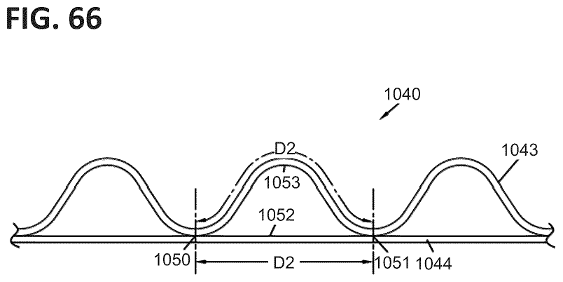

Attention is now directed to FIG. 66, in which z-filter media; i.e., a z-filter media construction 1040, utilizing a regular, curved, wave pattern corrugated sheet 1043, and a non-corrugated flat sheet 1044, i.e., a single facer strip is schematically depicted. The distance D1, between points 1050 and 1051, defines the extension of flat media 1044 in region 1052 underneath a given corrugated flute 1053. The length D2 of the arcuate media for the corrugated flute 1053, over the same distance D1 is of course larger than D1, due to the shape of the corrugated flute 1053. For a typical regular shaped media used in fluted filter applications, the linear length D2 of the media 1053 between points 1050 and 1051 will often be at least 1.2 times D1. Typically, D2 would be within a range of 1.2-2.0 times D1, inclusive. One particularly convenient arrangement for air filters has a configuration in which D2 is about 1.25-1.35×D1. Such media has, for example, been used commercially in Donaldson Powercore™ Z-filter arrangements. Another potentially convenient size would be one in which D2 is about 1.4-1.6 times D1. Herein the ratio D2/D1 will sometimes be characterized as the flute/flat ratio or media draw for the corrugated media.

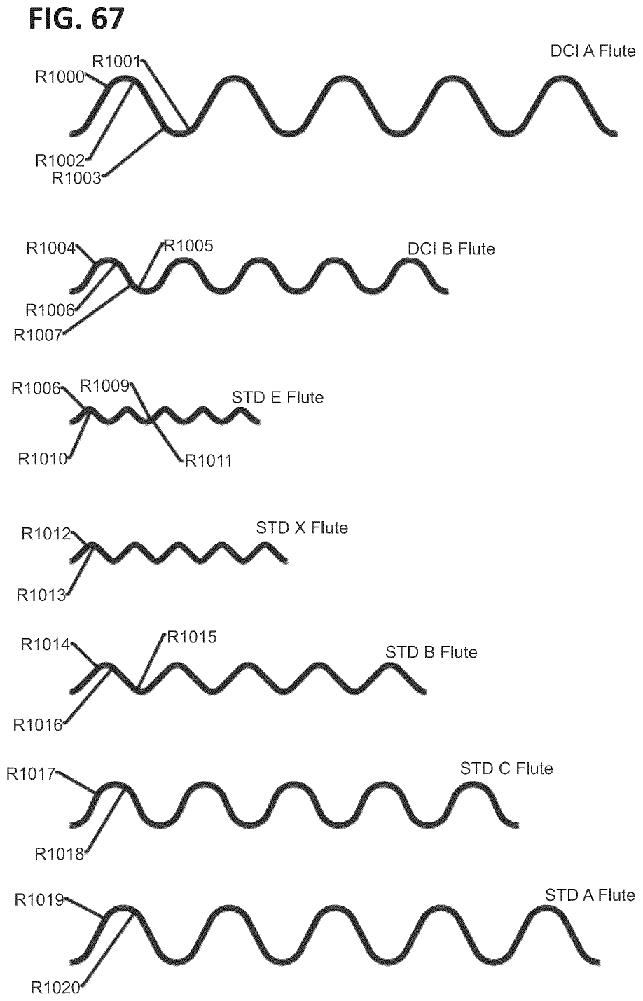

In the corrugated cardboard industry, various standard flutes have been defined. For example the standard E flute, standard X flute, standard B flute, standard C flute and standard A flute. FIG. 67, attached, in combination with Table A below provides definitions of these flutes.

Donaldson Company, Inc., (DCI) the assignee of the present disclosure, has used variations of the standard A and standard B flutes, in a variety of z-filter arrangements. These flutes are also defined in Table A and FIG. 67.

TABLE A
(Flute definitions for FIG. 67)

DCI A Flute: Flute/flat = 1.52:1; The Radii (R) are as follows:
R1000 = .0675 inch (1.715 mm); R1001 = .0581 inch (1.476 mm);
R1002 = .0575 inch (1.461 mm); R1003 = .0681 inch (1.730 mm);
DCI B Flute: Flute/flat = 1.32:1; The Radii (R) are as follows:
R1004 = .0600 inch (1.524 mm); R1005 = .0520 inch (1.321 mm);
R1006 = .0500 inch (1.270 mm); R1007 = .0620 inch (1.575 mm);
Std. E Flute: Flute/flat = 1.24:1; The Radii (R) are as follows:
R1008 = .0200 inch (.508 mm); R1009 = .0300 inch (.762 mm);
R1010 = .0100 inch (.254 mm); R1011 = .0400 inch (1.016 mm);
Std. X Flute: Flute/flat = 1.29:1; The Radii (R) are as follows:
R1012 = .0250 inch (.635 mm); R1013 = .0150 inch (.381 mm);
Std. B Flute: Flute/flat = 1.29:1; The Radii (R) are as follows:
R1014 = .0410 inch (1.041 mm); R1015 = .0310 inch (.7874 mm);
R1016 = .0310 inch (.7874 mm);
Std. C Flute: Flute/flat = 1.46:1; The Radii (R) are as follows:
R1017 = .0720 inch (1.829 mm); R1018 = .0620 inch (1.575 mm);
Std. A Flute: Flute/flat = 1.53:1; The Radii (R) are as follows:
R1019 = .0720 inch (1.829 mm); R1020 = .0620 inch (1.575 mm).

Of course other, standard, flutes definitions from the corrugated box industry are known.

In general, standard flute configurations from the corrugated box industry can be used to define corrugation shapes or approximate corrugation shapes for corrugated media. Comparisons above between the DCI A flute and DCI B flute, and the corrugation industry standard A and standard B flutes, indicate some convenient variations.

It is noted that alternative flute definitions such as those characterized in U.S. Ser. No. 12/215,718, filed Jun. 26, 2008; and published as US 2009/0127211; U.S. Ser. No. 12/012,785, filed Feb. 4, 2008 and published as US 2008/0282890; and/or U.S. Ser. No. 12/537,069 published as US 2010/0032365 can be used, with air cleaner features as characterized herein below. The complete disclosures of each of US 2009/0127211, US 2008/0282890 and US 2010/0032365 are incorporated herein by reference.

Another media variation comprising fluted media with facing media secured thereto, can be used in arrangements according to the present disclosure, in either a stacked or coiled form, is described in US 2014/0208705 A1, owned by Baldwin Filters, Inc., published Jul. 31, 2014, and incorporated herein by reference.

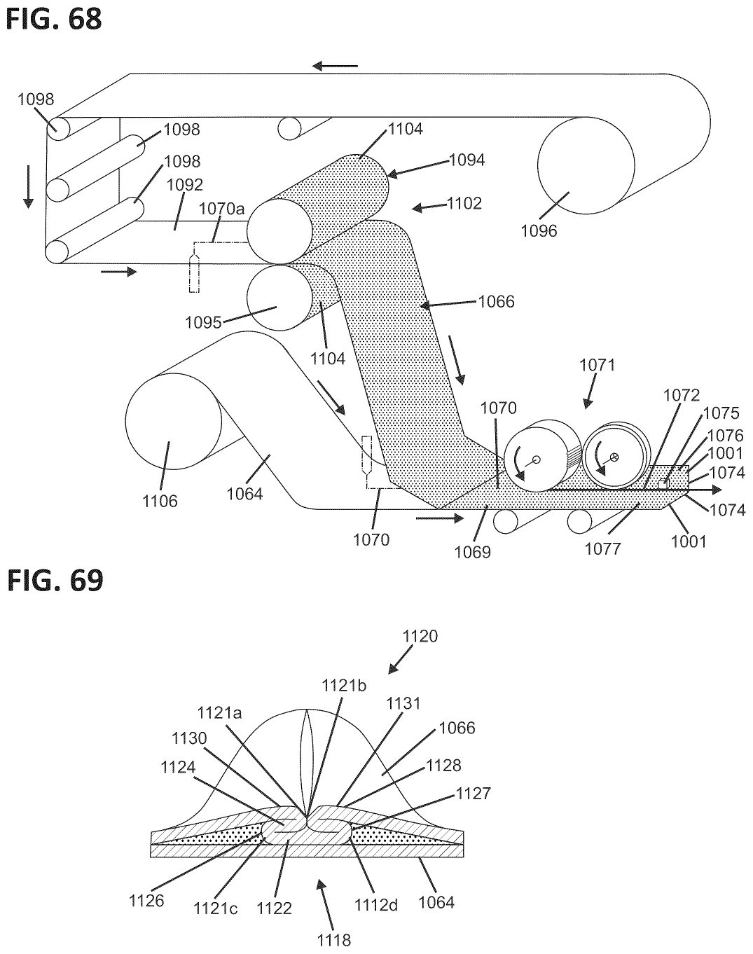

### B. Manufacture of Media Pack Configurations Including the Media of FIGS. 65-67, See FIGS. 68-71

In FIG. 68, one example of a manufacturing process for making a media strip (single facer) corresponding to strip 1001, FIG. 65 is shown. In general, facing sheet 1064 and the fluted (corrugated) sheet 1066 having flutes 1068 are brought together to form a media web 1069, with an adhesive bead located therebetween at 1070. The adhesive bead 1070 will form a single facer bead 1010, FIG. 65. An optional darting process occurs at station 1071 to form center darted section 1072 located mid-web. The z-filter media or Z-media strip 1074 can be cut or slit at 1075 along the bead 1070 to create two pieces or strips 1076, 1077 of z-filter media 1074, each of which has an edge with a strip of sealant (single facer bead) extending between the corrugating and facing sheet. Of course, if the optional darting process is used, the edge with a strip of sealant (single facer bead) would also have a set of flutes darted at this location.

Techniques for conducting a process as characterized with respect to FIG. 68 are described in PCT WO 04/007054, published Jan. 22, 2004 incorporated herein by reference.

Still in reference to FIG. 68, before the z-filter media 1074 is put through the darting station 1071 and eventually slit at 1075, it must be formed. In the schematic shown in FIG. 1004, this is done by passing a sheet of filter media 1092 through a pair of corrugation rollers 1094, 1095. In the schematic shown in FIG. 68, the sheet of filter media 1092 is unrolled from a roll 1096, wound around tension rollers 1098, and then passed through a nip or bite 1102 between the corrugation rollers 1094, 1095. The corrugation rollers 1094, 1095 have teeth 1104 that will give the general desired shape of the corrugations after the flat sheet 1092 passes through the nip 1102. After passing through the nip 1102, the sheet 1092 becomes corrugated across the machine direction and is referenced at 1066 as the corrugated sheet. The corrugated sheet 1066 is then secured to facing sheet 1064. (The corrugation process may involve heating the media, in some instances.)

Still in reference to FIG. 68, the process also shows the facing sheet 1064 being routed to the darting process station 1071. The facing sheet 1064 is depicted as being stored on a roll 1106 and then directed to the corrugated sheet 1066 to form the Z-media 1074. The corrugated sheet 1066 and the facing sheet 1064 would typically be secured together by adhesive or by other means (for example by sonic welding).

Referring to FIG. 68, an adhesive line 1070 is shown used to secure corrugated sheet 1066 and facing sheet 1064 together, as the sealant bead. Alternatively, the sealant bead for forming the facing bead could be applied as shown as 1070a. If the sealant is applied at 1070a, it may be desirable to put a gap in the corrugation roller 1095, and possibly in both corrugation rollers 1094, 1095, to accommodate the bead 1070a.

Of course the equipment of FIG. 68 can be modified to provide for the tack beads 1020, FIG. 65, if desired.

The type of corrugation provided to the corrugated media is a matter of choice, and will be dictated by the corrugation or corrugation teeth of the corrugation rollers 1094, 1095. One useful corrugation pattern will be a regular curved wave pattern corrugation, of straight flutes or ridges, as defined herein above. A typical regular curved wave pattern used, would be one in which the distance D2, as defined above, in a corrugated pattern is at least 1.2 times the distance D1 as defined above. In example applications, typically D2=1.25-1.35×D1, although alternatives are possible. In some instances the techniques may be applied with curved wave patterns that are not “regular,” including, for example, ones that do not use straight flutes. Also, variations from the curved wave patterns shown, are possible.

As described, the process shown in FIG. 68 can be used to create the center darted section 1072. FIG. 69 shows, in cross-section, one of the flutes 1068 after darting and slitting.

A fold arrangement 1118 can be seen to form a darted flute 1120 with four creases 1121a, 1121b, 1121c, 1121d. The fold arrangement 1118 includes a flat first layer or portion 1122 that is secured to the facing sheet 1064. A second layer or portion 1124 is shown pressed against the first layer or portion 1122. The second layer or portion 1124 is preferably formed from folding opposite outer ends 1126, 1127 of the first layer or portion 1122.

Still referring to FIG. 69, two of the folds or creases 1121a, 1121b will generally be referred to herein as “upper, inwardly directed” folds or creases. The term “upper” in this context is meant to indicate that the creases lie on an upper portion of the entire fold 1120, when the fold 1120 is viewed in the orientation of FIG. 69. The term “inwardly directed” is meant to refer to the fact that the fold line or crease line of each crease 1121a, 1121b, is directed toward the other.

In FIG. 69, creases 1121c, 1121d, will generally be referred to herein as “lower, outwardly directed” creases. The term “lower” in this context refers to the fact that the creases 1121c, 1121d are not located on the top as are creases 1121a, 1121b, in the orientation of FIG. 69. The term “outwardly directed” is meant to indicate that the fold lines of the creases 1121c, 1121d are directed away from one another.

The terms “upper” and “lower” as used in this context are meant specifically to refer to the fold 1120, when viewed from the orientation of FIG. 69. That is, they are not meant to be otherwise indicative of direction when the fold 1120 is oriented in an actual product for use.

Based upon these characterizations and review of FIG. 69, it can be seen that a regular fold arrangement 1118 according to FIG. 5 in this disclosure is one which includes at least two “upper, inwardly directed, creases.” These inwardly directed creases are unique and help provide an overall arrangement in which the folding does not cause a significant encroachment on adjacent flutes.

A third layer or portion 1128 can also be seen pressed against the second layer or portion 1124. The third layer or portion 1128 is formed by folding from opposite inner ends 1130, 1131 of the third layer 1128.

Another way of viewing the fold arrangement 1118 is in reference to the geometry of alternating ridges and troughs of the corrugated sheet 1066. The first layer or portion 1122 is formed from an inverted ridge. The second layer or portion 1124 corresponds to a double peak (after inverting the ridge) that is folded toward, and in preferred arrangements, folded against the inverted ridge.

Techniques for providing the optional dart described in connection with FIG. 69, in a preferred manner, are described in PCT WO 04/007054, incorporated herein by reference. Techniques for coiling the media, with application of the winding bead, are described in PCT application US 04/07927, filed Mar. 17, 2004 and published as WO 04/082795 and incorporated herein by reference.

Alternate approaches to darting the fluted ends closed are possible. Such approaches can involve, for example: darting which is not centered in each flute; and, rolling, pressing or folding over the various flutes. In general, darting involves folding or otherwise manipulating media adjacent to fluted end, to accomplish a compressed, closed, state.

Techniques described herein are particularly well adapted for use in media packs that result from a step of coiling a single sheet comprising a corrugated sheet/facing sheet combination, i.e., a “single facer” strip. However, they can also be made into stacked arrangements.

Coiled media or media pack arrangements can be provided with a variety of peripheral perimeter definitions. In this context the term “peripheral, perimeter definition” and variants thereof, is meant to refer to the outside perimeter shape defined, looking at either the inlet end or the outlet end of the media or media pack. Typical shapes are circular as described in PCT WO 04/007054. Other useable shapes are obround, some examples of obround being oval shape. In general oval shapes have opposite curved ends attached by a pair of opposite sides. In some oval shapes, the opposite sides are also curved. In other oval shapes, sometimes called racetrack shapes, the opposite sides are generally straight. Racetrack shapes are described for example in PCT WO 04/007054, and PCT application US 04/07927, published as WO 04/082795, each of which is incorporated herein by reference.

Another way of describing the peripheral or perimeter shape is by defining the perimeter resulting from taking a cross-section through the media pack in a direction orthogonal to the winding access of the coil.

Opposite flow ends or flow faces of the media or media pack can be provided with a variety of different definitions. In many arrangements, the ends or end faces are generally flat (planer) and perpendicular to one another. In other arrangements, one or both of the end faces include tapered, for example, stepped, portions which can either be defined to project axially outwardly from an axial end of the side wall of the media pack; or, to project axially inwardly from an end of the side wall of the media pack.

The flute seals (for example from the single facer bead, winding bead or stacking bead) can be formed from a variety of materials. In various ones of the cited and incorporated references, hot melt or polyurethane seals are described as possible for various applications.

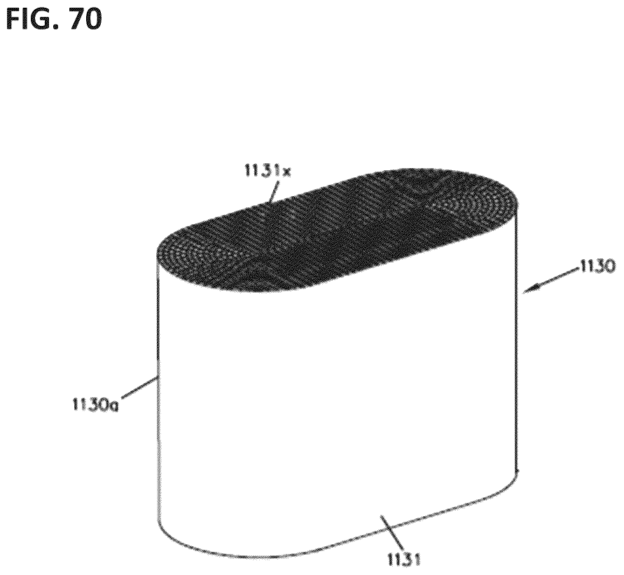

In FIG. 70, a coiled media pack (or coiled media) 1130 constructed by coiling a single strip of single faced media is depicted, generally. The particular coiled media pack depicted is an oval media pack 1130a, specifically a racetrack shaped media pack 1131. The tail end of the media, at the outside of the media pack 1130 is shown at 1131x. It will be typical to terminate that tail end along straight section of the media pack 1130 for convenience and sealing. Typically, a hot melt seal bead or seal bead is positioned along that tail end to ensure sealing. In the media pack 130, the opposite flow (end) faces are designated at 1132, 1133. One would be an inlet flow end or face, the other an outlet flow end or face.

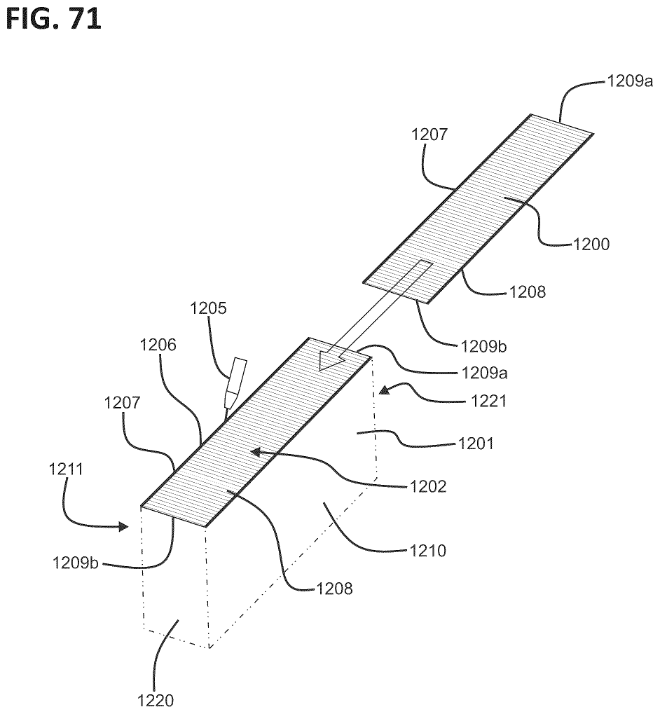

In FIG. 71, there is (schematically) shown a step of forming stacked z-filter media (or media pack) from strips of z-filter media, each strip being a fluted sheet secured to a facing sheet. Referring to FIG. 70, single facer strip 1200 is being shown added to a stack 1201 of strips 1202 analogous to strip 1200. Strip 1200 can be cut from either of strips 176, 177, FIG. 68. At 1205, FIG. 70, application of a stacking bead 1206 is shown, between each layer corresponding to a strip 1200, 1202 at an opposite edge from the single facer bead or seal. (Stacking can also be done with each layer being added to the bottom of the stack, as opposed to the top.)

Referring to FIG. 71, each strip 1200, 1202 has front and rear edges 1207, 208 and opposite side edges 1209a, 1209b. Inlet and outlet flutes of the corrugated sheet/facing sheet combination comprising each strip 1200, 1202 generally extend between the front and rear edges 1207, 1208, and parallel to side edges 1209a, 1209b.

Still referring to FIG. 71, in the media or media pack 1201 being formed, opposite flow faces are indicated at 1210, 1211. The selection of which one of faces 1210, 1211 is the inlet end face and which is the outlet end face, during filtering, is a matter of choice. In some instances the stacking bead 206 is positioned adjacent the upstream or inlet face 1211; in others the opposite is true. The flow faces 210, 211, extend between opposite side faces 1220, 1221.

The stacked media configuration or pack 1201 shown being formed in FIG. 71, is sometimes referred to herein as a “blocked” stacked media pack. The term “blocked” in this context, is an indication that the arrangement is formed to a rectangular block in which all faces are 90° relative to all adjoining wall faces. For example, in some instances the stack can be created with each strip 200 being slightly offset from alignment with an adjacent strip, to create a parallelogram or slanted block shape, with the inlet face and outlet face parallel to one another, but not perpendicular to upper and bottom surfaces.

In some instances, the media or media pack will be referenced as having a parallelogram shape in any cross-section, meaning that any two opposite side faces extend generally parallel to one another.

It is noted that a blocked, stacked arrangement corresponding to FIG. 71 is described in the prior art of U.S. Pat. No. 5,820,646, incorporated herein by reference. It is also noted that stacked arrangements are described in U.S. Pat. Nos. 5,772,883; 5,792,247; U.S. Provisional 60/457,255 filed Mar. 25, 2003; and U.S. Ser. No. 10/731,564 filed Dec. 8, 2003 and published as 2004/0187689. Each of these latter references is incorporated herein by reference. It is noted that a stacked arrangement shown in U.S. Ser. No. 10/731,504, published as 2005/0130508 is a slanted stacked arrangement.

It is also noted that, in some instances, more than one stack can be incorporated into a single media pack. Also, in some instances, the stack can be generated with one or more flow faces that have a recess therein, for example, as shown in U.S. Pat. No. 7,625,419 incorporated herein by reference.

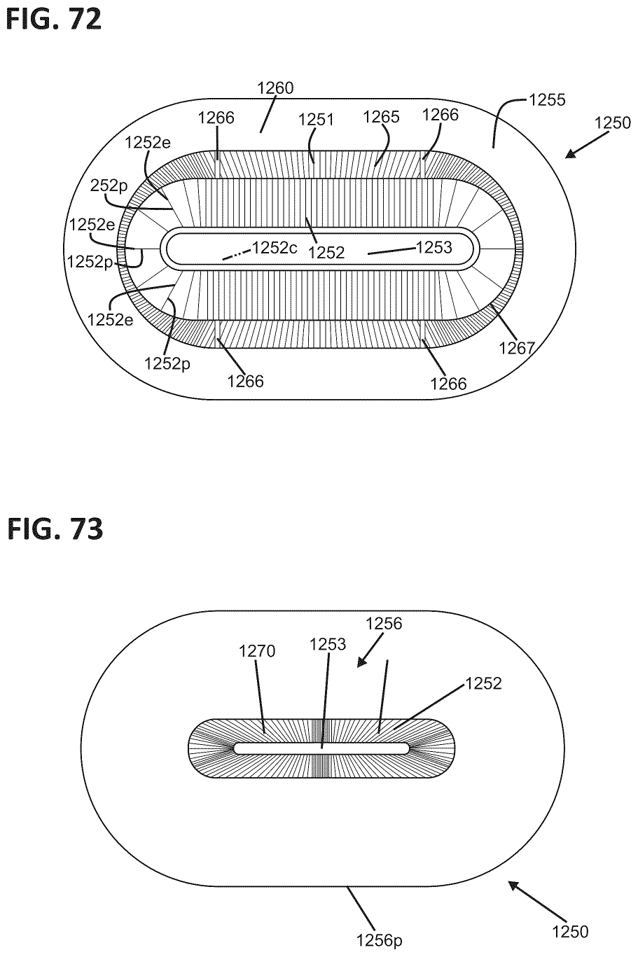

### C. Selected Media or Media Pack Arrangements Comprising Multiple Spaced Coils of Fluted Media; FIGS. 72-74

Alternate types of media arrangements or packs that involve flutes between opposite ends extending between can be used with selected principles according to the present disclosure. An example of such alternate media arrangement or pack is depicted in FIGS. 72-74. The media of FIGS. 72-74 is analogous to one depicted and described in DE 20 2008 017 059 U1; and as can sometimes found in arrangements available under the mark “IQORON” from Mann & Hummel.

Referring to FIG. 72, the media or media pack is indicated generally at 1250. The media or media pack 1250 comprises a first outer pleated (ridged) media loop 1251 and a second, inner, pleated (ridged) media loop 1252, each with pleat tips (or ridges) extending between opposite flow ends. The view of FIG. 72 is toward a media pack (flow) end 1255. The end 1255 depicted, can be an inlet (flow) end or an outlet (flow) end, depending on selected flow direction. For many arrangements using principles characterized having the media pack 1250 would be configured in a filter cartridge such that end 1255 is an inlet flow end.

Still referring to FIG. 72, the outer pleated (ridged) media loop 1251 is configured in an oval shape, though alternatives are possible. At 1260, a pleat end closure, for example molded in place, is depicted closing ends of the pleats or ridges 1251 at media pack end 1255.

Pleats, or ridges 1252 (and the related pleat tips) are positioned surrounded by and spaced from loop 1251, and thus pleated media loop 1252 is also depicted in a somewhat oval configuration. In this instance, ends 1252e of individual pleats or ridges 1252p in a loop 1252 are sealed closed. Also, loop 1252 surrounds the center 1252c that is closed by a center strip 1253 of material, typically molded-in-place.

During filtering, when end 1255 is an inlet flow end, air enters gap 1265 between the two loops of media 1251, 1252. The air then flows either through loop 1251 or loop 1252, as it moves through the media pack 250, with filtering.

In the example depicted, loop 1251 is configured slanting inwardly toward loop 1252, in extension away from end 1255. Also spacers 1266 are shown supporting a centering ring 1267 that surrounds an end of the loop 1252, for structural integrity.

In FIG. 73, an end 1256 of the cartridge 1250, opposite end 1255 is viewable. Here, an interior of loop 1252 can be seen, surrounding an open gas flow region 1270. When air is directed through cartridge 1250 in a general direction toward end 1256 and away from end 1255, the portion of the air that passes through loop 1252 will enter central region 1270 and exit therefrom at end 1256. Of course air that has entered media loop 1251, FIG. 72, during filtering would generally pass around (over) an outer perimeter 1256p of end 1256.

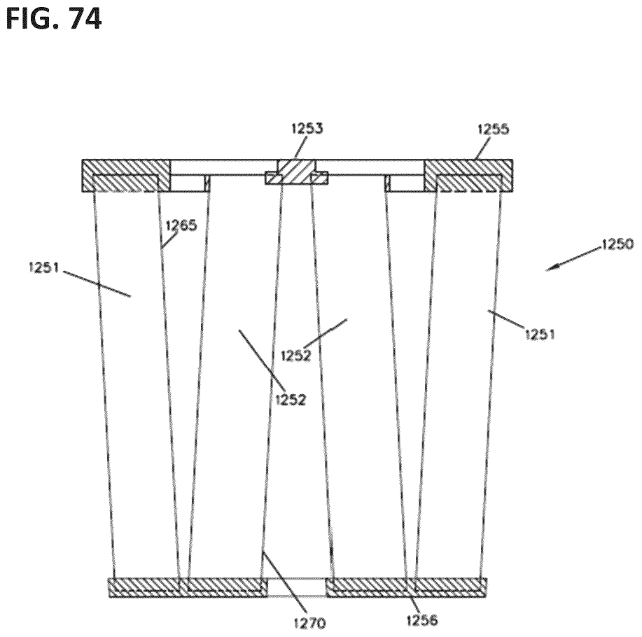

In FIG. 74 a schematic cross sectional view of cartridge 1250 is provided. Selected identified and described features are indicated by like reference numerals

It will be understood from a review of FIGS. 72-74, the above description, that the cartridge 1250 described, is generally a cartridge which has media tips extending in a longitudinal direction between opposite flow ends 1255, 1256.

In the arrangement of FIGS. 72-74, the media pack 1250 is depicted with an oval, in particular racetrack, shaped perimeter. It is depicted in this manner, since the air filter cartridges in many examples below also have an oval or racetrack shaped configuration. However, the principles can be embodied in a variety of alternate peripheral shapes.

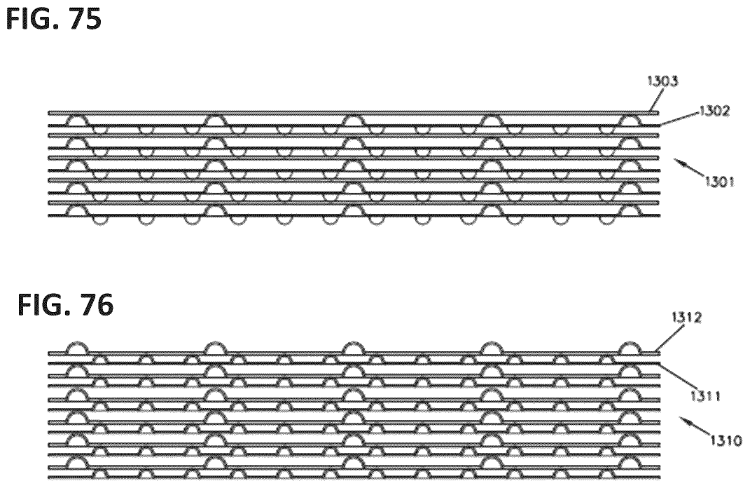

### D. Other Media Variations, FIGS. 75-80

Herein, in FIGS. 75-80, some schematic, fragmentary, cross-sectional views are provided of still further alternate variations of media types that can be used in selected applications of the principles characterized herein. Certain examples are described in U.S. Ser. No. 62/077,749, filed Nov. 10, 2014 and owned by the Assignee of the present disclosure, Donaldson Company, Inc. In general, each of the arrangements of FIGS. 9-12 represents a media type that can be stacked or coiled into an arrangement that has opposite inlet and outlet flow ends (or faces), with straight through flow.

In FIG. 75, an example media arrangement 1301 from U.S. Ser. No. 62/077,749 (2658) is depicted, in which an embossed sheet 1302 is secured to a non-embossed sheet 1303, then stacked and coiled into a media pack, with seals along opposite edges of the type previously described for FIG. 65 herein.

In FIG. 76, an alternate example media pack 1310 from U.S. Ser. No. 62/077,749 is depicted, in which a first embossed sheet 1311 is secured to a second embossed sheet 1312 and then formed into a stacked or coiled media pack arrangement, having edge seals generally in accord with FIG. 65 herein.

Edge seals can be conducted in either the upstream end or the downstream end, or in some instances both. Especially when the media is likely to encounter chemical material during filtering, it may be desirable to avoid a typical adhesive or sealant.

In FIG. 77, a cross-section is depicted in which the fluted sheet X has various embossments on it for engagement with the facing sheet Y. Again these can be separate, or sections of the same media sheet.

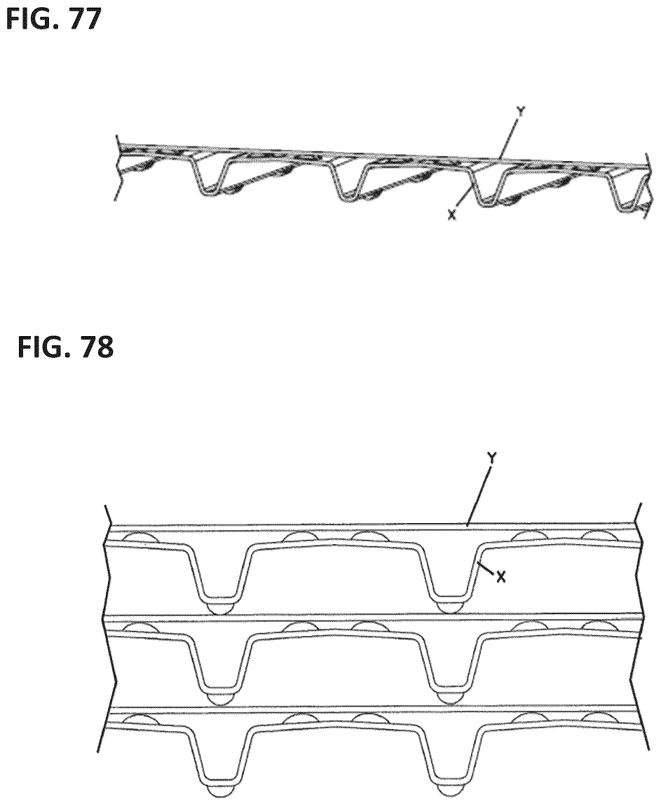

In FIG. 78, a schematic depiction of such an arrangement between the fluted sheet X and facing sheet Y is also shown.

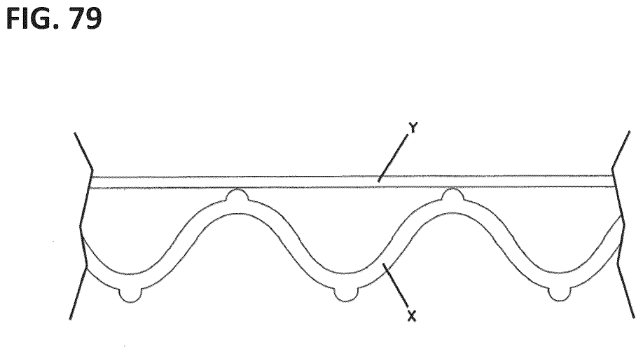

In FIG. 79, a still further variation of such a principle is shown between a fluted sheet X and a facing sheet Y. These are meant to help understand how a wide variety of approaches are possible.

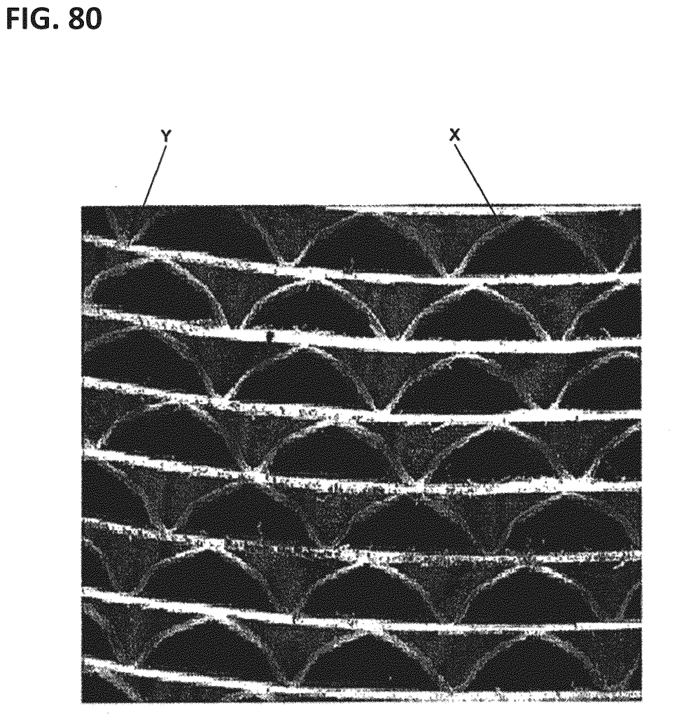

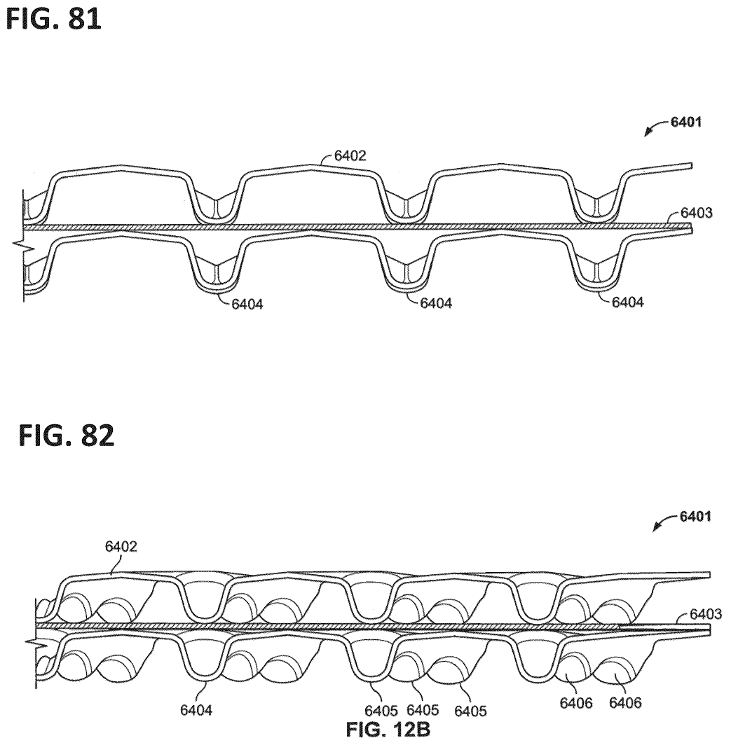

In FIG. 80, still another possible variation in fluted sheet X and facing sheet Y is shown.

In FIGS. 81 and 82, an example media arrangement 6401 is depicted, in which a fluted sheet 6402 is secured to a facing sheet 6403. The facing sheet 6403 may be a flat sheet. The media arrangement 6401 can then be stacked or coiled into a media pack, with seals along opposite edges of the type previously described for FIG. 1 herein. In the embodiment shown, the flutes 6404 of fluted sheet 6402 have an undulating ridgeline including a series of peaks 6405 and saddles 6406. The peaks 6405 of adjacent flutes 6404 can be either aligned as shown in FIGS. 81 and 82 or offset. Further the peak height and/or density can increase, decrease, or remain constant along the length of the flutes 6404. The ratio of the peak flute height to saddle flute height can vary from about 1.5, typically from 1.1 to about 1.

It is noted that there is no specific requirement that the same media be used for the fluted sheet section and the facing sheet section. A different media can be desirable in each, to obtain different effects. For example, one may be a cellulose media, while the other is a media containing some non-cellulose fiber. They may be provided with different porosity or different structural characteristics, to achieve desired results.

A variety of materials can be used. For example, the fluted sheet section or the facing sheet section can include a cellulose material, synthetic material, or a mixture thereof. In some embodiments, one of the fluted sheet section and the facing sheet section includes a cellulose material and the other of the fluted sheet section and facing sheet section includes a synthetic material.

Synthetic material(s) can include polymeric fibers, such as polyolefin, polyamide, polyester, polyvinyl chloride, polyvinyl alcohol (of various degrees of hydrolysis), and polyvinyl acetate fibers. Suitable synthetic fibers include, for example, polyethylene terephthalate, polyethylene, polypropylene, nylon, and rayon fibers. Other suitable synthetic fibers include those made from thermoplastic polymers, cellulosic and other fibers coated with thermoplastic polymers, and multi-component fibers in which at least one of the components includes a thermoplastic polymer. Single and multi-component fibers can be manufactured from polyester, polyethylene, polypropylene, and other conventional thermoplastic fibrous materials.

The examples of FIGS. 75-82, are meant to indicate generally that a variety alternate media packs can be used in accord with the principles herein. Attention is also directed to U.S. Ser. No. 62/077,749 incorporated herein by reference, with respect to the general principles of construction and application of some alternates media types.

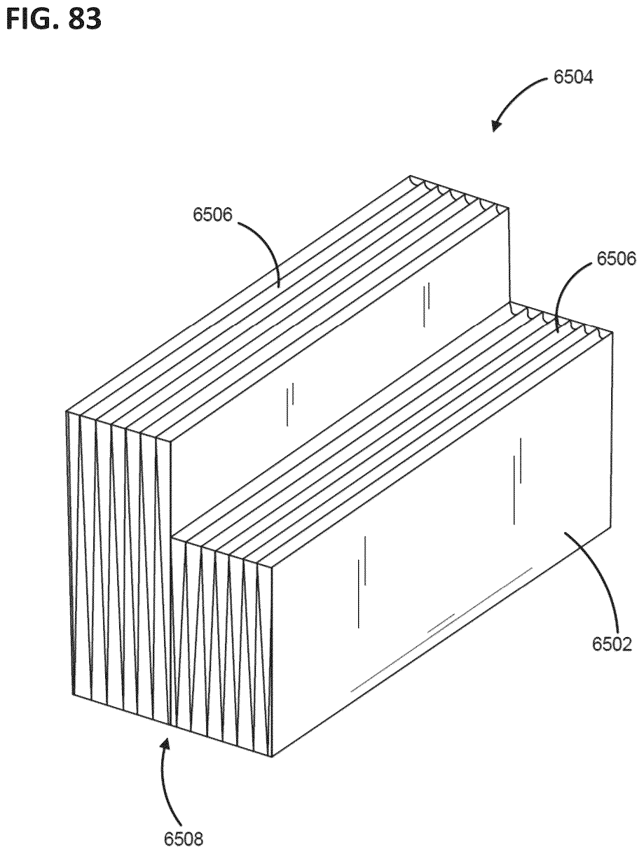

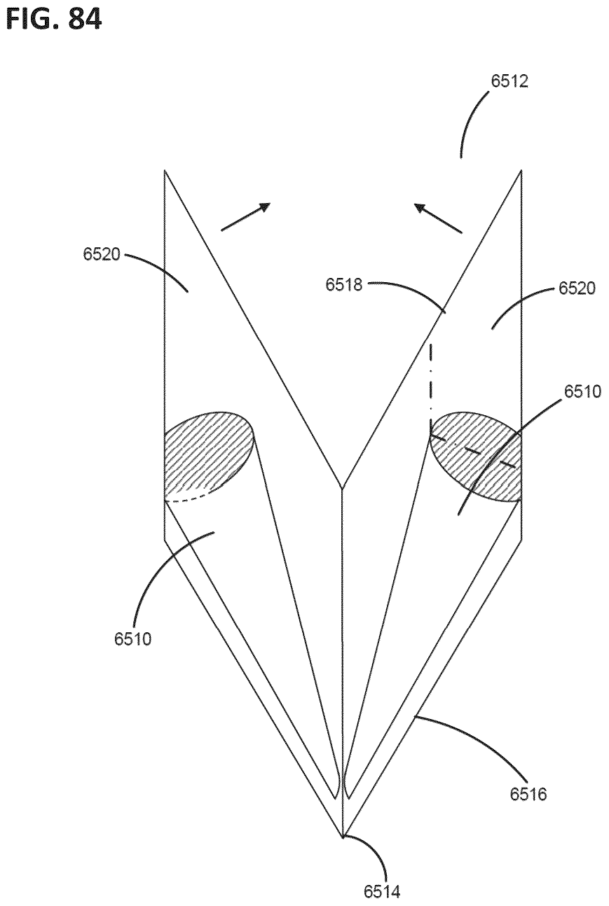

E. Additional Media Pack Arrangements Including Pleated Media with Flutes; FIGS. 83-86

Additional examples of alternative types of media arrangements or packs that involve filtration media having flutes extending between opposite ends or flow faces in a straight through flow configuration are depicted in FIGS. 83-86. The flutes can be considered inlet flutes when they are arranged to receive dirty air via an inlet flow face, and they can be considered outlet flutes when they are arranged to permit filtered air to flow out via an outlet flow face.

The filtration media 6502 depicted in FIGS. 83-85, which is analogous to ones depicted in U.S. Pat. Nos. 8,479,924 and 9,919,256 assigned to Mann+Hummel GmbH, is illustrated in an arrangement that shows how the filtration media 6502 can be formed into a media pack arrangement 6504.

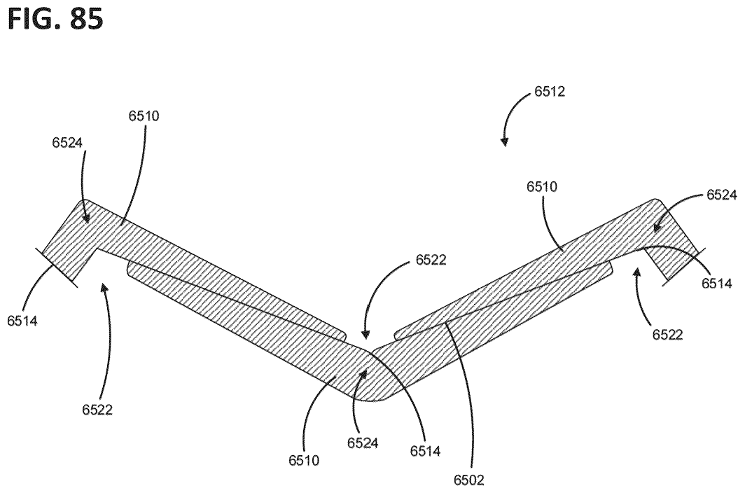

The media pack arrangement 6504 can be considered as having relatively long or deep pleats from an inlet flow face 6506 to an outlet flow face 6508, and can also have varying pleat depths as illustrated. As the depth of pleats of a media pack increases, there is a tendency of the filtration media to collapse on each other thereby causing masking. Masking is undesirable because masked filtration media tends to no longer be available for filtration thereby decreasing dust holding capacity and flow through the media pack, and also potentially increasing pressure drop across the media pack. In order to reduce masking and to help the filtration media retain its shape, support structures are known to be applied to pleated media. In FIGS. 84 and 85, support sections or spacers 6510 are provided. It should be appreciated that FIGS. 84 and 85 are illustrated in a folded configuration 6512 having pleat folds 6514, but are expanded or separated to show how the filtration media 6502 and the support sections or spacers 6510 can be arranged.

As illustrated in FIGS. 84 and 85, the filtration media 6502 extends between a first side 6516 and a second side 6518. Although only one support section 6510 is shown on each pleat face 6520, it should be appreciated that multiple support sections 6510 can be arranged along each pleat face 6520 so that when the filtration media 6502 is arranged into a media pack as illustrated in FIG. 83 as media pack 604, the volume between each of the support sections 6510 can be considered flutes extending between the inlet flow face 6506 and the outlet flow face 6508. The support sections 6510 can be arranged on each flow face 6520 so that opposite support sections 6510 contact or engage each other to help maintain the media pack shape while also limiting the amount of filtration media that would be contacted by the support sections 6510, as illustrated in FIG. 84. Furthermore, by providing that the support sections 6510 have adhesive properties, the support sections 6510 can be provided so that opposing support sections 6510 can adhere to each other when the filtration media 6502 is arranged into the media pack 6504.

The support sections 6510 can be arranged in a tapered configuration where support sections 6510 have a cross section at an interior fold 6522 and wherein the cross section increases toward an exterior fold 6524. In this context, the phrase “interior fold” refers to the side of the media that forms an acute angle, and the phrase “exterior fold” refers to the side of the media that forms an obtuse angle when the media is arranged into a media pack. Furthermore, the reference to changing the cross section of the support sections 6510 can refer to one or both of the height that the support section extends away from the media to which it is adhered and also to the width along the media to which it is adhered to in a direction toward or away from other support sections across adjacent flutes. Changing the shape of the support sections 6510 can help maintain the shape of the media pack and the resulting flutes, and can help reduce the amount of media that would otherwise be contacted by the support sections 6510 if they were not arranged in a tapered configuration. In addition, the support sections 6510 can be arranged in a non-tapered configuration. As illustrated in FIG. 85, the support sections 6510 can be provided so that they extend over the exterior folds 6524 although it is not necessary for the support sections 6510 to extend over the exterior folds. In addition, it is not necessary for the support sections 6510 to extend into the interior folds 6522, although, if desired, the support sections 6510 can be provided so that they extend into the interior folds 6522.

The support sections 6510 can be applied to the filtration media 6502 as adhesive extruded onto the filtration media 6502 where the adhesive forms the support sections 6510. Before the adhesive has a chance to fully cure, the filtration media 6502 can be folded into the media pack arrangement 6504, which may or may not have varying pleat depths. By forming the media pack arrangement 6504 before the adhesive has fully cured, the opposing support sections 6510 can become bonded or adhered to each other thereby forming flutes extending between the inlet flow face 6506 and the outlet flow face 6508.

It should be appreciated that the filtration media 6502 can be provided with deformation, such as corrugations, extending across the media. The direction of deformation, such as corrugation, can be parallel or perpendicular to the pleat fold direction.

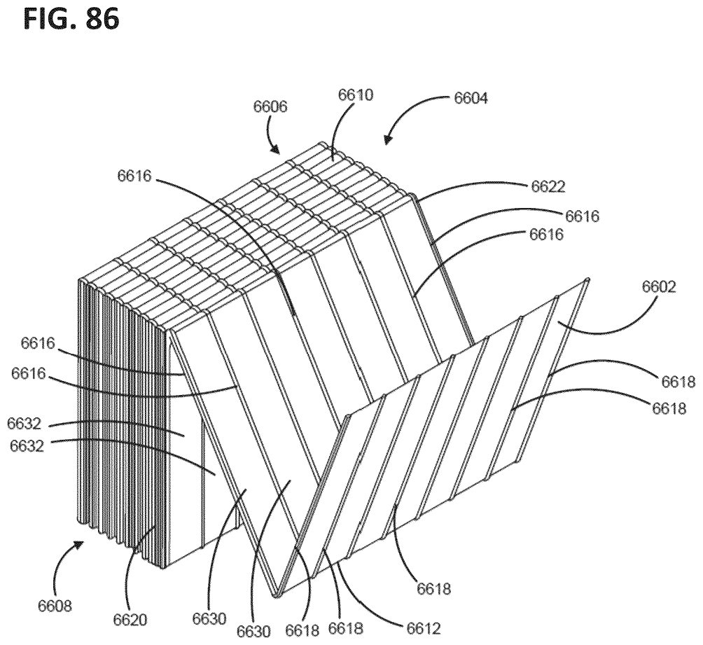

The filtration media 6602 depicted in FIG. 86 is analogous to filtration media depicted in US 2018/0207566 assigned to Champion Laboratories, Inc., as another example of a media pack arrangement 6604 having inlet and outlet flutes in a straight through flow arrangement.

The filtration media pack arrangement 6604 can be formed by folding the filtration media 6602 to form an inlet flow face 6606 and an outlet flow face 6608. The pleat tips 6610 form the inlet flow face 6606, and the pleat tips 6612 form the outlet flow face 6608. Adhesive beads 6616 and 6618, which may be continuous or discontinuous, extend along the filtration media 6602 in multiple lines across the filtration media 6602 from a media first side 6620 to a media second side 6622. The adhesive beads 6616 and 6618 along the media first side 6620 and along the media second side 6620 can be thickened, if desired, and can be arranged to provide an edge seal along the media first side 6620 and the media second side 6622. By providing that the adhesive beads 6616 and 6618 adhere to each other as the filtration media 6602 is folded, inlet flutes 6630 and outlet flutes 6632 can be formed in the straight through media pack arrangement 6604.

A similar type of filtration media pack arrangement is commercially available under the name Enduracube from Baldwin Filters, Inc. The filtration media pack available under the name Enduracube from Baldwin Filters, Inc. is arranged in a pleated configuration forming inlet flutes and outlet flutes extending between an inlet flow face and an outlet flow face.

### F. Still Further Media Types

Many of the techniques characterized herein will preferably be applied when the media is oriented for filtering between opposite flow ends of the cartridge is media having flutes or pleat tips that extend in a direction between those opposite ends. However, alternatives are possible. The techniques characterized herein with respect to seal arrangement definition can be applied in filter cartridges that have opposite flow ends, with media positioned to filter fluid flow between those ends, even when the media does not include flutes or pleat tips extending in a direction between those ends. The media, for example, can be depth media, can be pleated in an alternate direction, or it can be a non-pleated material.

It is indeed the case, however, that the techniques characterized herein are particularly advantageous for use with cartridges that are relatively deep in extension between flow ends, usually at least 100 mm, typically at least 150 mm, often at least 200 mm, sometimes at least 250 mm, and in some instances 300 mm or more, and are configured for large loading volume during use. These types of systems will typically be ones in which the media is configured with pleat tips or flutes extending in a direction between opposite flow ends.

It is also noted that while the techniques described herein were typically developed for advantageous application and arrangements involving media packs with straight through flow configurations, the techniques can be applied to advantage in other systems. For example, the techniques can be applied when the cartridge comprises media surrounding a central interior, in which the cartridge has an open end. Such arrangements can involve “forward flow” in which air to be filtered enters the central open interior by passage through the media, and the exits through the open end; or, with reverse flow in which air to be filtered enters the open end and then turns and passes through the media. A variety of such arrangements are possible, including pleated media and alternate types of media. Configurations usable would include cylindrical and conical, among others.

### IV. Summary

The principles described herein can be applied in a variety of filter assemblies. Examples described in which the principles applied to (air) gas filter assemblies. Examples are described include air filters, for example, air filters used for treating engine intake airflows. The principles can be applied to a variety of alternate gas filtration arrangements, in some instances even with liquid filter assemblies.

Again, the principles, techniques, and features described herein can be applied in a variety of systems, and there is no requirement that all of the advantageous features identified be incorporated in an assembly, system or component to obtain some benefit according to the present disclosure. For example, the disclosed air filter cartridges 300, 300′, 300″ may be provided with the disclosed seal member without being provided with a handle. Further, the disclosed filter cartridges 200, 200′, 200″ may be provided with a first part of a catch arrangement, for example a locating feature, without being provided with a handle, and vice versa. Additionally, while the seal member 330, 330′ are described in some examples as supported by about the shell 320, 320′, the seal member 330, 330′ can be supported directly on the outer perimeter surface of the media pack 210, 210′ itself. Further, the seal arrangements 330″, 331″ of air cleaner 100″ may be used with the air cleaners 100, 100′ in conjunction with the catch arrangement disclosed for those embodiments. Further, the catch arrangement of any one of the air cleaners 100, 100′, 100″ may be used with any other of the air cleaners 100, 100′, 100″.

1. A filter cartridge for an air cleaner housing comprising:
a) a media pack defining an outer perimeter extending between an inlet flow end and an outlet flow end;
b) a shell peripherally arranged about at least a portion of the media pack outer perimeter; and
c) a seal member peripherally arranged about the shell, the seal member including:
i) a radially directed first seal arrangement for forming a seal between the filter cartridge and the air cleaner housing; and
ii) a radially directed second seal arrangement, separate from the first seal arrangement, for forming a seal between the filter cartridge and another filter cartridge, wherein the first seal arrangement is located axially between the second seal arrangement and the media pack outlet flow end.

2. The filter cartridge of claim 1, wherein the seal member further includes a radially directed third seal arrangement for forming a seal between the filter cartridge and the air cleaner housing.

3. The filter cartridge of claim 1, wherein the first seal arrangement is a radially outwardly directed seal arrangement.

4. The filter cartridge of claim 1, wherein the second seal arrangement is a radially outwardly directed seal arrangement.

5. The filter cartridge of claim 1, wherein at least one of the first and second seal arrangements includes a lip seal.

6. The filter cartridge of claim 1, wherein the first seal arrangement is located radially closer to a longitudinal axis of the media pack in comparison to the second seal arrangement.

7. The filter cartridge of claim 2, wherein the seal member defines a trough region within which the third seal arrangement is disposed.

8. An air cleaner assembly comprising:
a) a housing defining an interior volume;
b) a first filter cartridge installed within the housing interior volume;
c) a second filter cartridge installed within the housing interior volume at a location downstream of the first filter cartridge, the second filter cartridge including a seal member including:
i) a radially directed first seal arrangement forming a seal between the second filter cartridge and the housing;
ii) a radially directed second seal arrangement forming a seal between the second filter cartridge and the first filter cartridge, wherein the first seal arrangement is located axially between the second seal arrangement and an outlet flow end of the second filter cartridge.

9. The air cleaner assembly of claim 8, wherein the seal member further includes a radially directed third seal arrangement forming a seal between the second filter cartridge and the air cleaner housing.

10. The air cleaner assembly of claim 8, wherein the first seal arrangement is a radially outwardly directed seal arrangement.

11. The air cleaner assembly of claim 8, wherein the second seal arrangement is a radially outwardly directed seal arrangement.

12. The air cleaner assembly of claim 8, wherein at least one of the first and second seal arrangements includes a lip seal.

13. The filter cartridge of claim 8, wherein the first seal arrangement is located radially closer to a longitudinal axis of the second filter cartridge in comparison to the second seal arrangement.

14. The filter cartridge of claim 10, wherein the seal member defines a trough region within which the third seal arrangement is disposed.

15. An air cleaner assembly comprising:
a) a housing defining an interior volume;
b) a first filter cartridge installed within the housing interior volume;
c) a second filter cartridge installed within the housing interior volume at a location downstream of the first filter cartridge, the second filter cartridge including a seal member including an outwardly radially directed seal surface forming a seal with a first interior surface of the housing and including an inwardly radially directed seal surface forming a seal with a second interior surface of the housing.

16. The air cleaner of claim 15, wherein the seal member further includes a second outwardly radially directed seal surface forming a seal between the second filter cartridge and the first filter cartridge.

17. The air cleaner of claim 15, wherein the outwardly radially directed seal surface is located axially between inlet and outlet flow ends of the second filter cartridge.

18. The air cleaner of claim 15, wherein at least a portion of the inwardly radially directed seal surface is located axially beyond an inlet flow end of a media pack, in a direction extending from an outlet flow end of the media pack towards the inlet flow end.

19. The air cleaner of claim 16, wherein one or all of the inwardly radially directed seal surface, the outwardly directed seal surface, and the second outwardly directed seal surface includes one or more lip seals.

20-60. (canceled)
